(19) United States
(12) Patent Application Publication
(10) Pub. No.: US 2002/0065751 A1
(43) Pub. Date: May 30, 2002

(54) Automated, interactive management systems and processes

(76) Inventors: Paul Felton Bellows, Atlanta, GA (US); Evelyn Hagerty Coats, Atlanta, GA (US); Frank Sheffield Hale, Atlanta, GA (US); Alyson Guthrie, Atlanata, GA (US); Kathryn Ann Herring, Atlanta, GA (US); Jennifer Stobie Schumacher, Marietta, GA (US); Kathi Joyce Kirkland, Lawrenceville, GA (US); Laura Overstreet Biering, Stone Mountain, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/923,690

(22) Filed: Aug. 7, 2001

Related U.S. Application Data
(60) Provisional application No. 60/223,860, filed on Aug. 8, 2000.
(60) Provisional application No. 60/223,861, filed on Aug. 8, 2000.
(60) Provisional application No. 60/223,685, filed on Aug. 8, 2000.

(51) Int. Cl. G06F 17/60

(52) U.S. Cl. 705/32; 705/30

(57) ABSTRACT

Systems and processes for managing in a professional services firm. Such systems and processes include interactive solicitation and reporting functionality for bottom up or 360 review of supervisors by those who work under them; interactive solicitation and reporting forms for use in a practice development planning process and solicitation and reporting forms for use in managing employee community involvement. Such systems and processes can be implemented using any desired database accessible on any desired local, wide-area or other network from user/timekeeper stations. Systems and processes according to the present invention automate collection and dissemination of information helpful to the professional services firm in creating rewarding opportunities and career paths for their employees and thus a stronger competitive position to garner the best employees and the most meaningful and profitable business.

### RELATED APPLICATION DATA

This document claims priority to Provisional Application Ser. No. 60/223,860, filed Aug. 8, 2000, entitled “Management Supervision Review Systems and Processes,” Provisional Application Ser. No. 60/223,861, filed Aug. 8, 2000, entitled “Personal Development Plan Systems and Processes” and to Provisional Application Ser. No. 60/223,685, filed Aug. 8, 2000, entitled “Community Involvement Systems and Processes.”

The present invention relates to systems and processes for managing people in a professional services firm such as an accounting firm, an engineering firm, a law firm, or an architectural firm. Such systems and processes include automated databases and forms for reviewing particular supervisors' performance, for developing individual and group practice plans, and for managing community involvement activities.

### BACKGROUND OF THE INVENTION

Professional service firms are perhaps the last to recognize the need for sound management. Economically, professional services firms have traditionally made money by focusing on increased revenue, through increased hours worked and billing rate, rather than by controlling costs. Competitive issues in recent times, combined with automation and the ability of clients to collect and use more information about costs, increase the pressure on professional services firms to manage wisely. Among the requirements are to provide meaningful career paths, fulfillment, and the richest possible professional atmosphere and culture for employees. Recent statistics show that hiring the right employees and retaining them is the greatest competitive issue to be faced, at least in the foreseeable future. It is estimated, for instance, that replacing a single lawyer subjects a firm to hundreds of thousands of dollars of expense and lost time and opportunity.

The central components of sound human resources management in a professional services firm include bottom up review of supervisors as well as top down review of subordinates' performance. Only then can supervisors learn in any organized way, from a number of people they supervise, how they need to improve and thus promote an environment that fosters career growth, fulfillment, and a pleasing culture. Similarly, it is desirable for the professional services firm to foster thinking and career planning by each individual. This can be accomplished, among other ways, by providing an organized framework for causing the employee to consider and plan based on factors such as (a) what they like to do; (b) what they do not like to do; (c) what they are good at; (d) what they are not good at; (e) what clients they want to be servicing in the future; (f) what clients they do not want to be servicing in the future; (g) what trends they see happening in the future; (h) who their competitors are and their strengths and weaknesses; and (i) their own strengths and weaknesses; and based on these factors (j) their personal and professional goals, action steps needed to reach those goals, and timing for the action steps.

One ingredient for success in a meaningful career path has always been community involvement. It is therefore further desirable for professional services firms to collect and promote use by employees of information about community service involvement and opportunities.

Systems and processes according to the present invention seek to accomplish these objectives and thus allow a professional services firm to be the sort of place which attracts the brightest professionals because it provides the most rewarding fulfilling set of opportunities and career paths. In turn, those bright professionals naturally attract important and meaningful business, which in turn increases the stature, fulfillment and compensation level for the employees. This exciting atmosphere in turn attracts more bright employees who attract more desirable business and the cycle of growth continues.

### BRIEF DESCRIPTION OF THE DRAWINGS

FIG. 1 is a process flow diagram showing management processes for reviewing supervisors according to a preferred embodiment of the present invention.

FIG. 2 is a process flow diagram showing practice development plan processes according to a preferred embodiment of the present invention.

FIG. 3 is a process flow diagram showing processes for managing employee community involvement according to a preferred embodiment of the present invention.

FIG. 4 is a functional block diagram showing the system according to a preferred embodiment on which processes such as those shown in FIGS. 1-3 can be implemented.

FIGS. 5-44 are screen shots showing screens presented in the management review process shown in FIG. 1.

FIGS. 45-99 are screen shots showing screens presented by the practice development planning process shown in FIG. 2.

FIGS. 100-110 are screen shots showing screens presented by the community involvement management process shown in FIG. 3.

### DETAILED DESCRIPTION

(A) Management Supervision Review

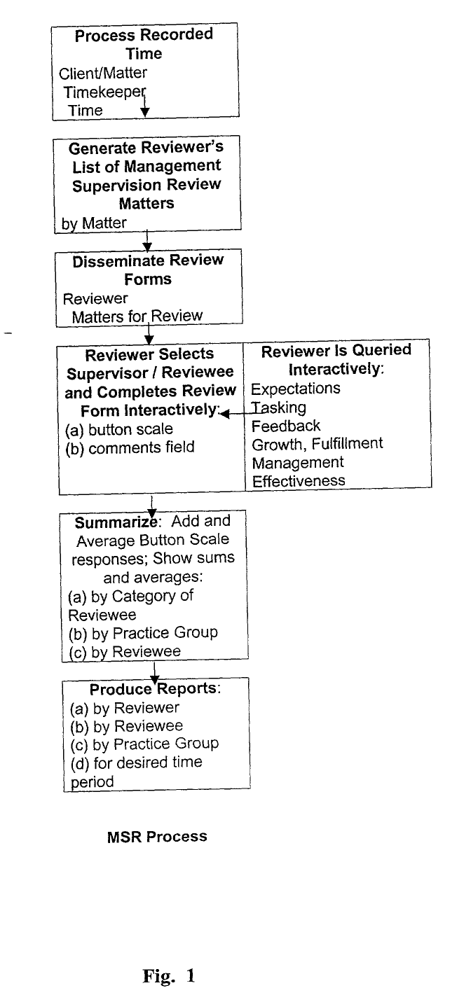

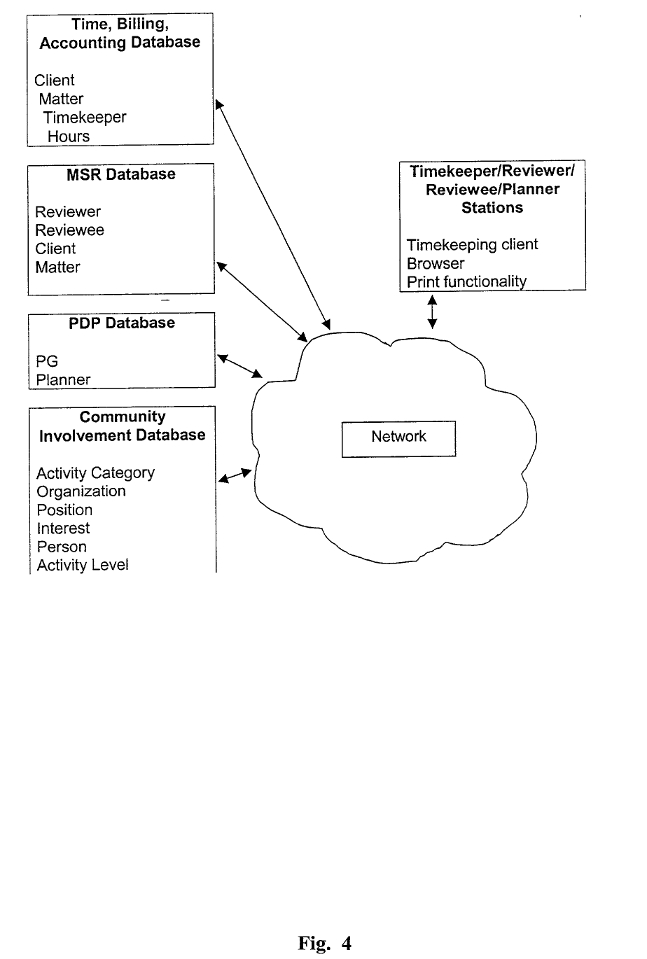

FIG. 1 is a process flow diagram showing, at a high level, processes for supervising managers in a professional services firm according to a preferred embodiment of the present invention. These processes may be carried out on a system such as that shown in FIG. 4 which includes at least a time, billing and accounting database an MSR database and timekeeper stations, all interconnected on a suitable network. In the preferred embodiment, the network is a Microsoft Windows NT network, the timekeeper stations run the Windows NT operating system with the Carpe Diem timekeeper client, Explorer browser, Windows Office Suite, and suitable print functionality such as Hewlett-Packard laser printers. The time, billing and accounting database is the Elite database for law firms, and the MSR database is implemented with an HTML presentation level for interactivity on the timekeeper stations. Any desired systems and components may be used, whether now existing or adopted in the future. In particular, implementation using the extended mark-up language or XML, with or without a common document model architecture, may be implemented. The network may be local or wide-area, connectivity occurring on any desired medium, including twisted pair, fiber optic or wireless interface.

The management supervision review process in FIG. 1 leverages timekeeper data. More specifically, timekeepers are required daily or otherwise periodically to record the quantity of time on which they worked on particular matters for particular clients, and what they did. The time, billing and accounting system collects this information in order, among other things, to generate and prepare bills for services rendered, often itemized by date, timekeeper, time worked, and amount. This data can also be supplied to the MSR database, which can then sort and present review forms to particular reviewers listing matters on which the reviewer worked in a past predetermined period of time, and offering the reviewer the chance to review the person or persons supervising them on the matter. The reviewer, as shown in the fourth step in FIG. 1, interacts with the review form by, for instance, selecting buttons on a rating scale and/or providing comments in a comment field. The areas in which the review occurs may be in the categories of, among others, expectations, tasking, feedback, growth and fulfillment, and/or management effectiveness.

The MSR database receives the data provided interactively by the reviewer, processes it for summarization and allows reports to be produced. Summarization may occur by category of reviewer, such as clerical, associate or shareholder/partner, by practice group, by reviewee, or as otherwise desired. Reports may be produced to show data for reviews completed by reviewers, results received for particular reviewees, or summarized by practice group, all for any time period desired.

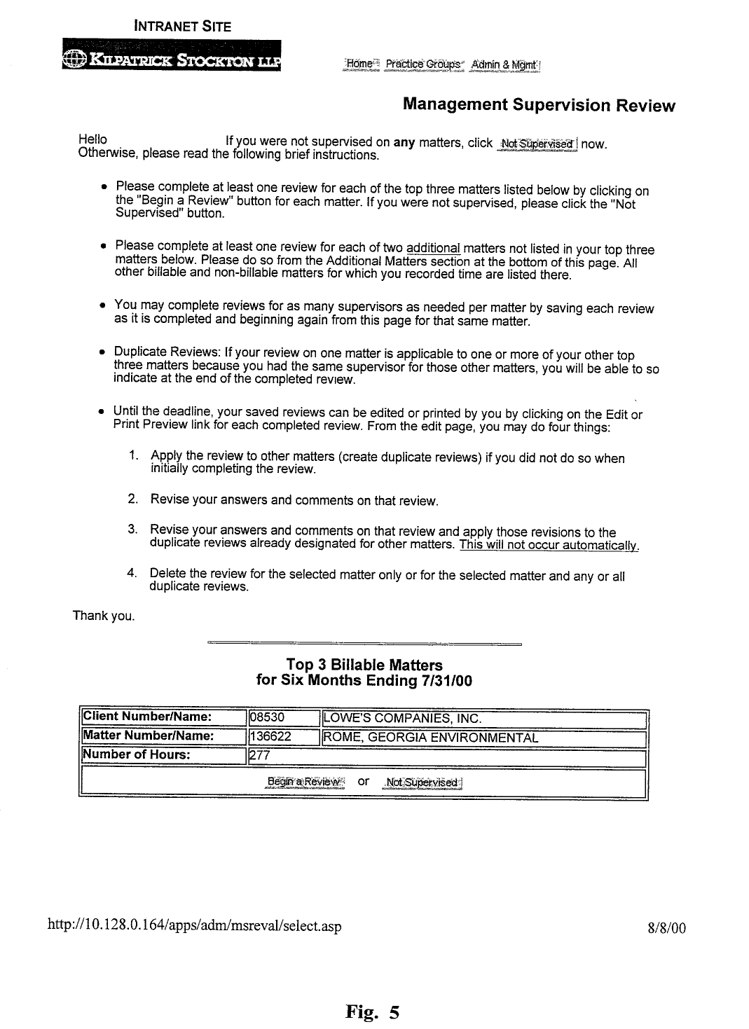

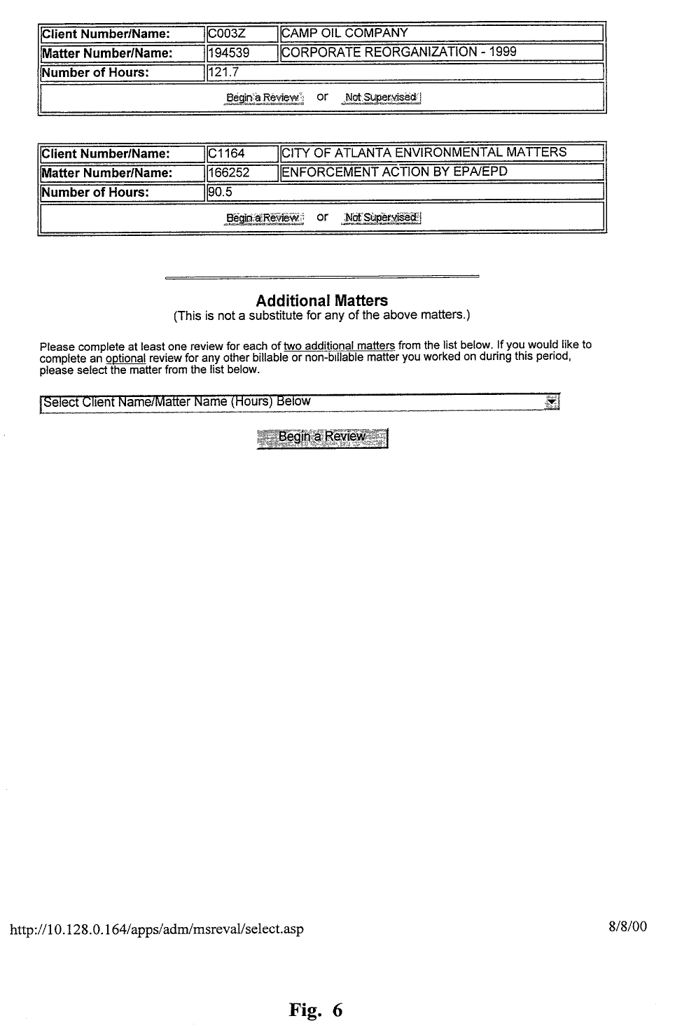

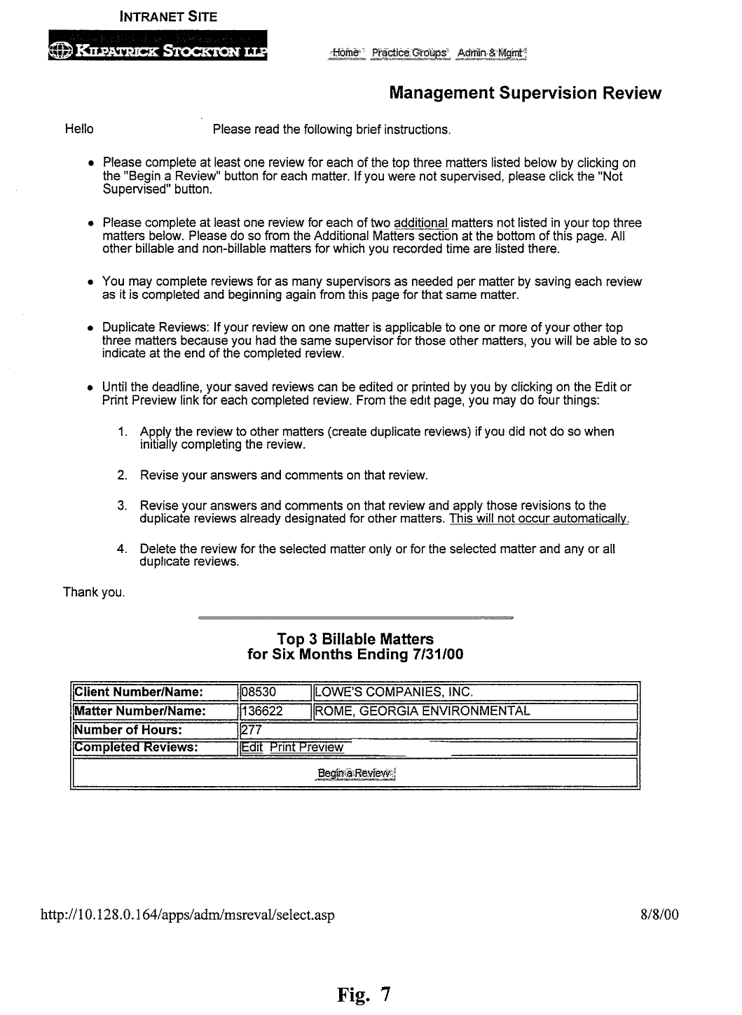

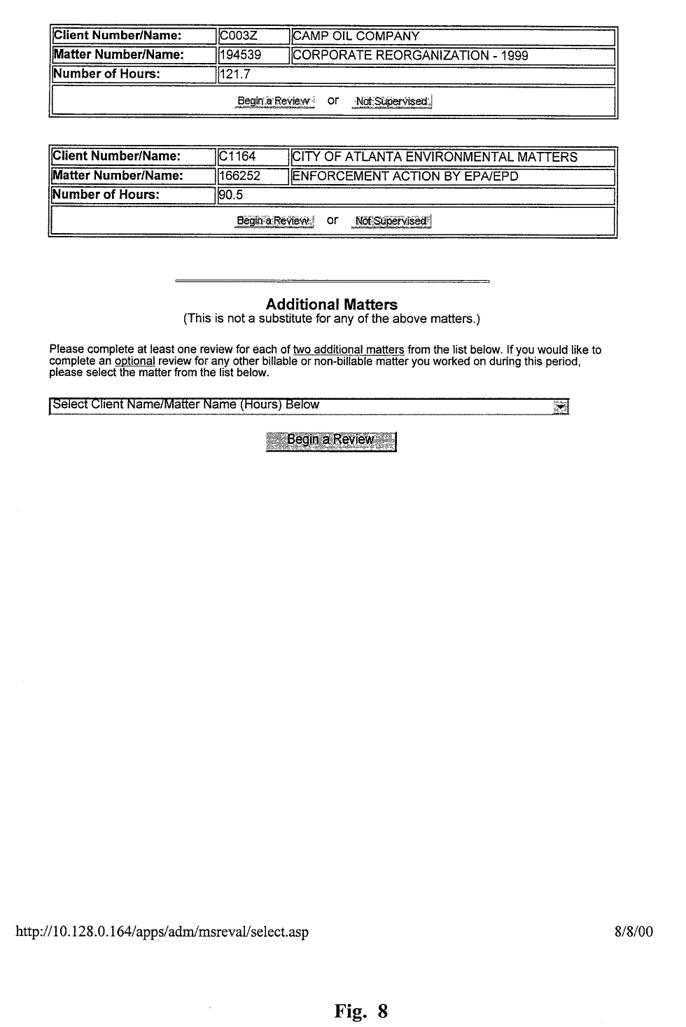

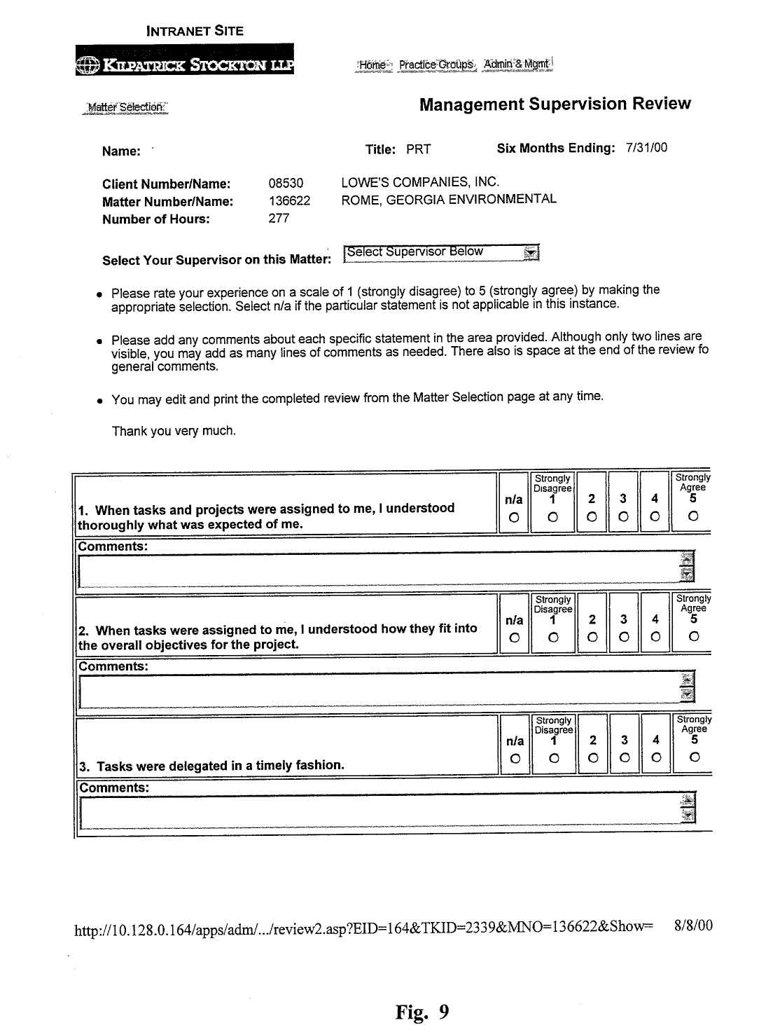

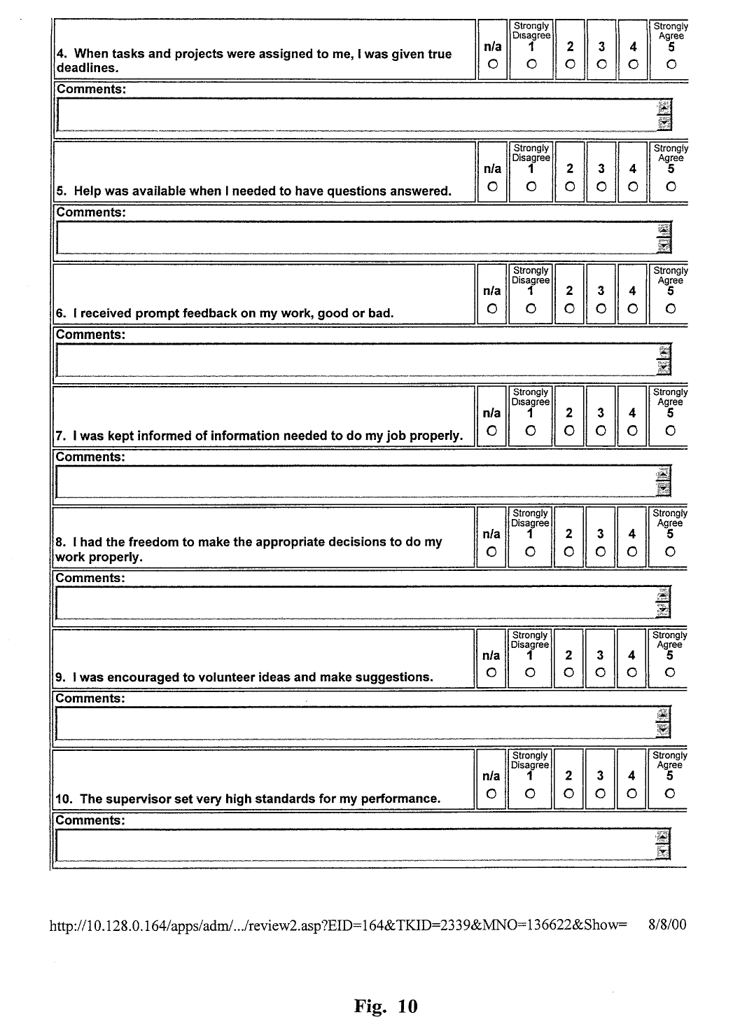

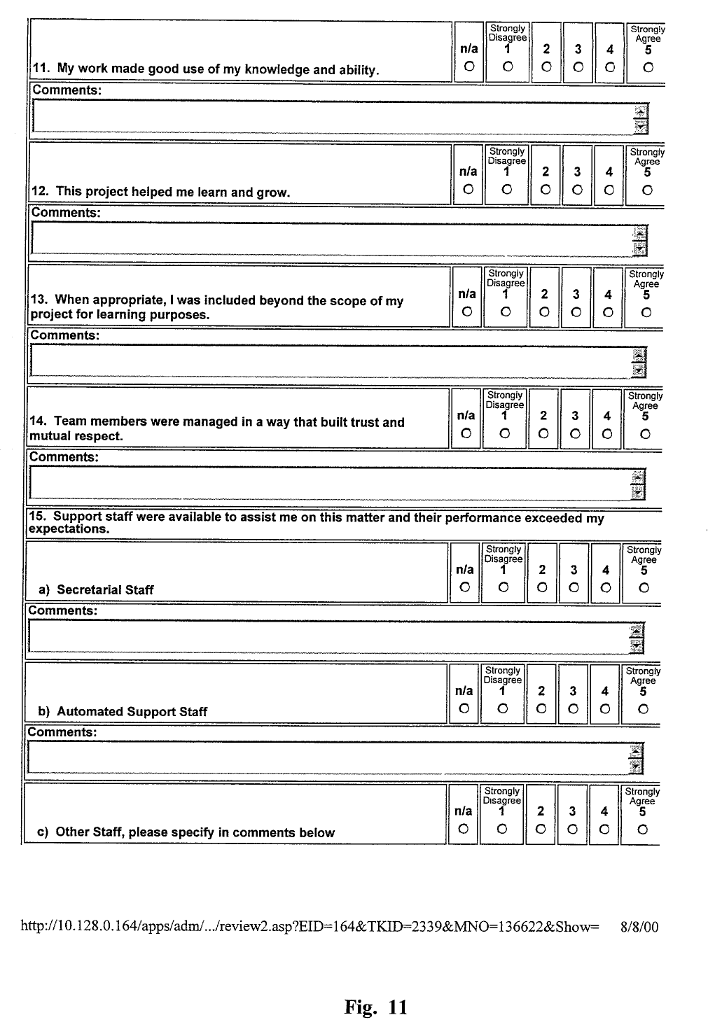

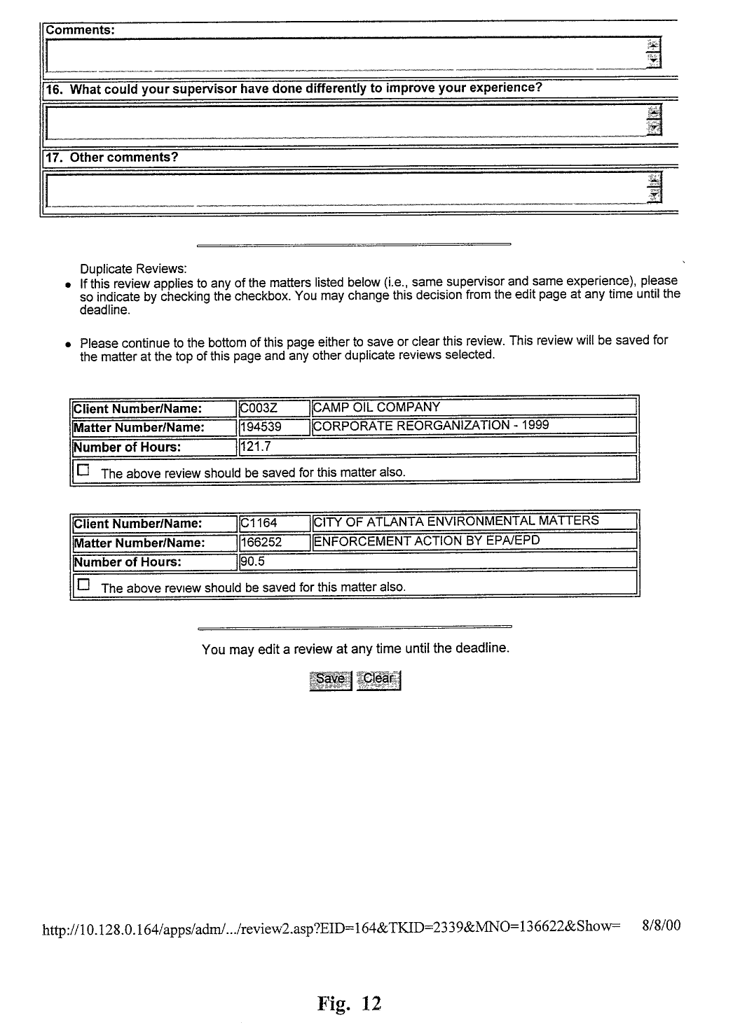

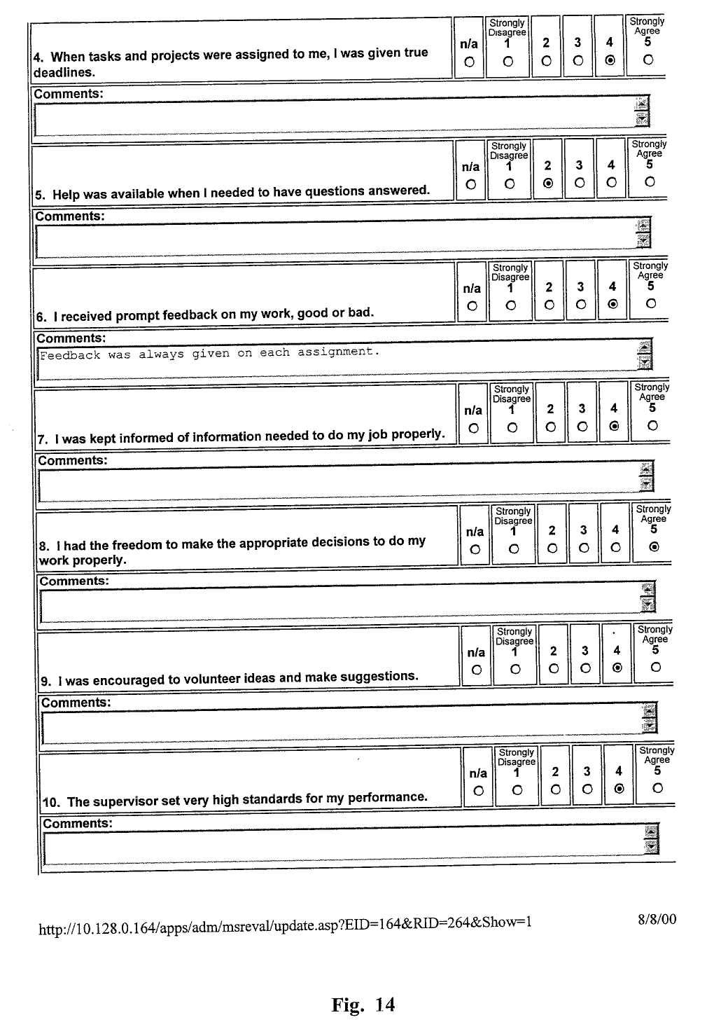

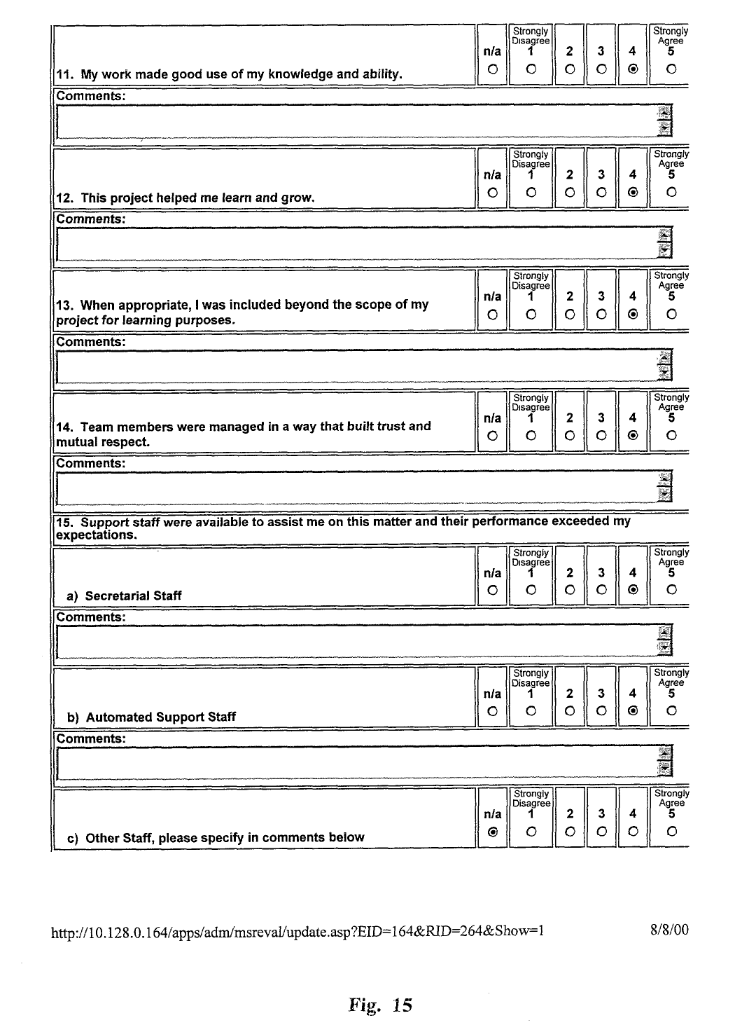

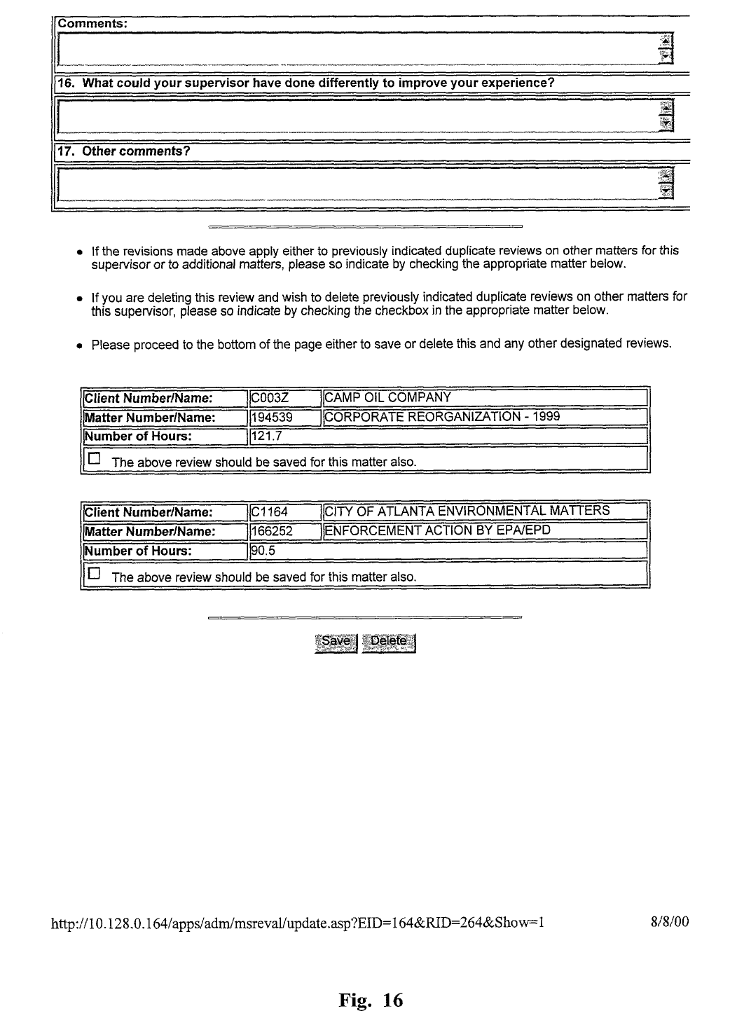

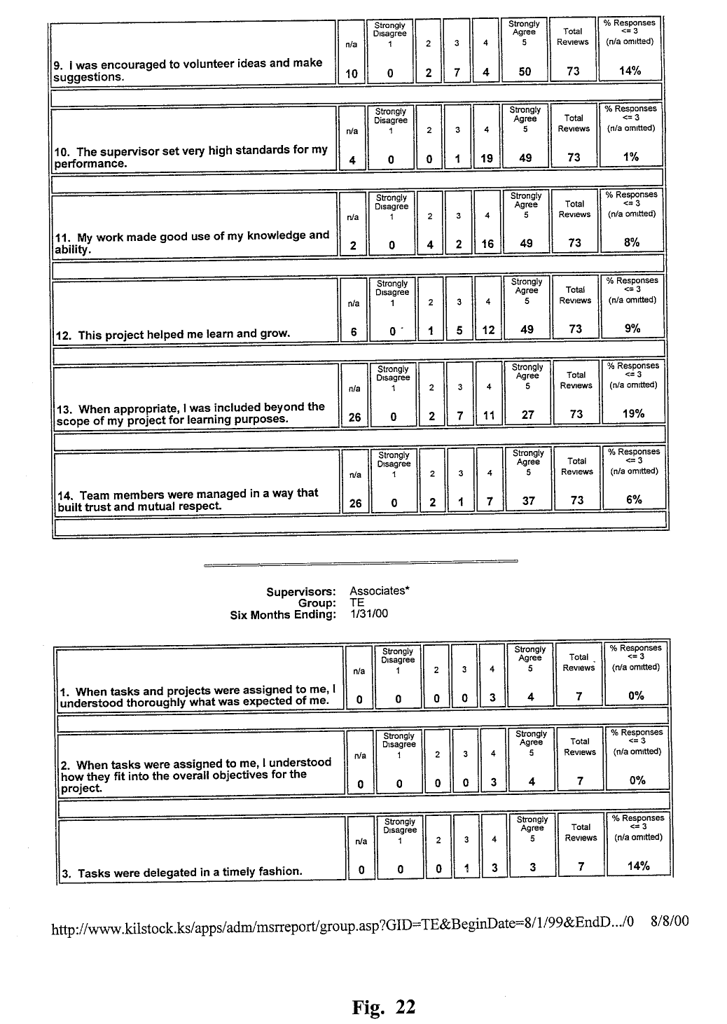

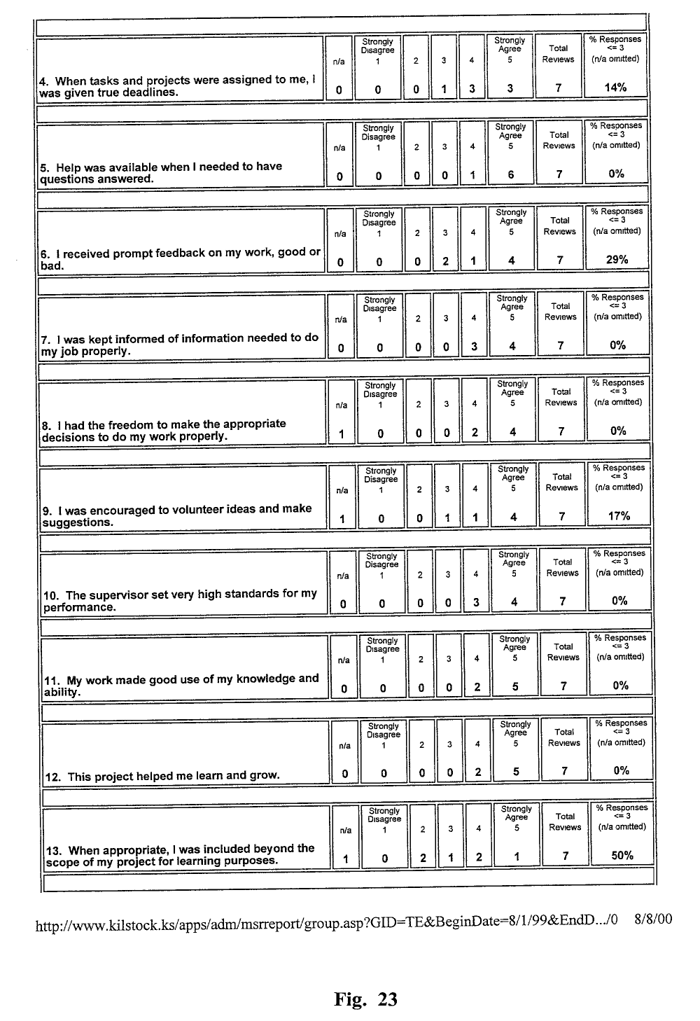

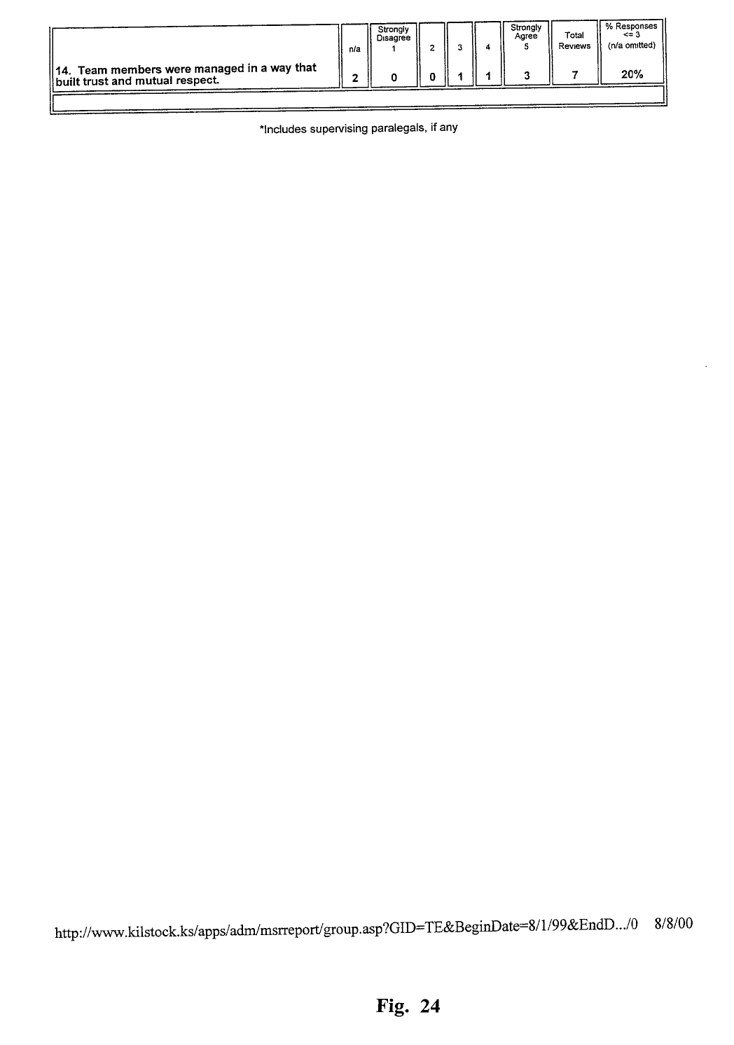

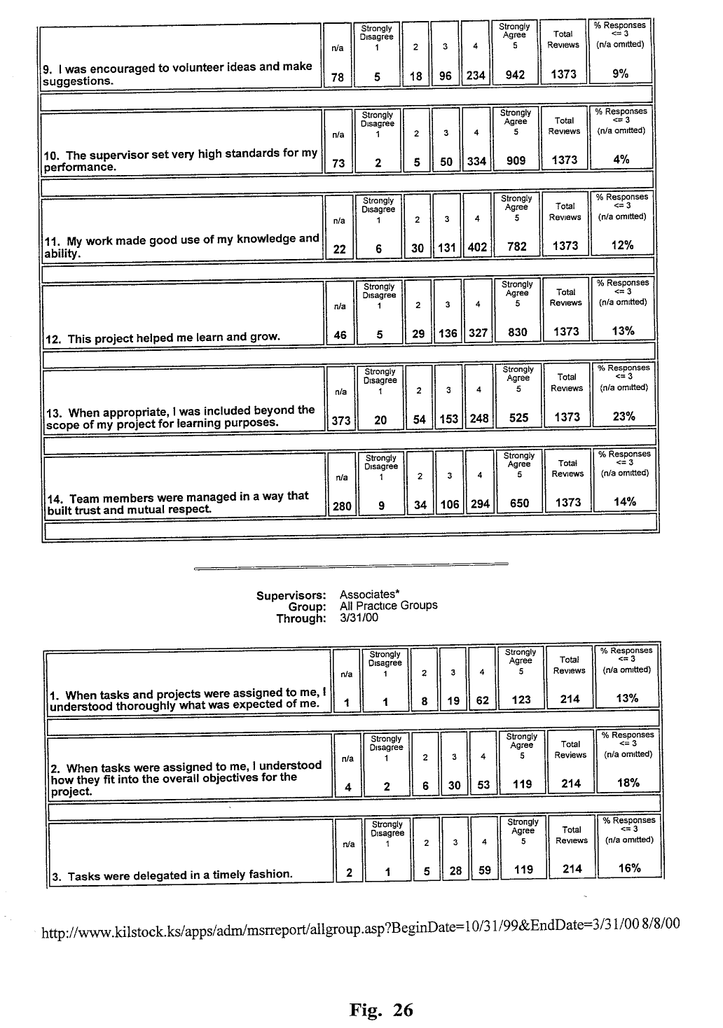

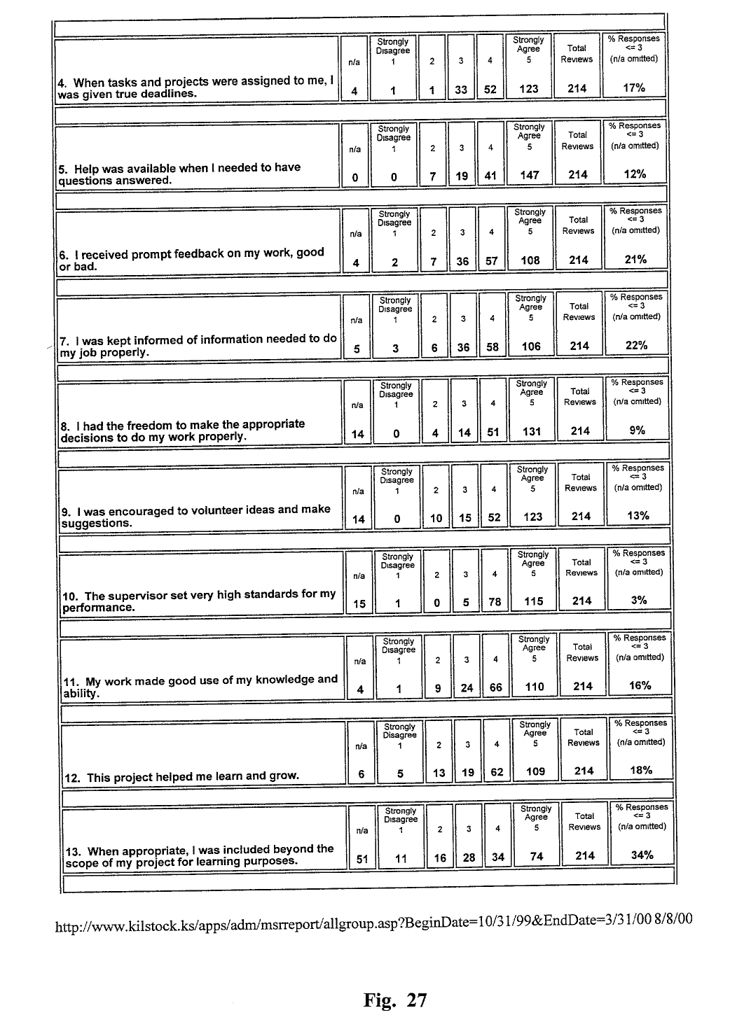

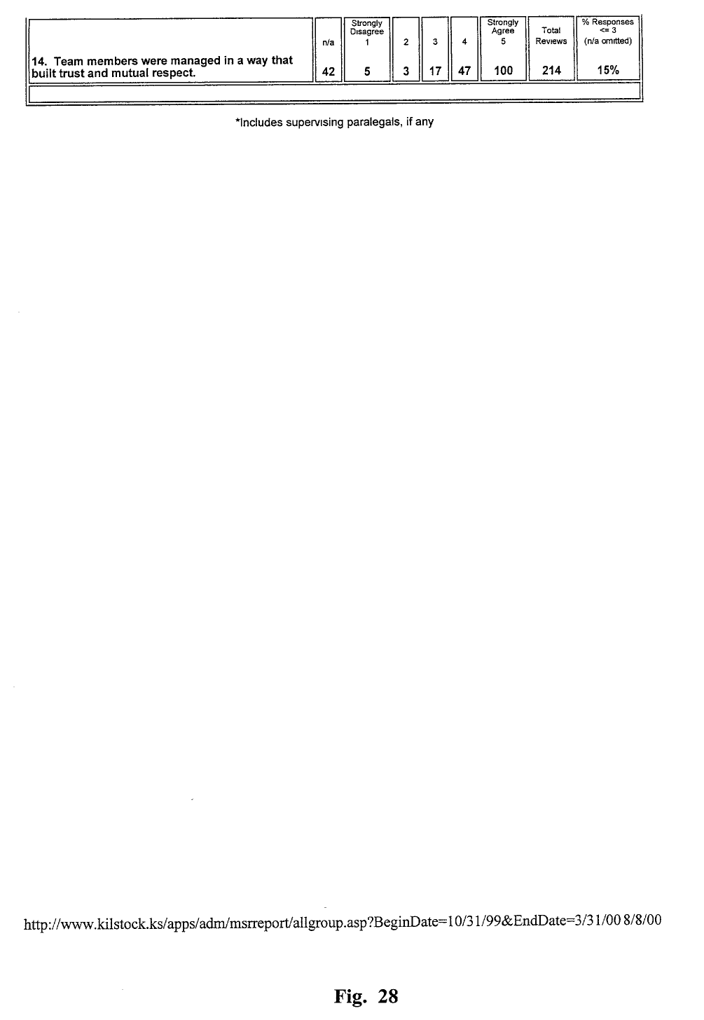

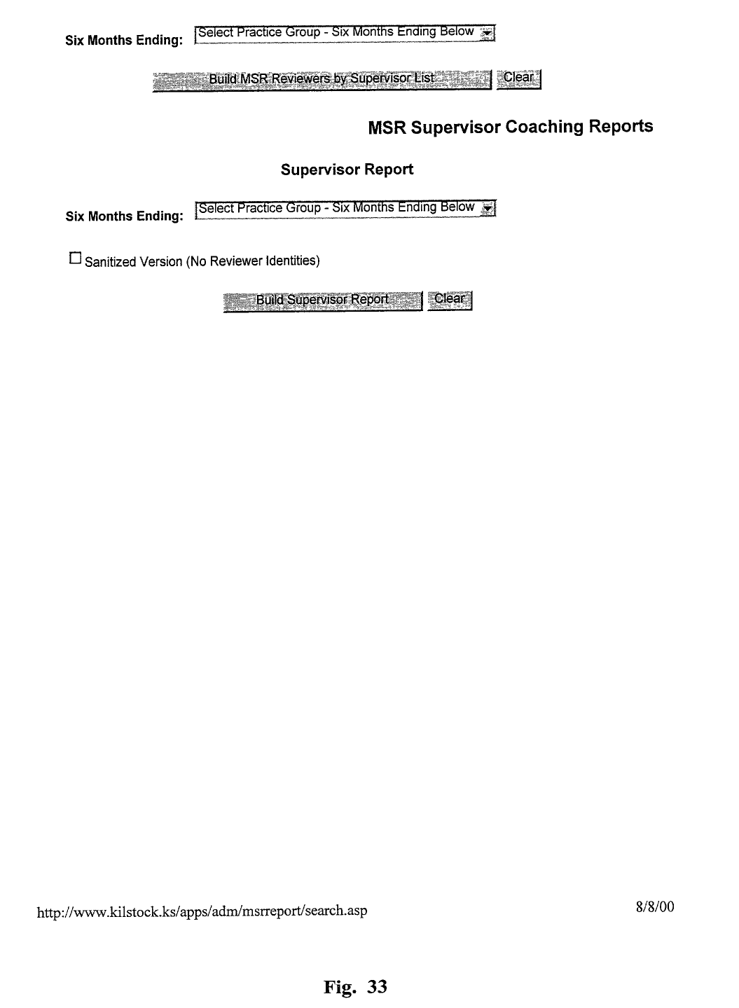

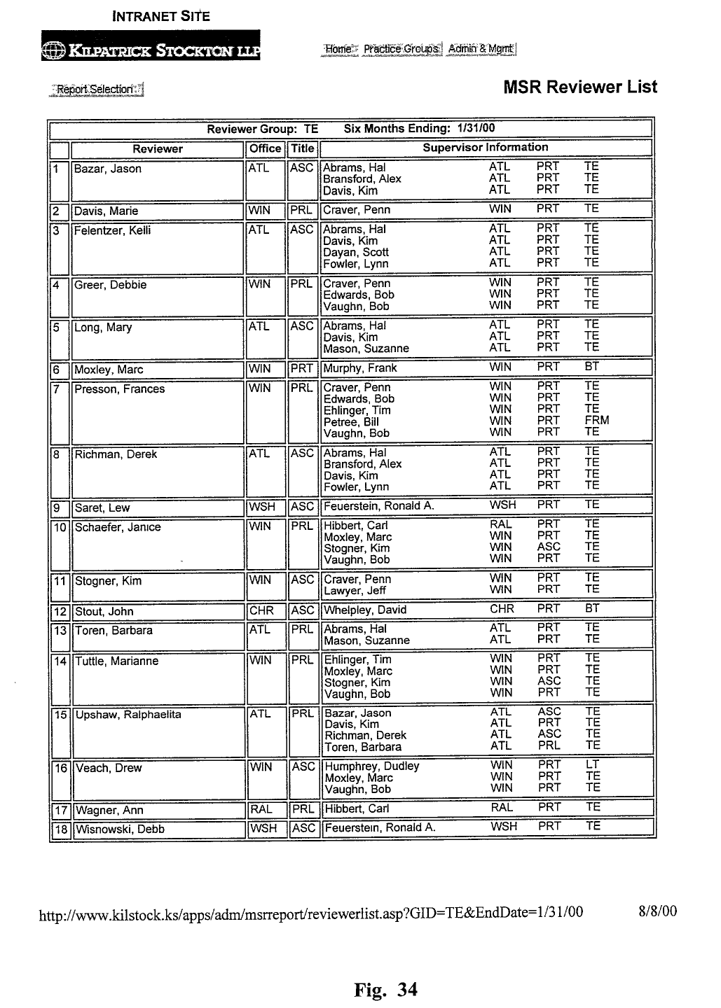

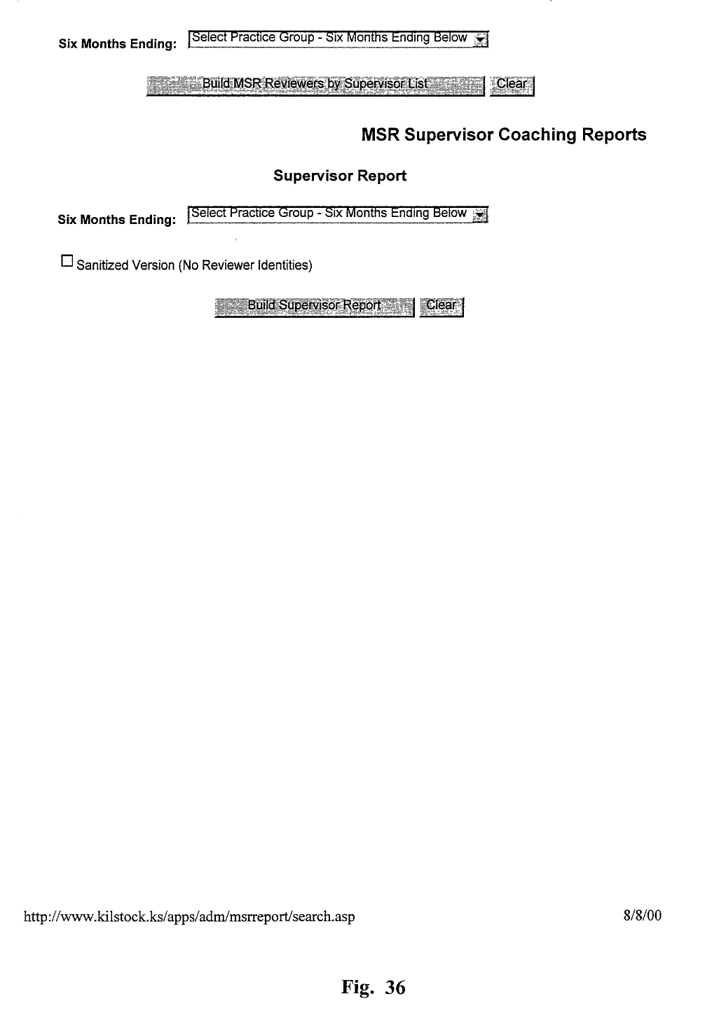

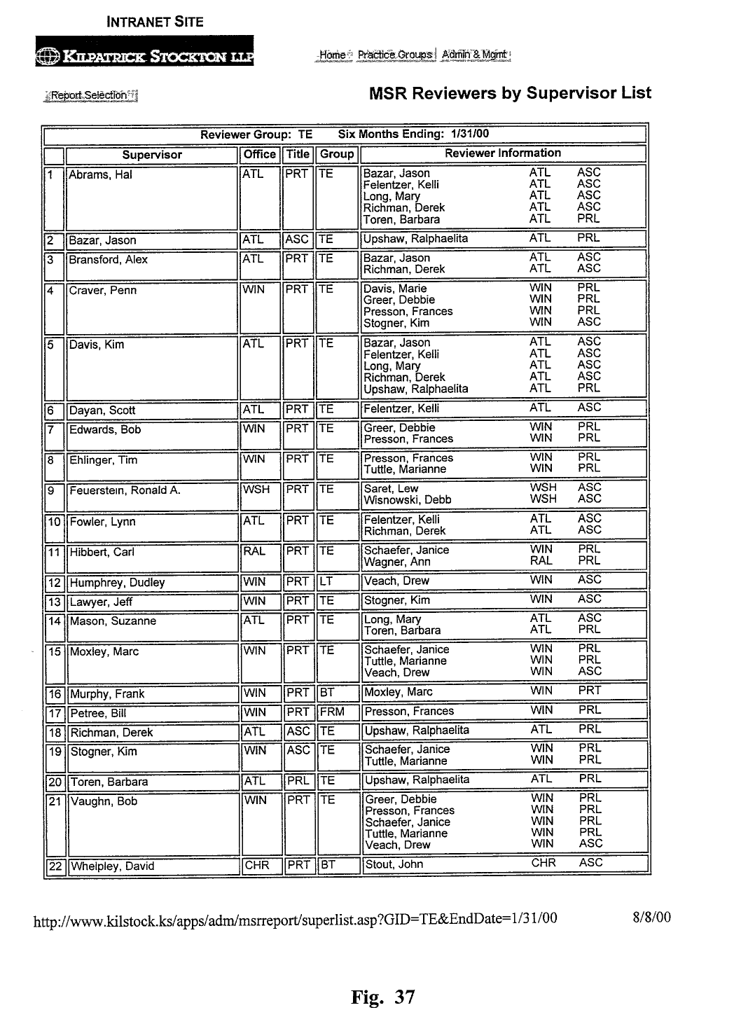

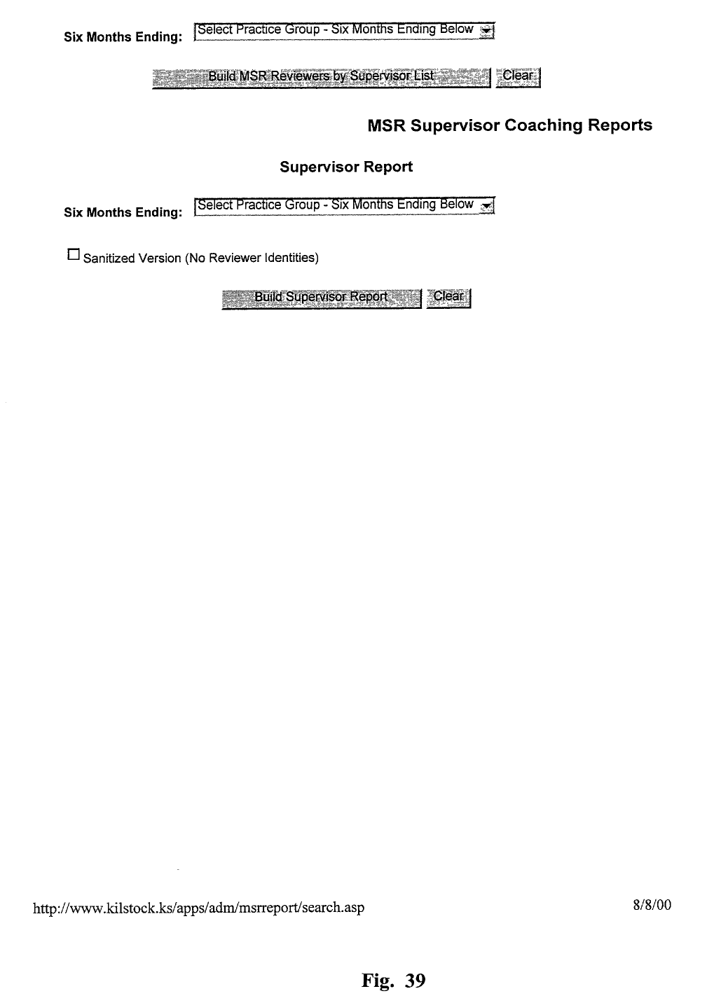

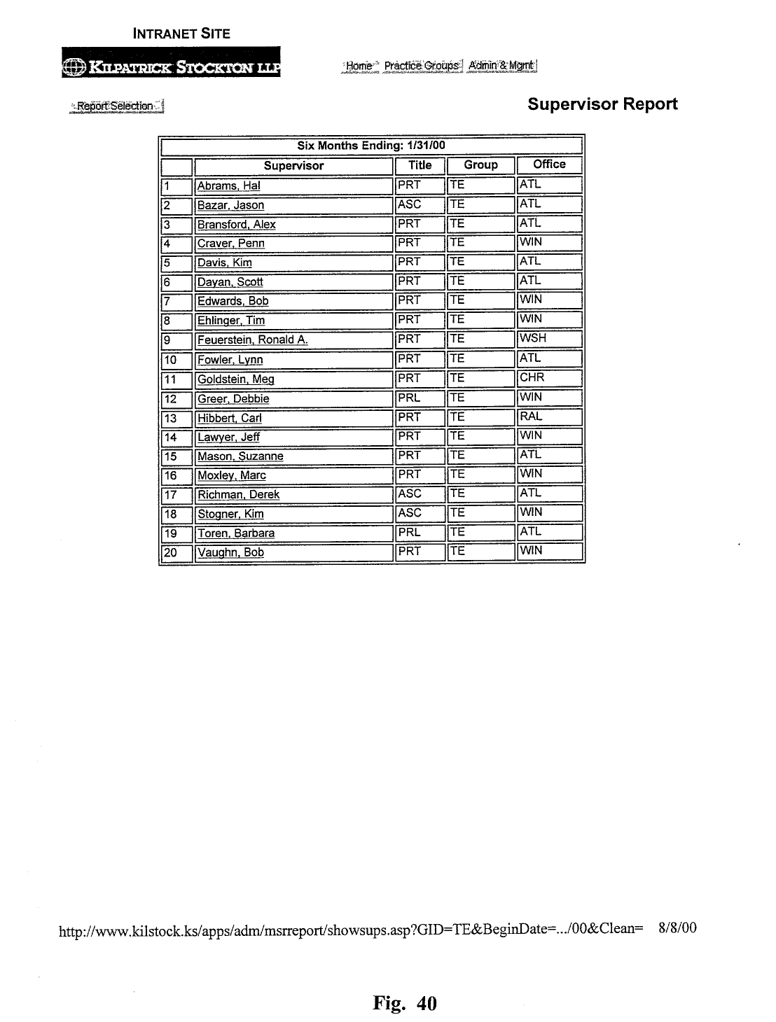

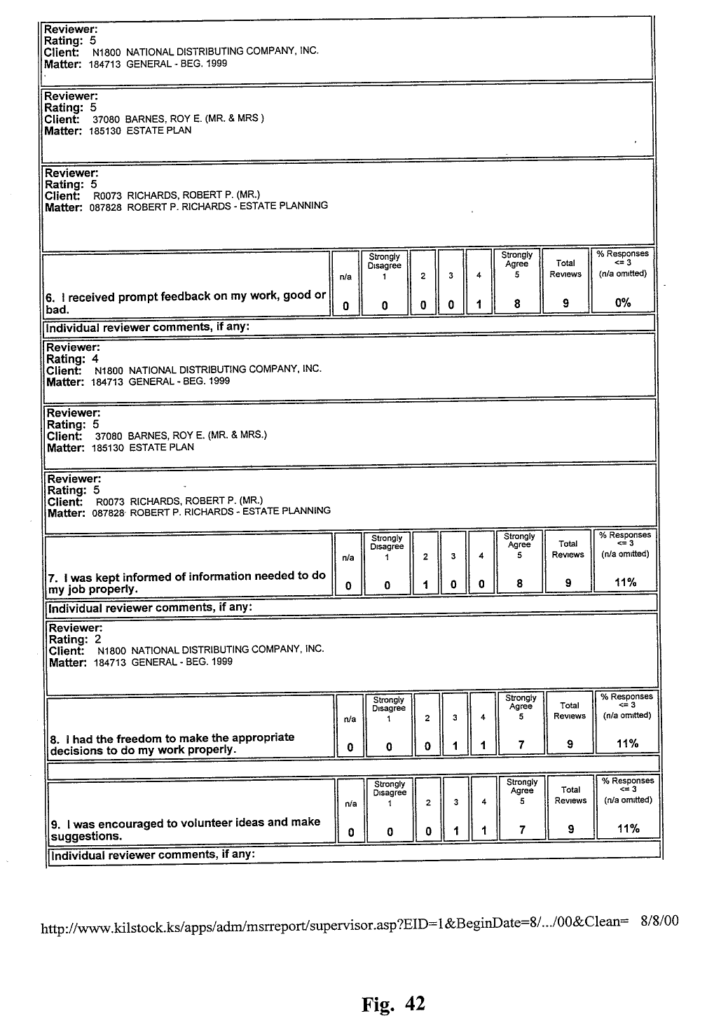

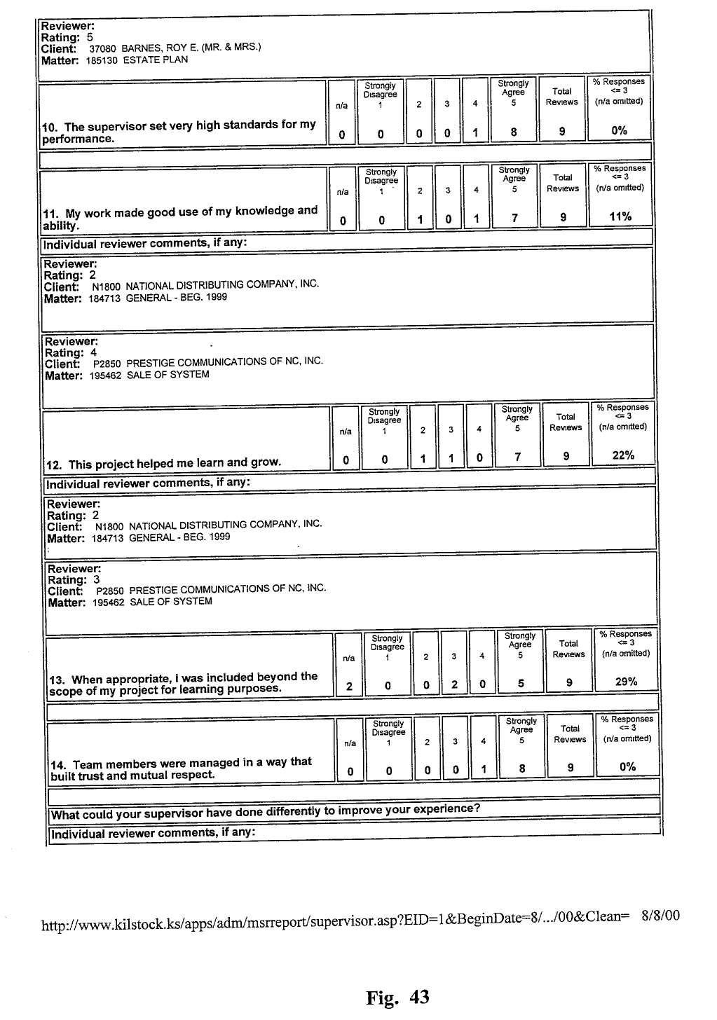

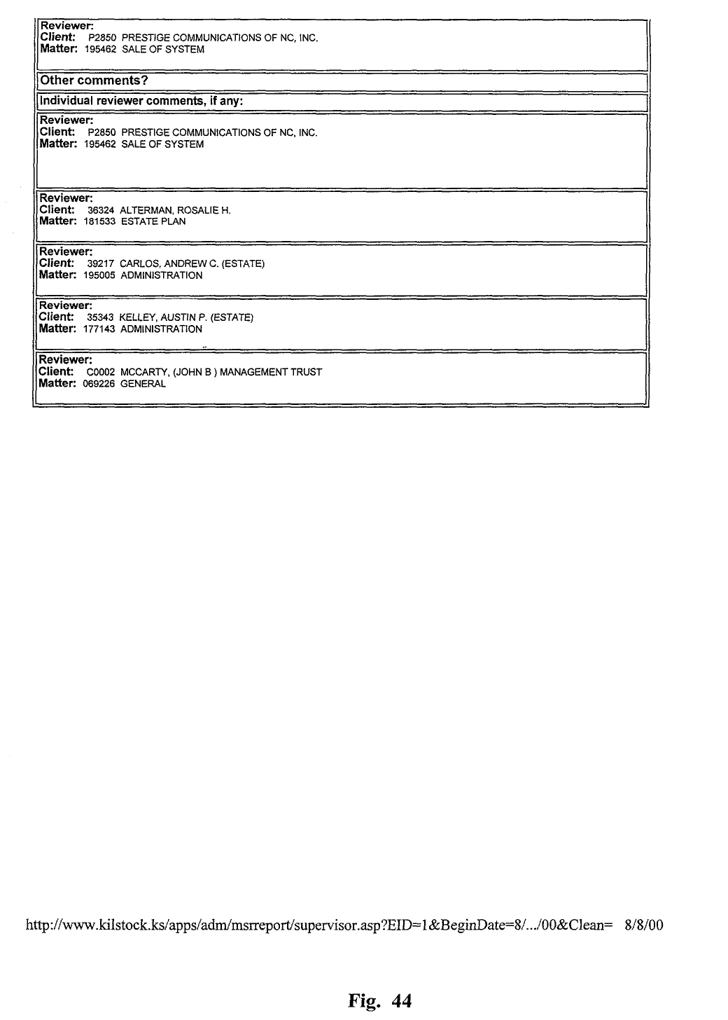

FIGS. 5-44 show the management supervision review process of FIG. 1 in more detail. FIGS. 5-8 introduce the reviewer and summarize the top three billable matters on which reviews are solicited. FIGS. 9-12 are a review form for a particular matter shown in FIGS. 6-8. The review solicits information from the reviewer using a strongly disagree/strongly agree or other desired button rating scale, together with a comment field. Any other desired interface may be used. Information is sought, among other things, on: (1) When tasks and projects were assigned to the reviewer, whether the reviewer understood thoroughly what was expected. (2) When tasks were assigned, whether the reviewer understood how they fit into the overall objectives for the project. (3) Whether tasks were delegated in a timely fashion. (4) When tasks and projects were assigned, whether the deadlines were true. (5) Whether help was available when the reviewer needed to have questions answered. (6) Whether the reviewer received prompt feedback on their work, good or bad. (7) Whether the reviewer was kept informed of information needed to do the job properly. (8) Whether the reviewer had the freedom to make the appropriate decisions to do their work properly. (9) Whether the reviewer was encouraged to volunteer ideas and make suggestions. (10) Whether the supervisor set very high standards for performance. (11) Whether the work made good use of the reviewer's knowledge and ability. (12) Whether the project helped the reviewer learn and grow. (13) When appropriate, whether the reviewer was included beyond the scope of their project for learning purposes. (14) Whether team members were managed in a way that built trust and mutual respect. (15) Whether support staff were available to assist the reviewer on the matter and on their level of performance. (16) What the supervisor could have done differently to improve the experience. Other areas can also be queried, and all of these need not be.

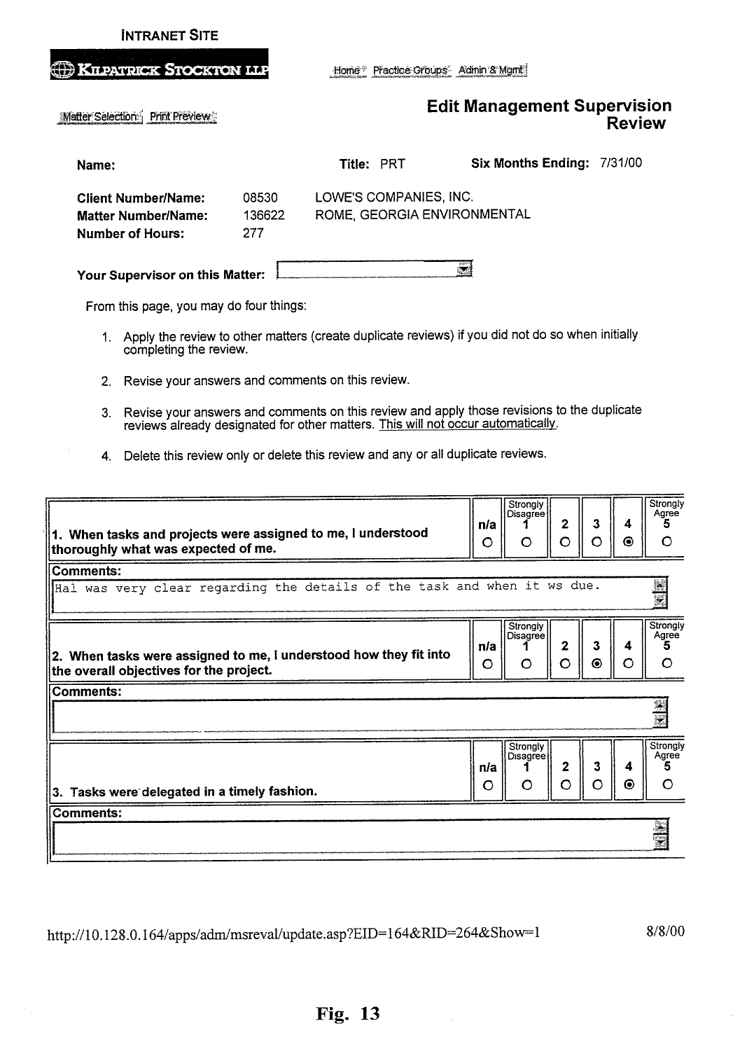

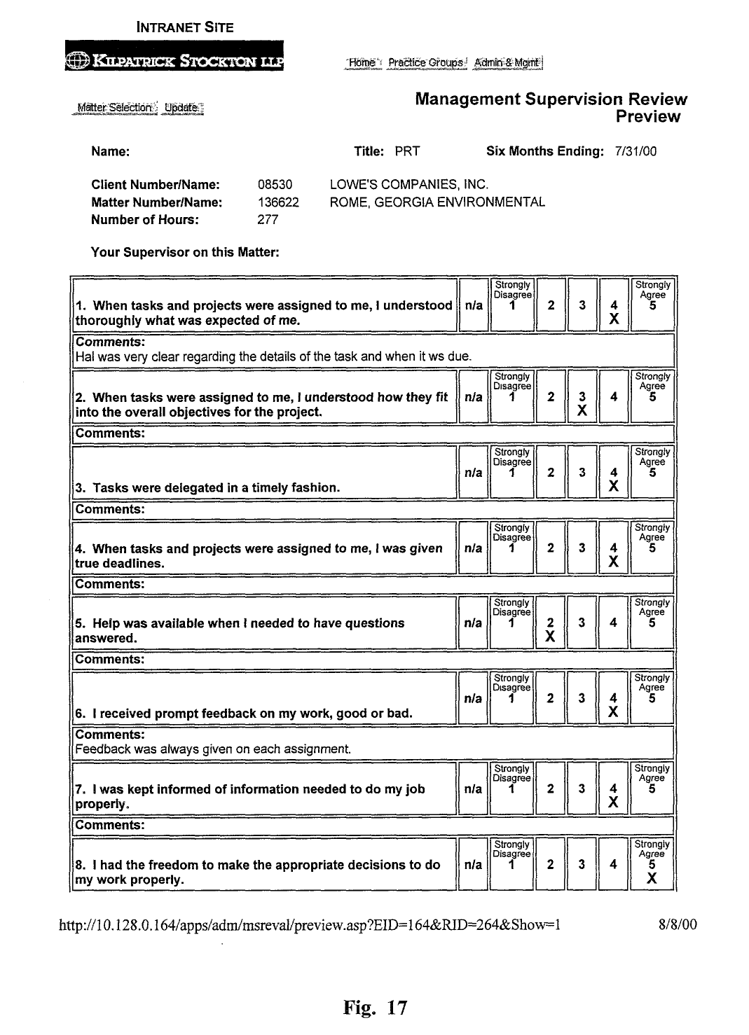

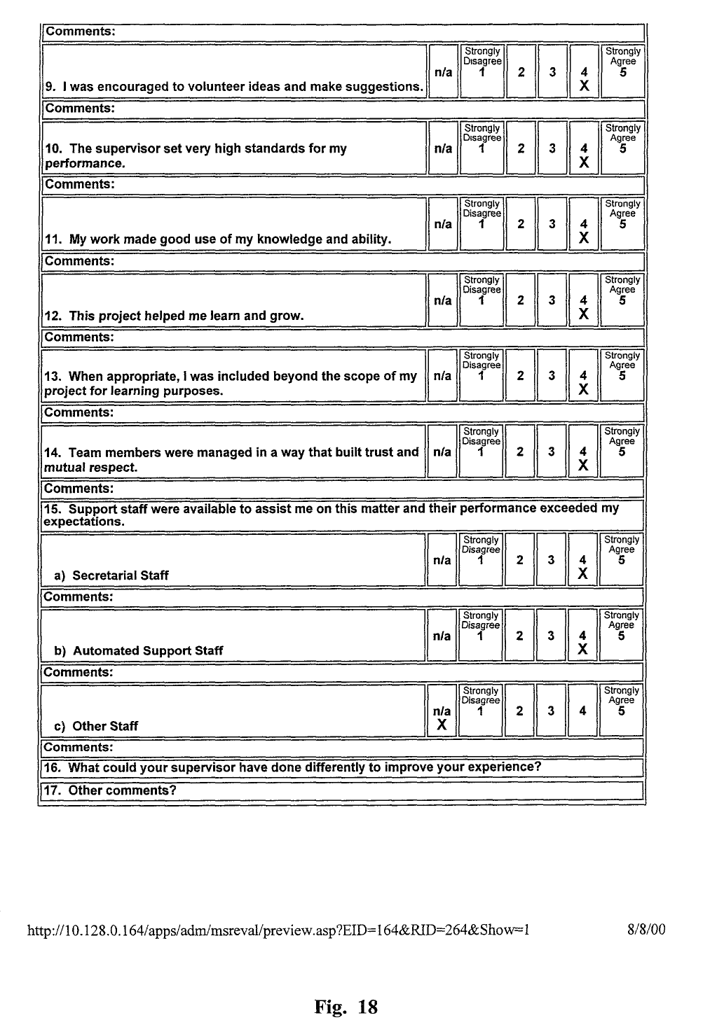

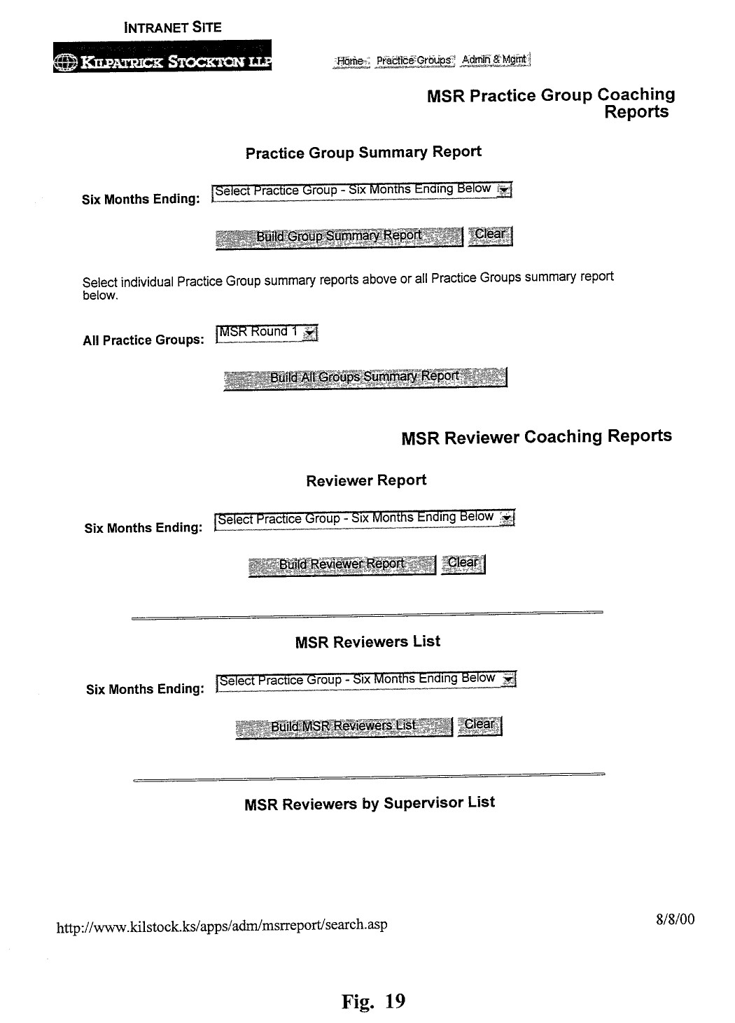

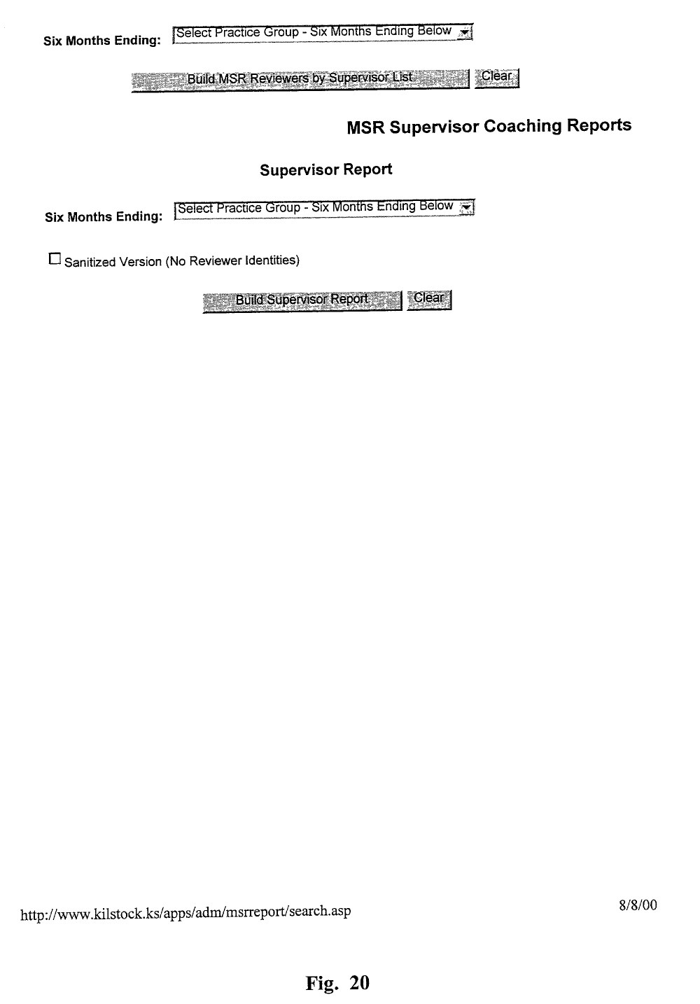

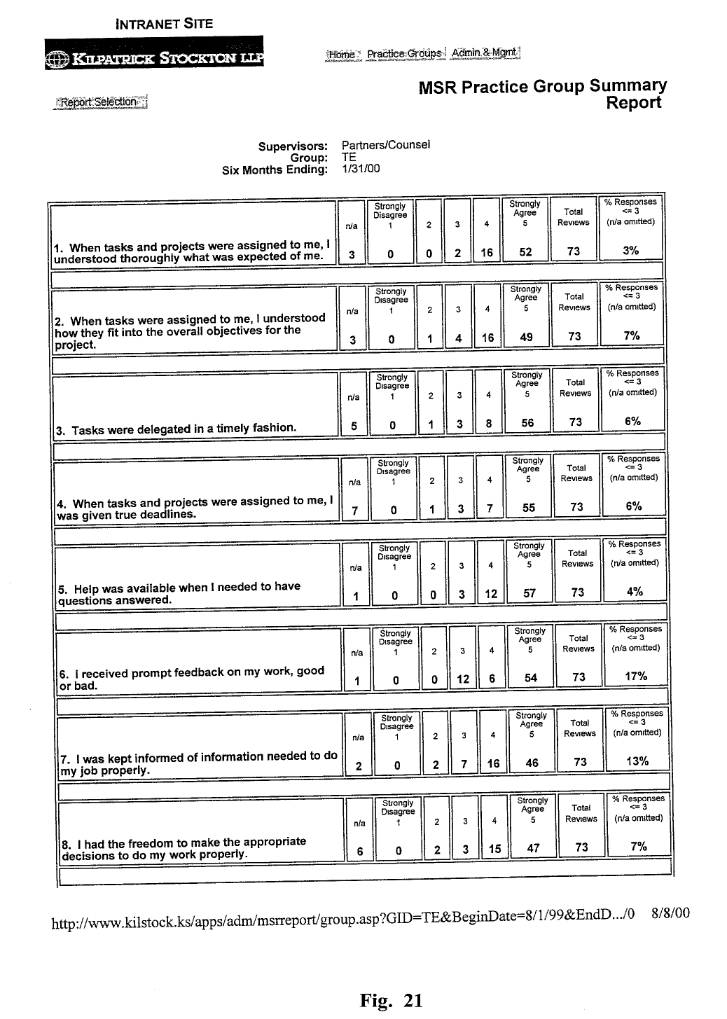

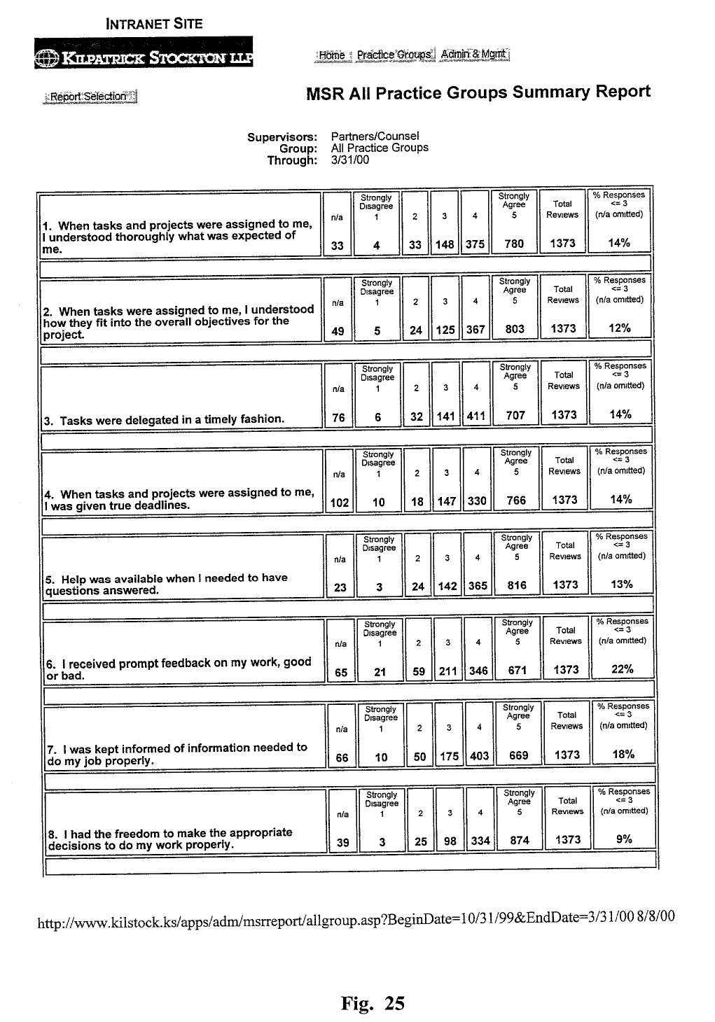

FIGS. 13-16 allow the MSR to be edited. FIGS. 17 and 18 are a report generated corresponding to the MSR shown in FIGS. 9-12. FIGS. 19 and 20 are a coaching report interface that allow reports to be requested and generated. FIGS. 21-24 are a summary report of MSRs in a particular practice group. FIGS. 25-28 summarize MSR input for all practice groups in the law firm for coaching and other purposes.

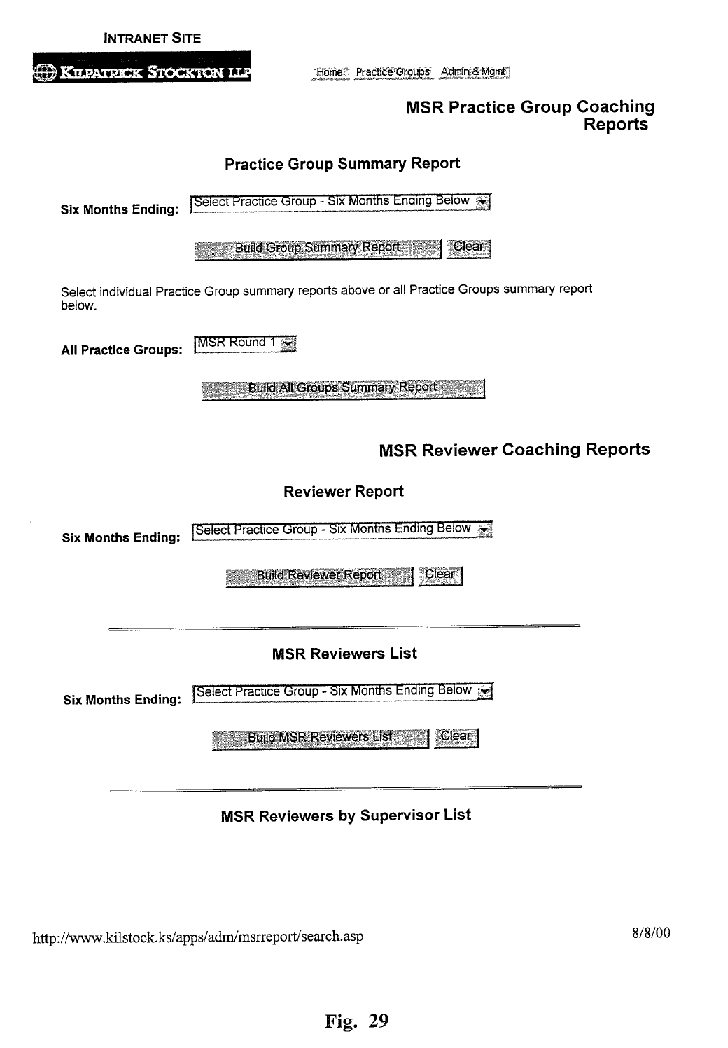

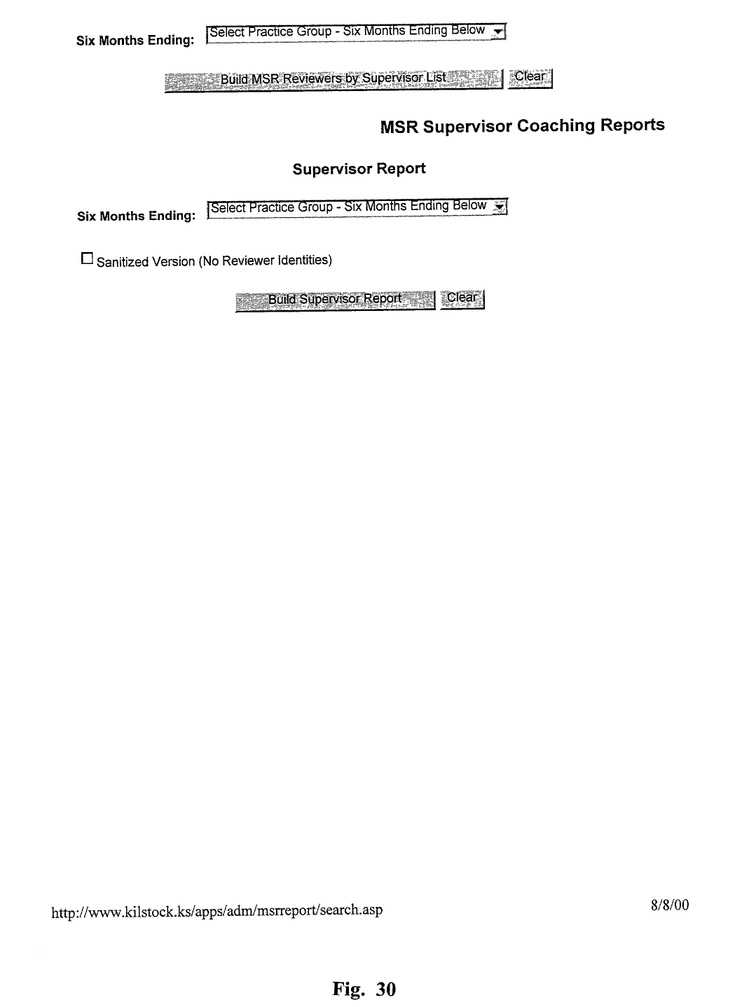

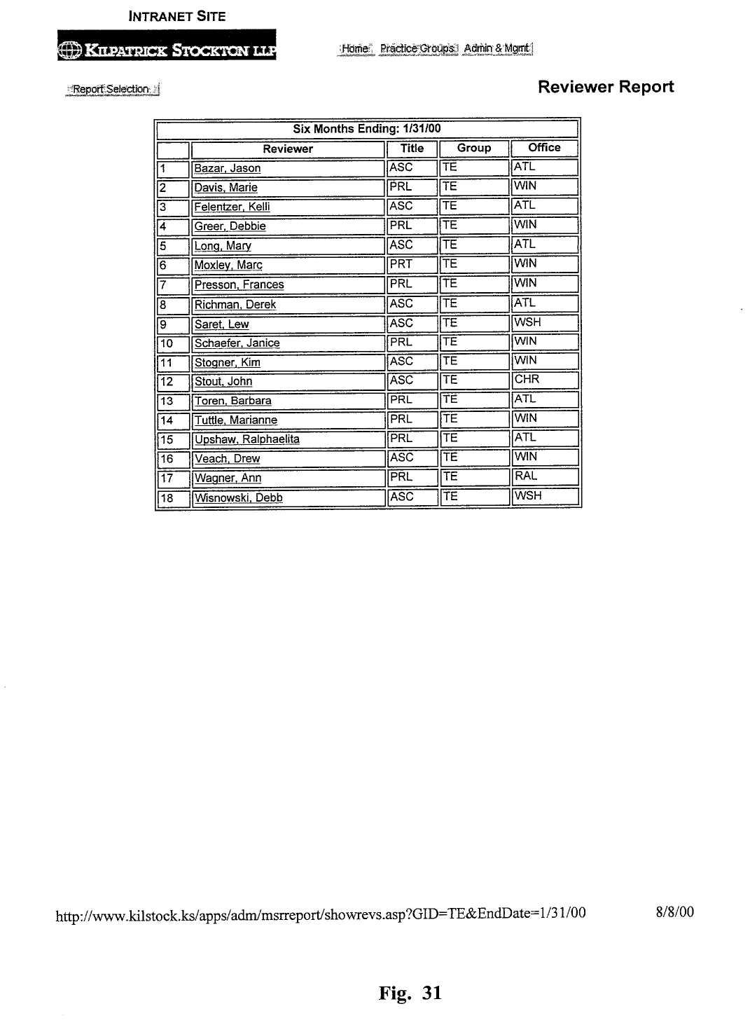

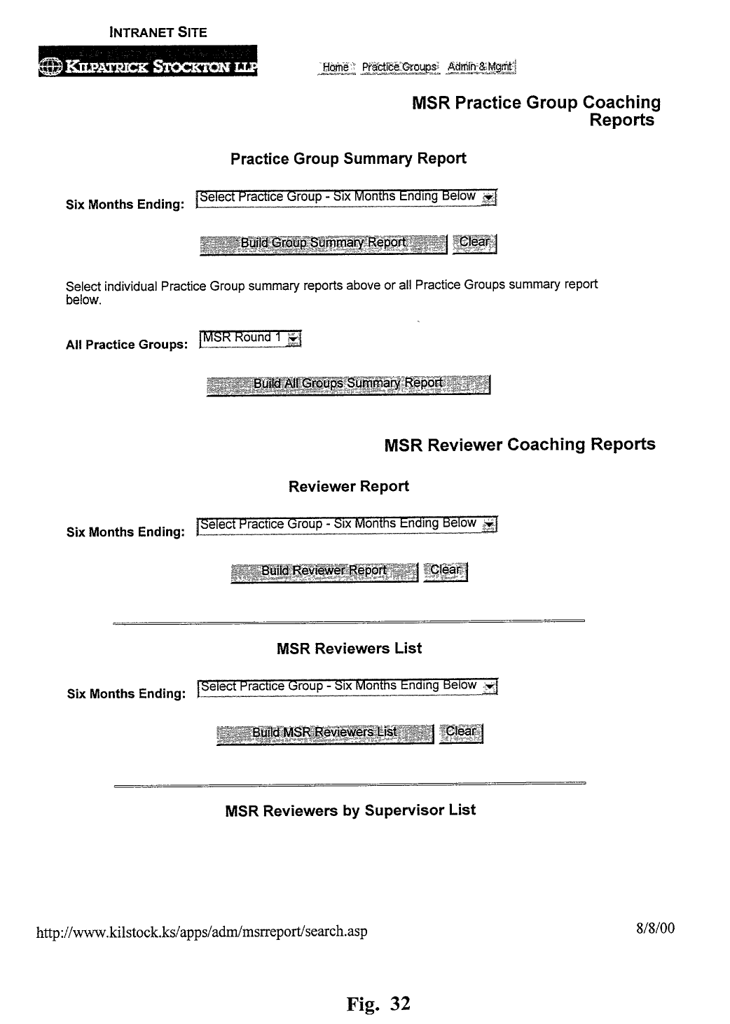

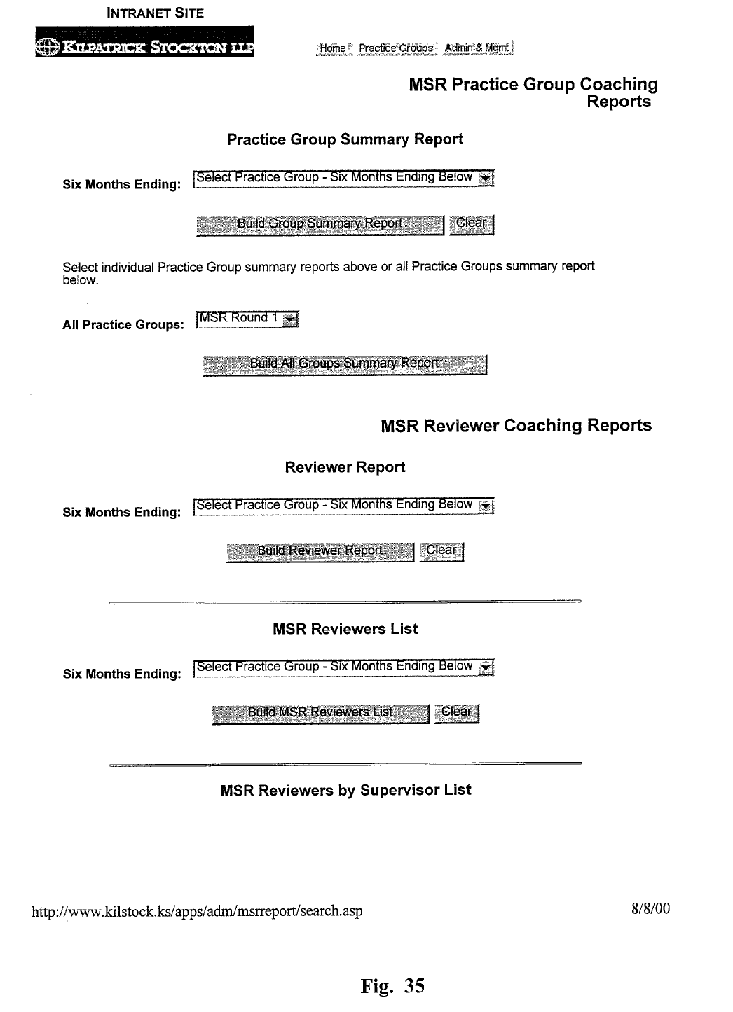

FIGS. 29 and 30 are additional practice group reports giving the option to prepare reports by reviewer. FIG. 31 is a screen shot showing such a report. FIGS. 32-34 are the interface allowing coaching reports broken down by group and showing more detailed information about reviewers and supervisors. FIGS. 35-39 are interfaces for requesting reports and a report generated according to the request for a particular practice group sorted by supervisor.

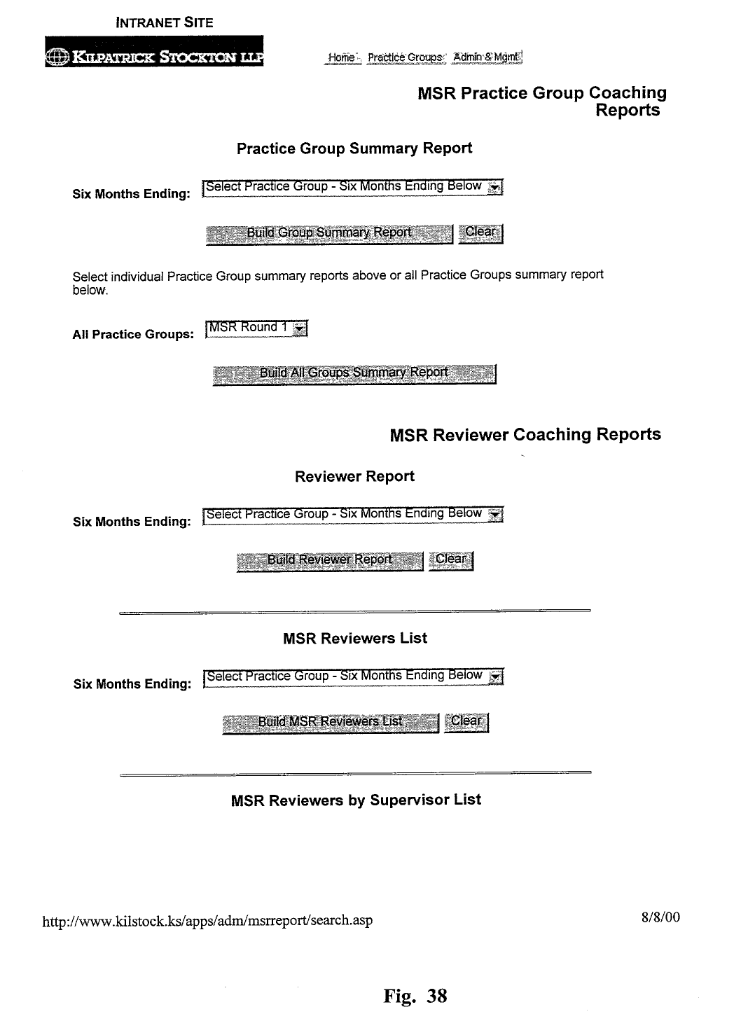

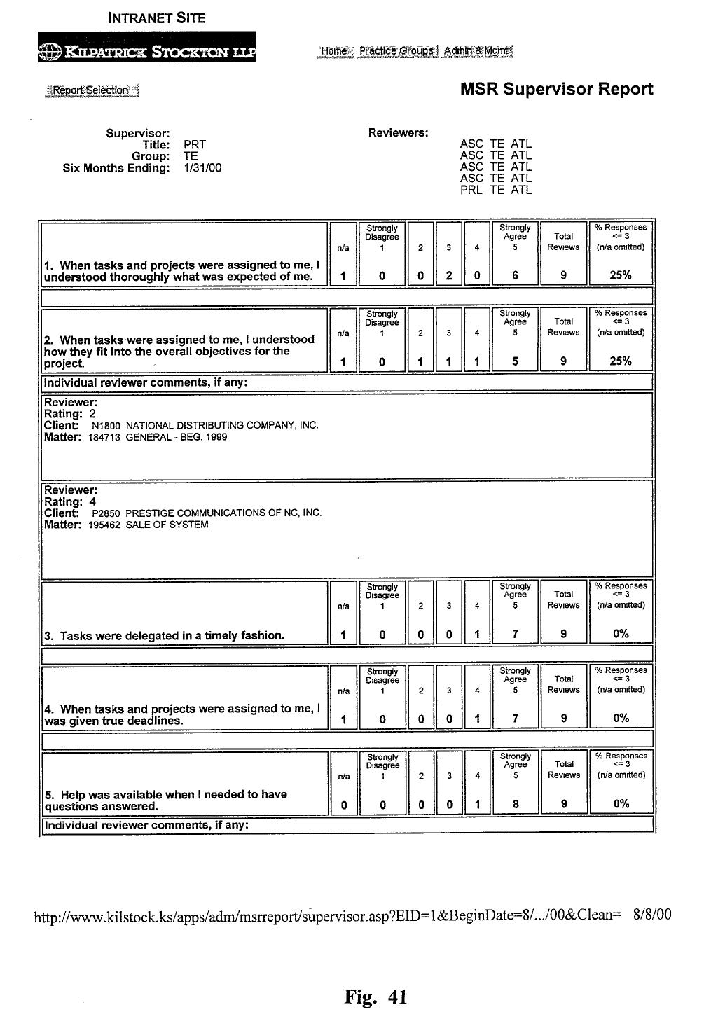

FIGS. 38-40 show an interface for obtaining a report of supervisors who have been reviewed and FIGS. 41-44 are a report for a particular supervisor summarizing input from all of the reviewers who have completed reviews forms. Thus, each employee can be solicited for detailed review of their supervisor by particular matters on which they work.

That information can be collected in the MSR database and then sorted and reported for use by coaches in working with supervisors to improve their supervisor performance. Access to the database for reporting purposes can be controlled using business rules tailored to the culture. For instance, bottom up review processes often create anxiety that retribution will occur. Accordingly, the coach can be an intermediary who obtains only summary information in which ratings and comments, for instance, are not reported with the particular timekeeper who input that information. The coach can then provide input and coaching to the supervisor in a way that shields the reviewer, if that is a concern. Furthermore, reviewer's access can be strictly controlled for input and edit purposes by password and other desired authentication functionality, which is conventional.

(B) Practice Development Planning

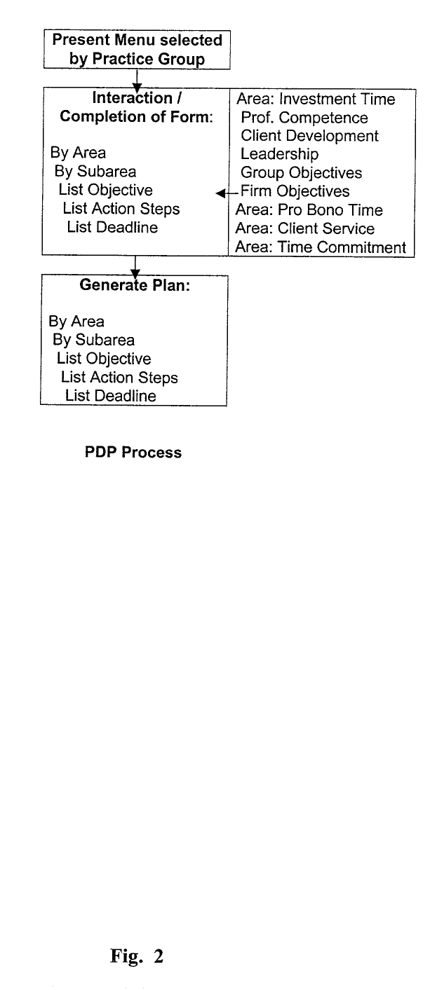

FIG. 2 is a process flow diagram showing practice development planning processes according to a preferred embodiment of the present invention. According to such processes, a clerical worker, associate, shareholder or other person is presented a form that allows them, in an automated and organized way, to develop a plan for developing their practice and/or career. The form is preferably organized according to four areas: (1) investment time; (2) pro bono time; (3) client service; and (4) time commitment. Investment time is preferably organized according to at least these categories or subareas: (a) professional competence; (b) client development (c) leadership: (d) practice group objectives; and (e) firm objectives.

After the planner has completed the automated process, the plan can be printed and disseminated electronically to coaches and others who have an interest in assisting in the career development.

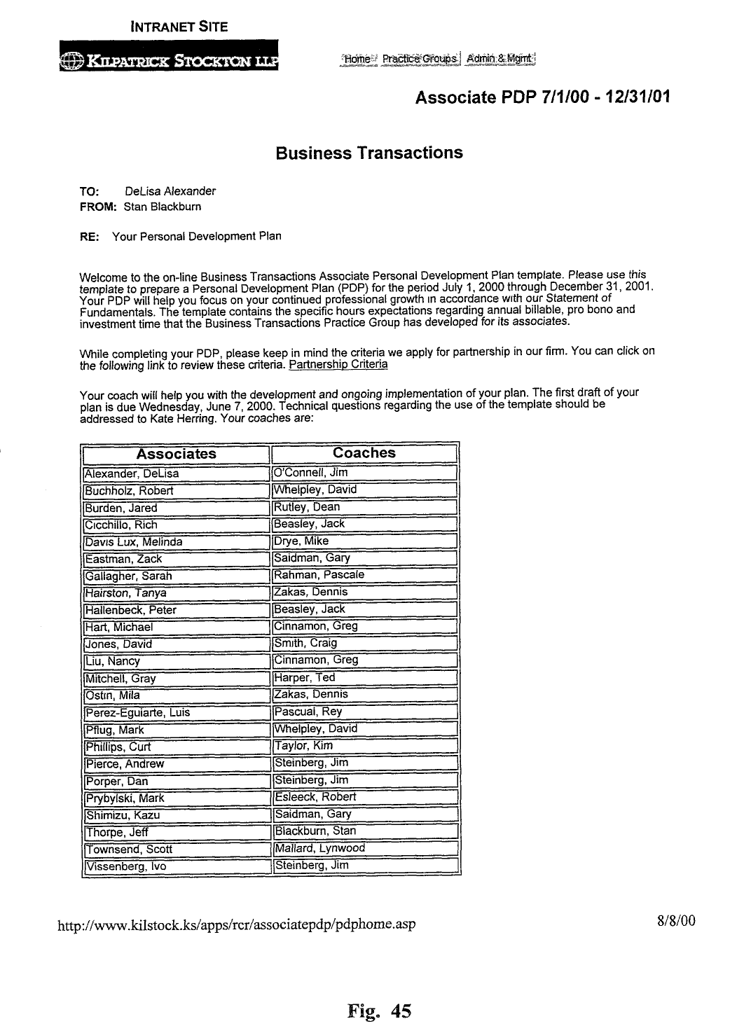

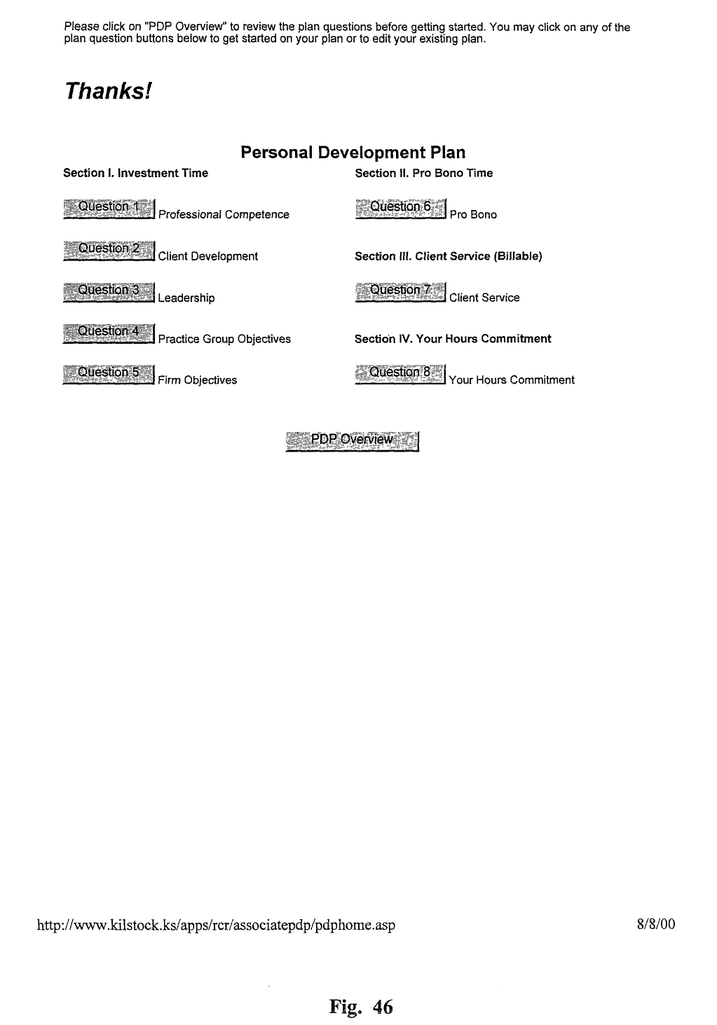

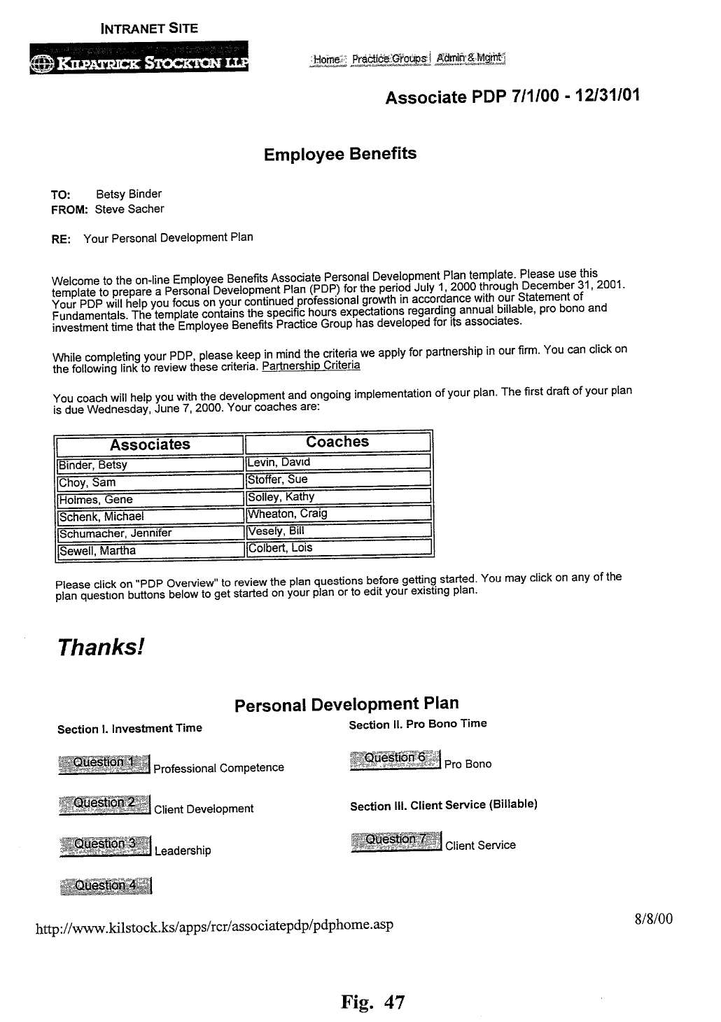

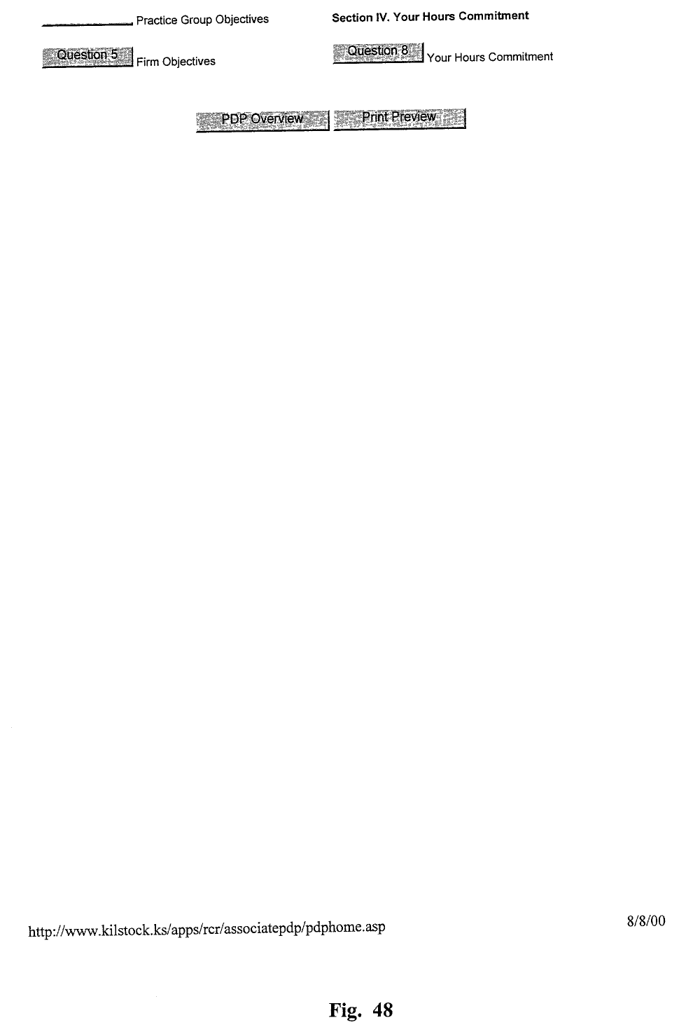

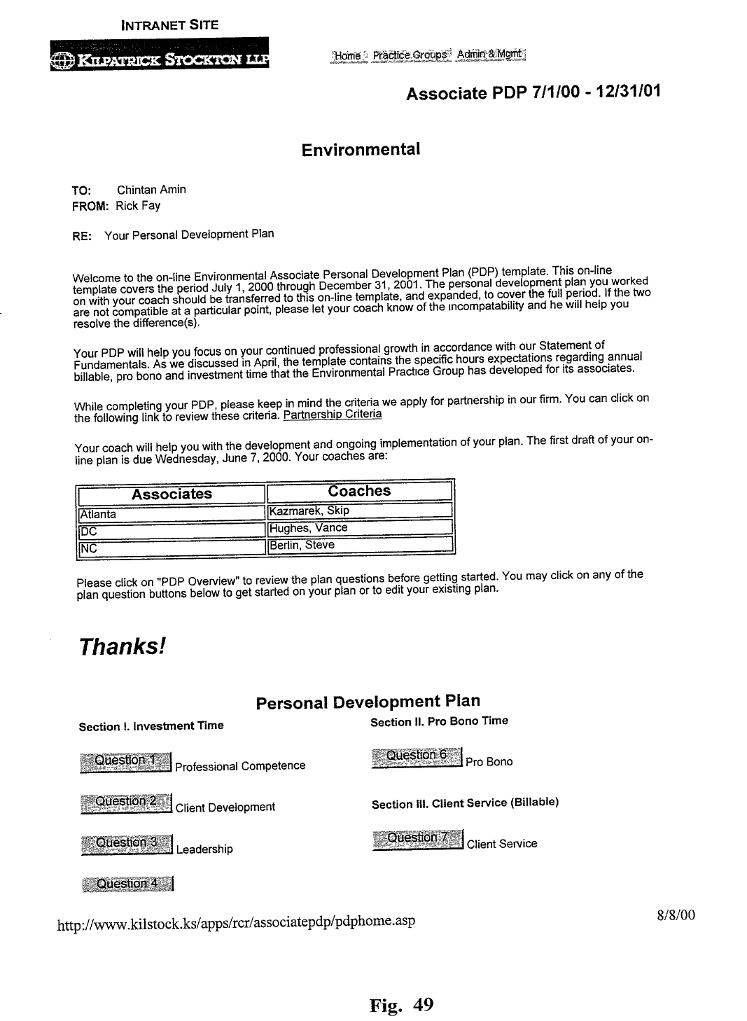

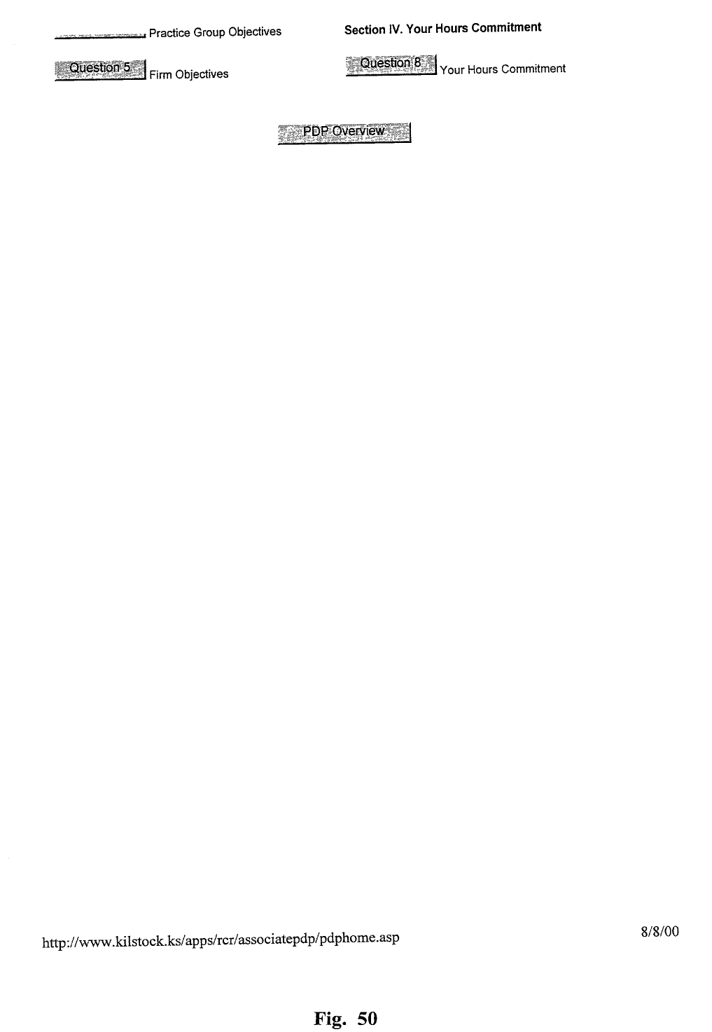

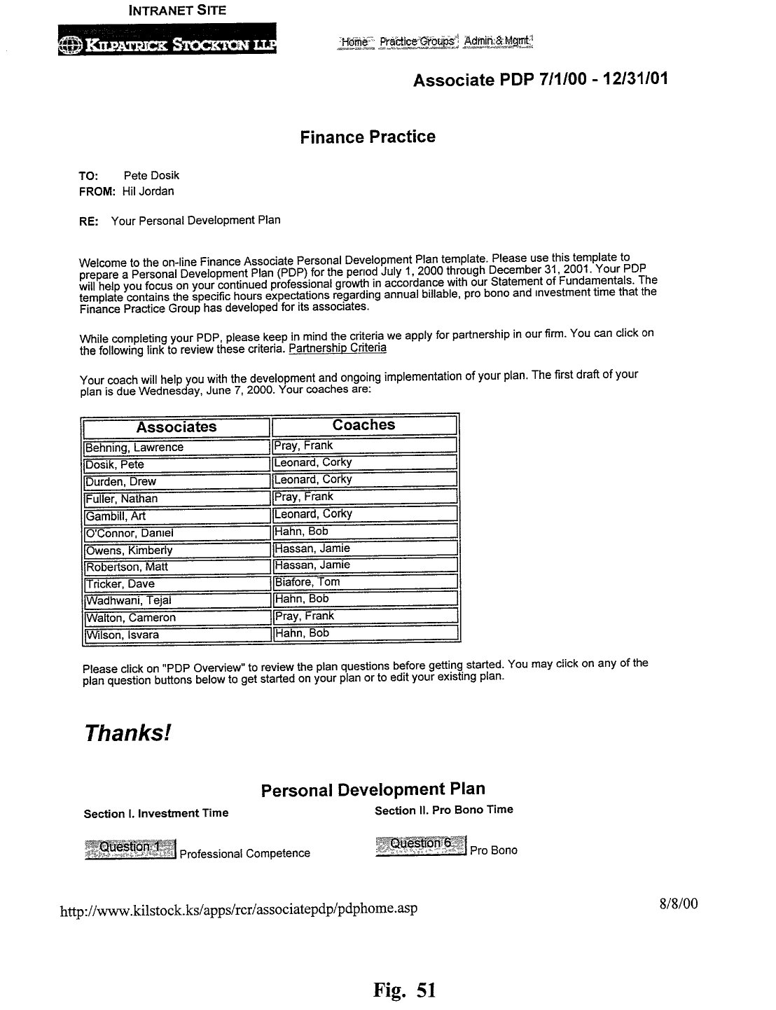

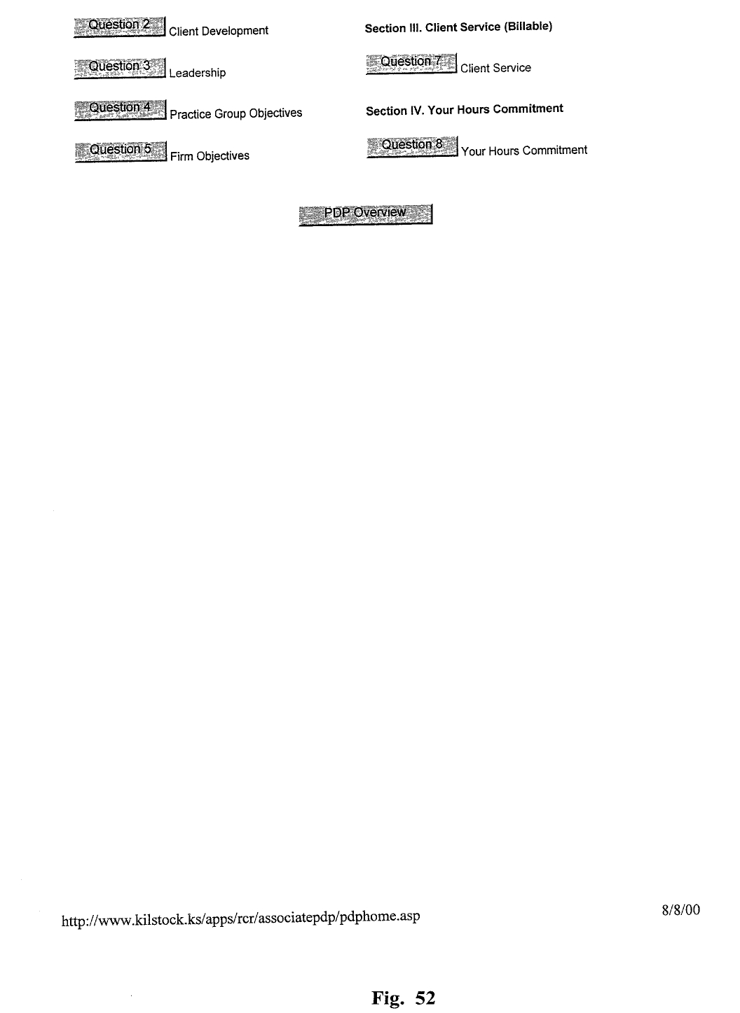

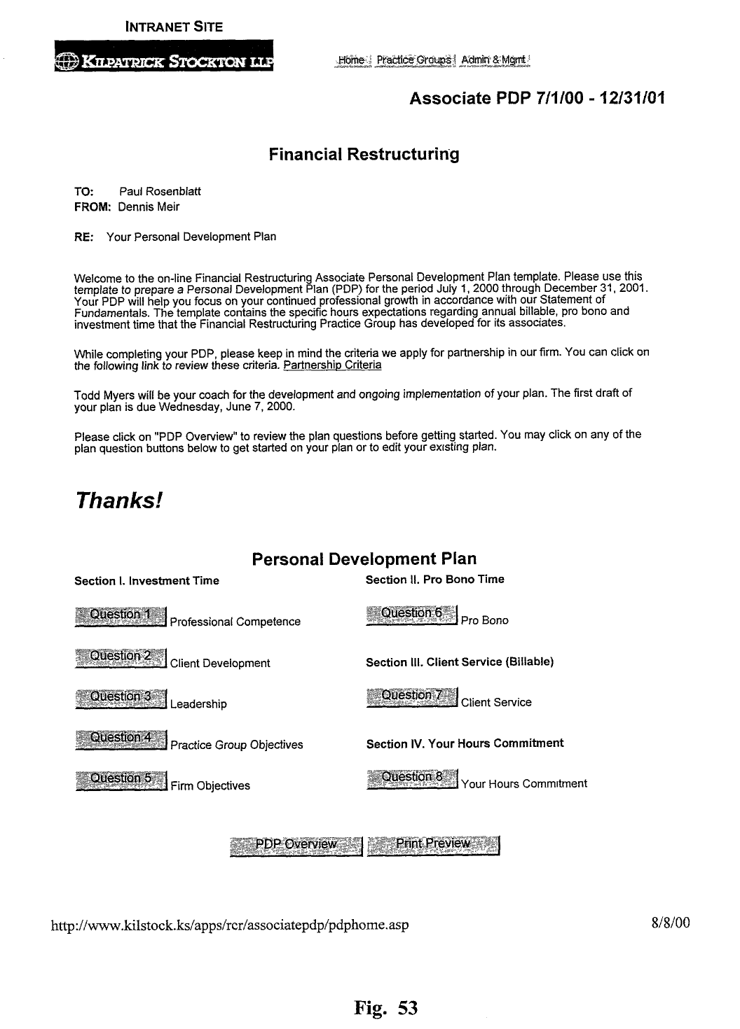

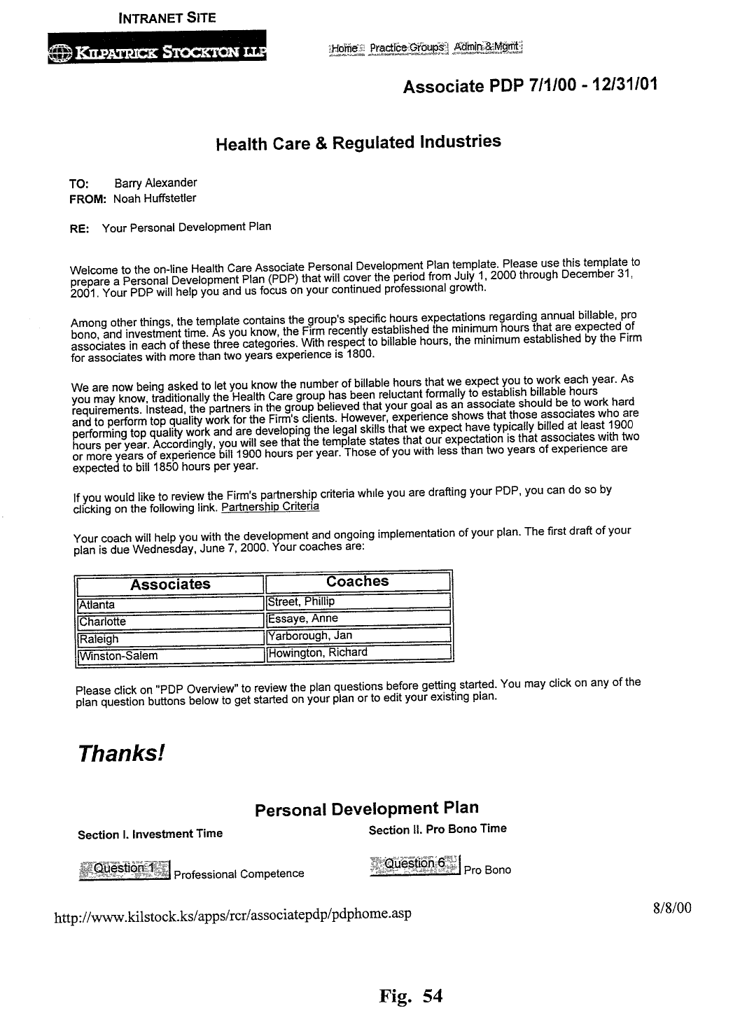

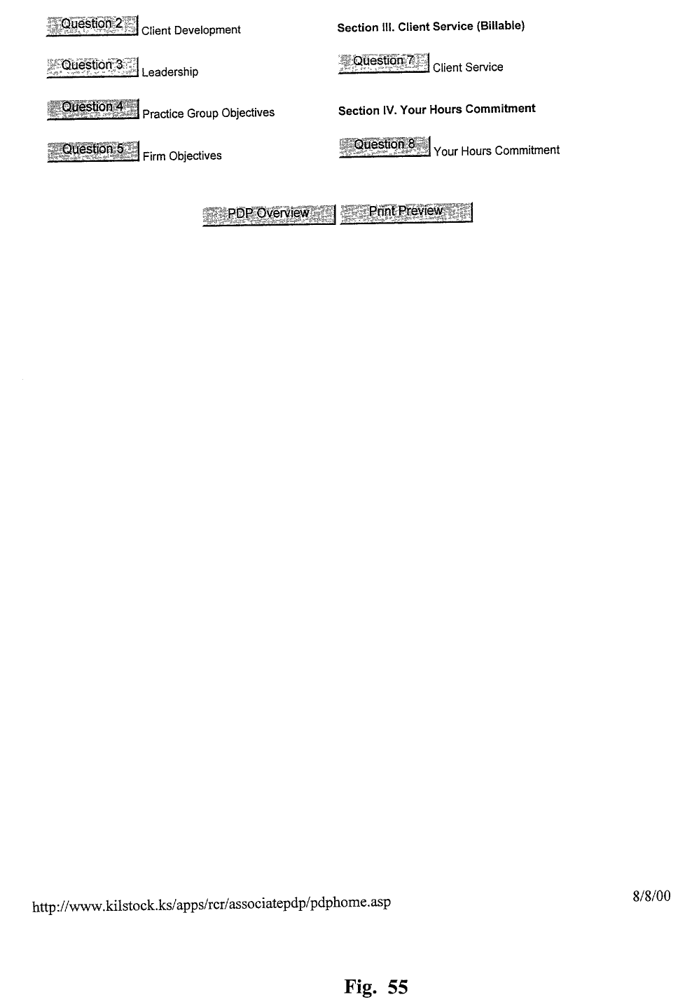

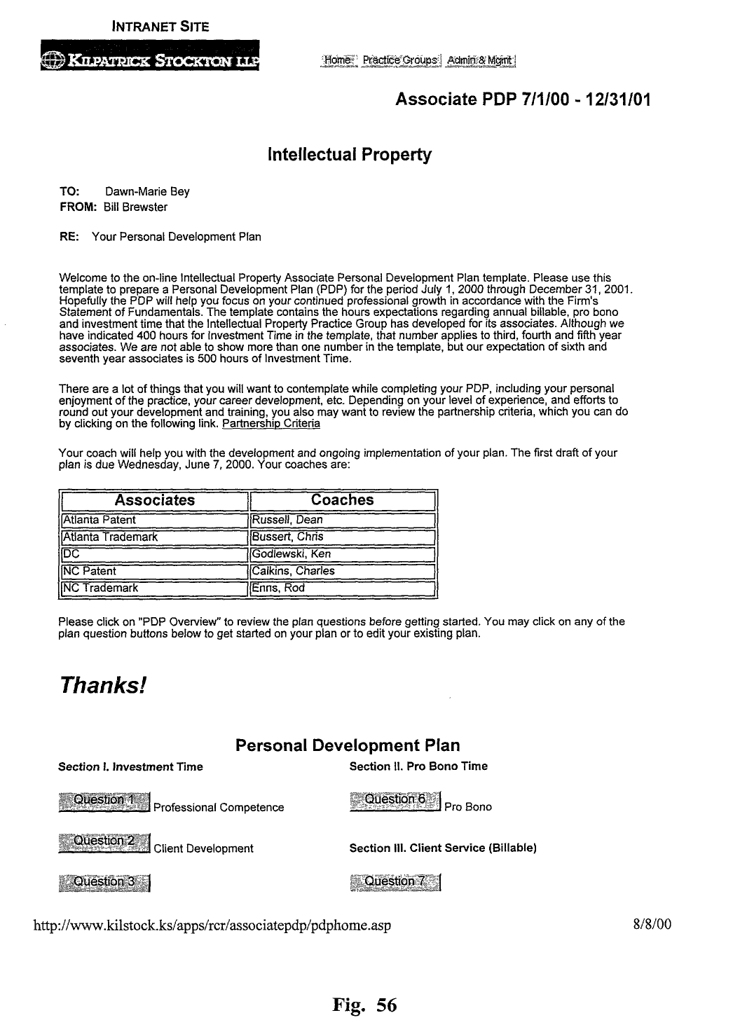

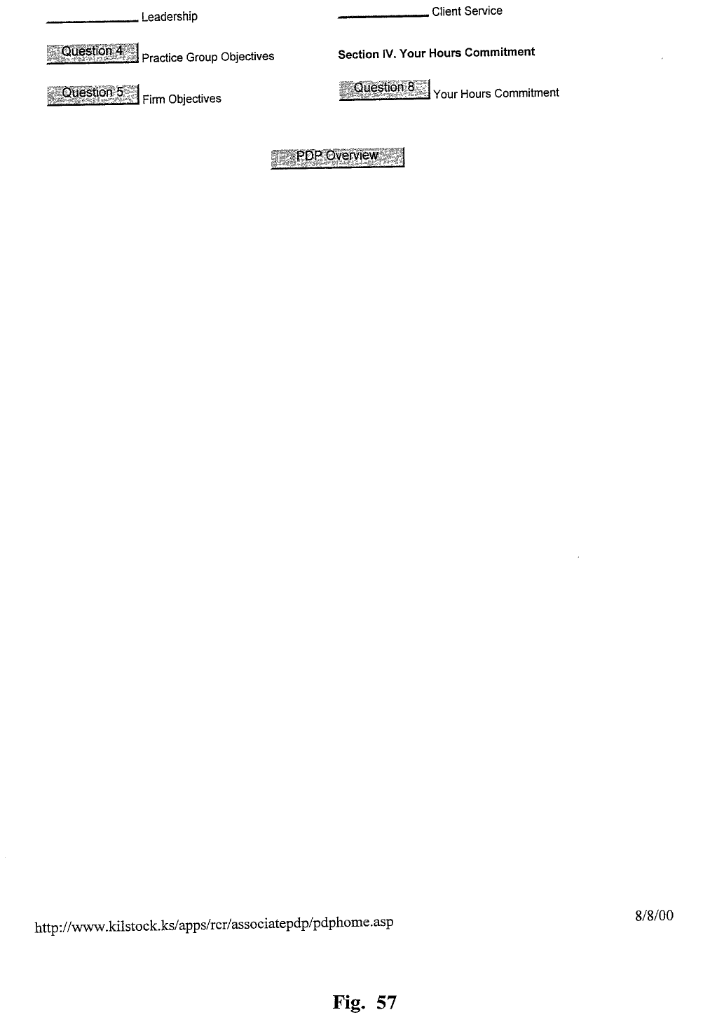

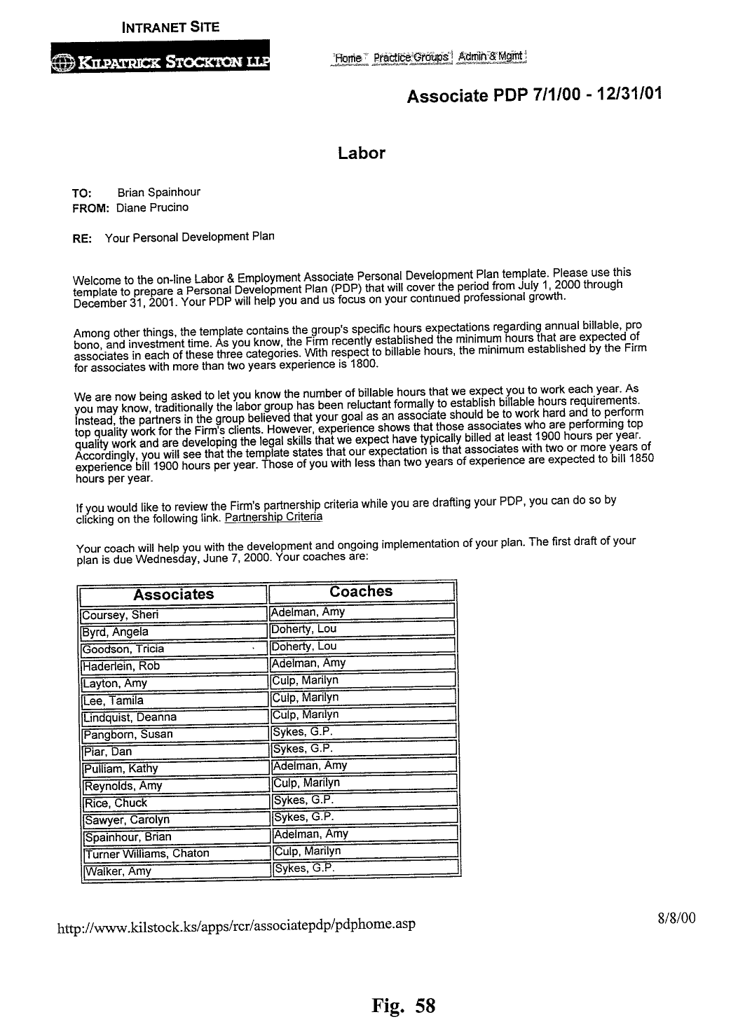

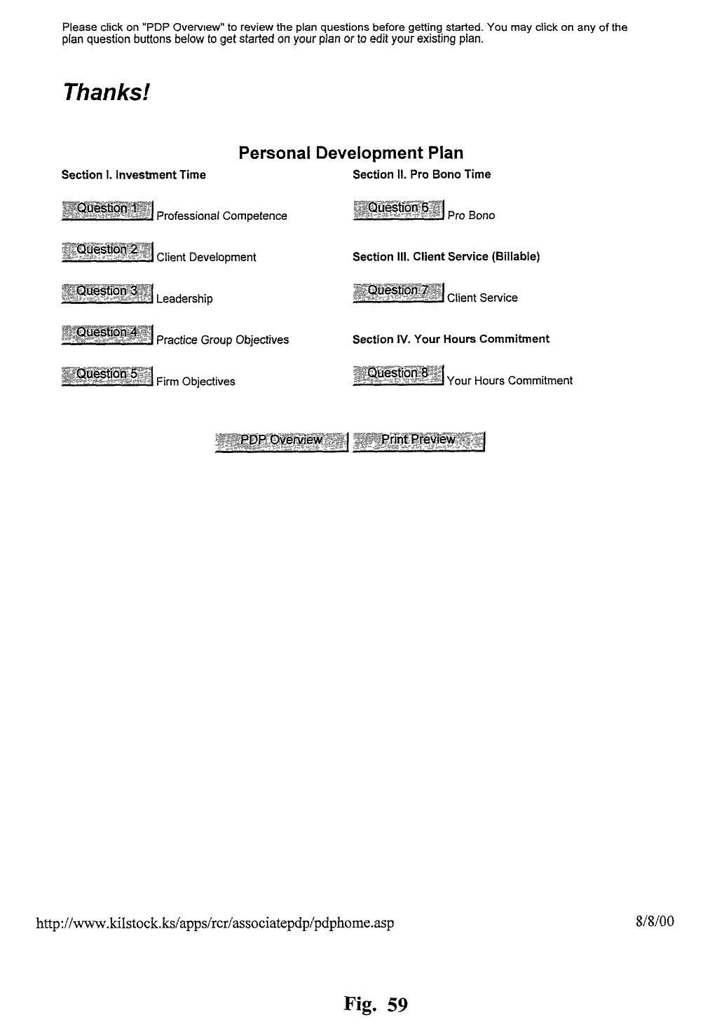

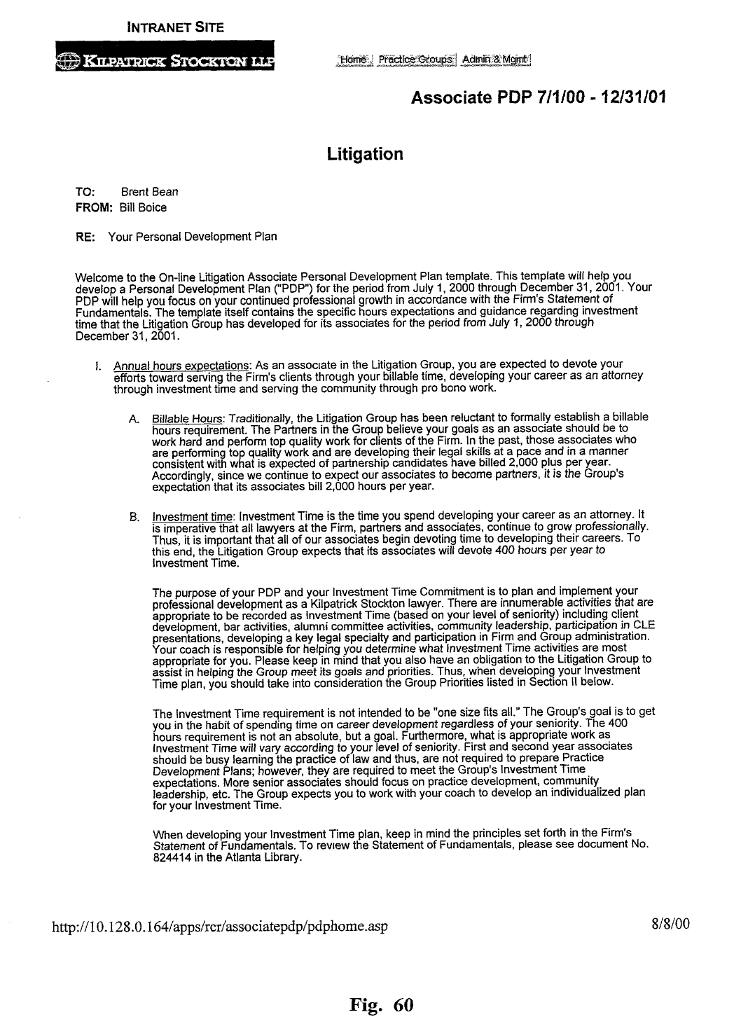

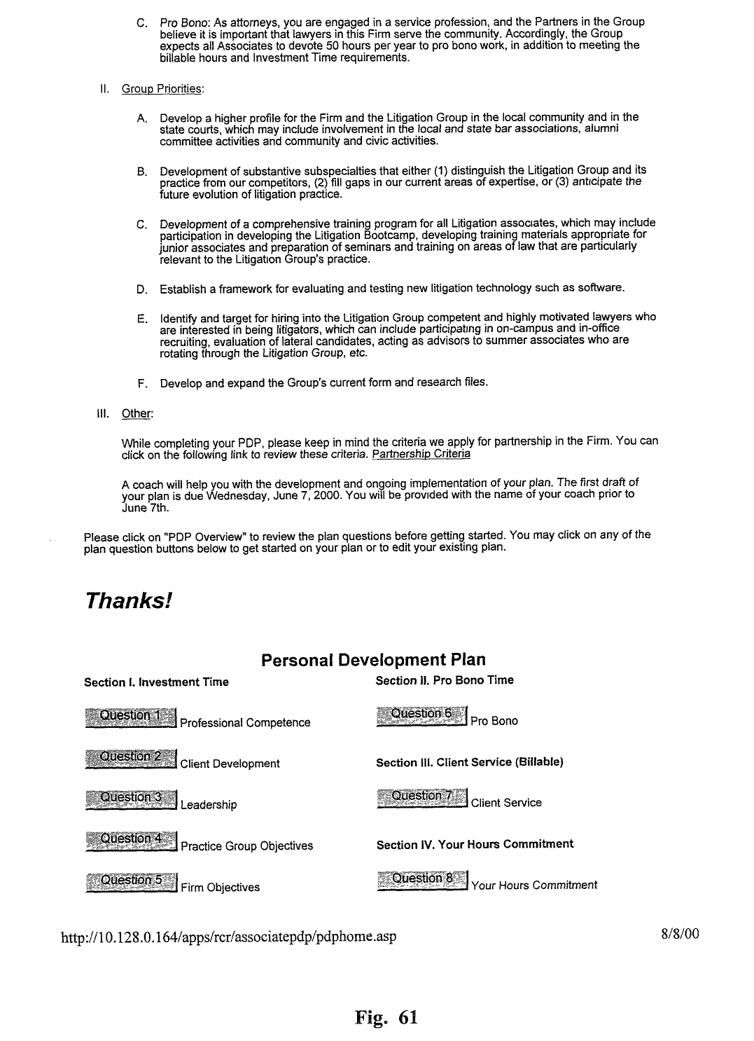

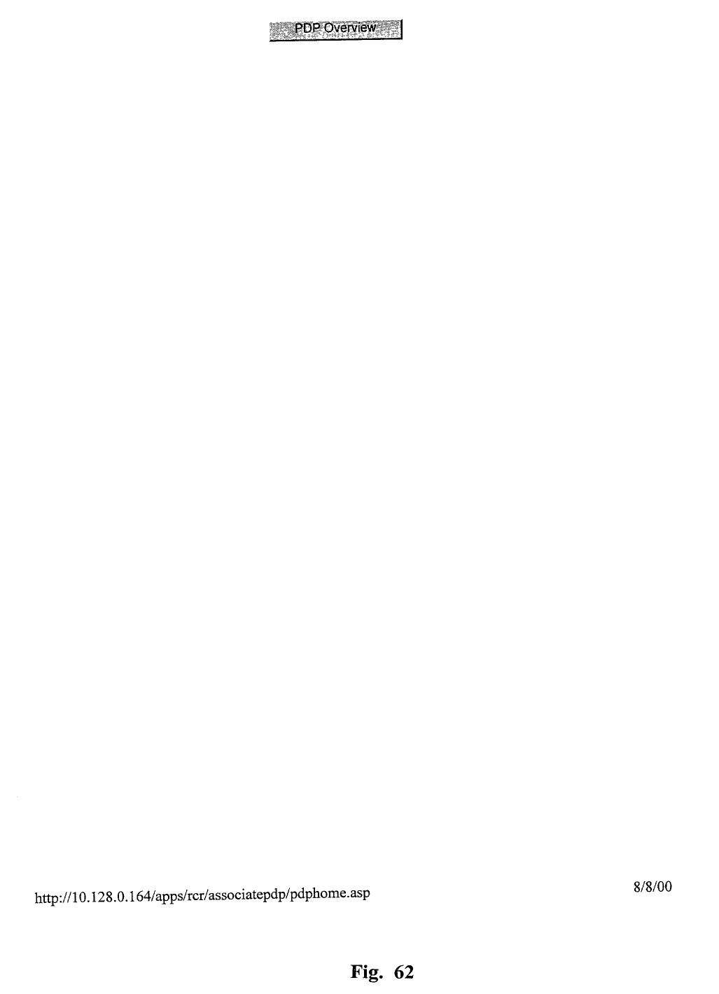

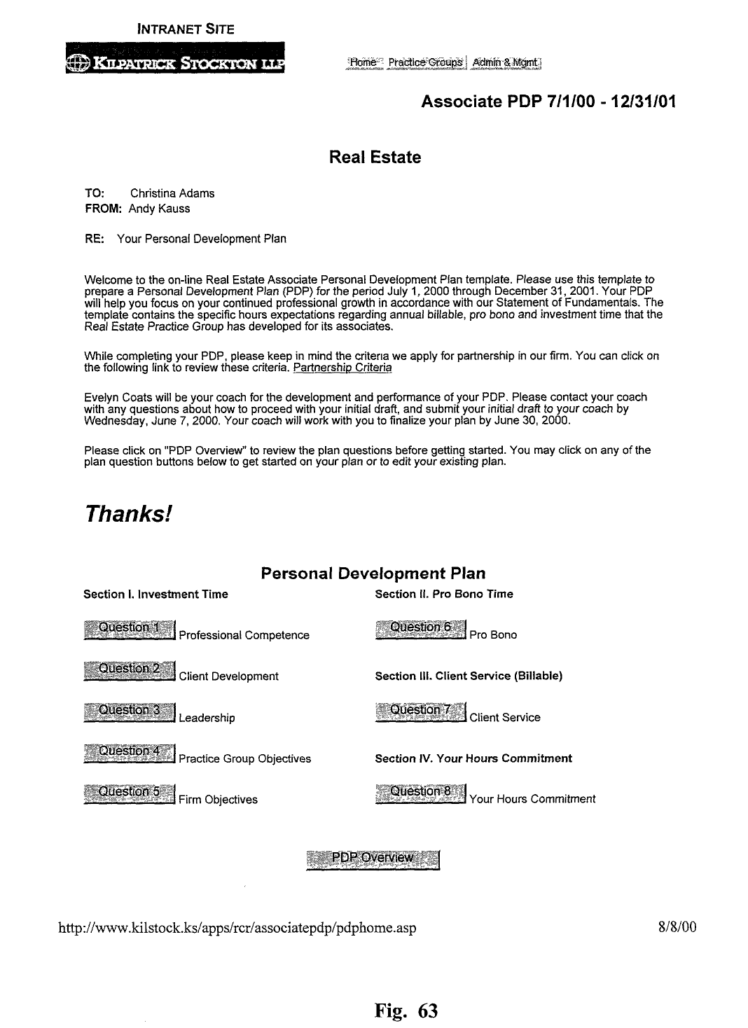

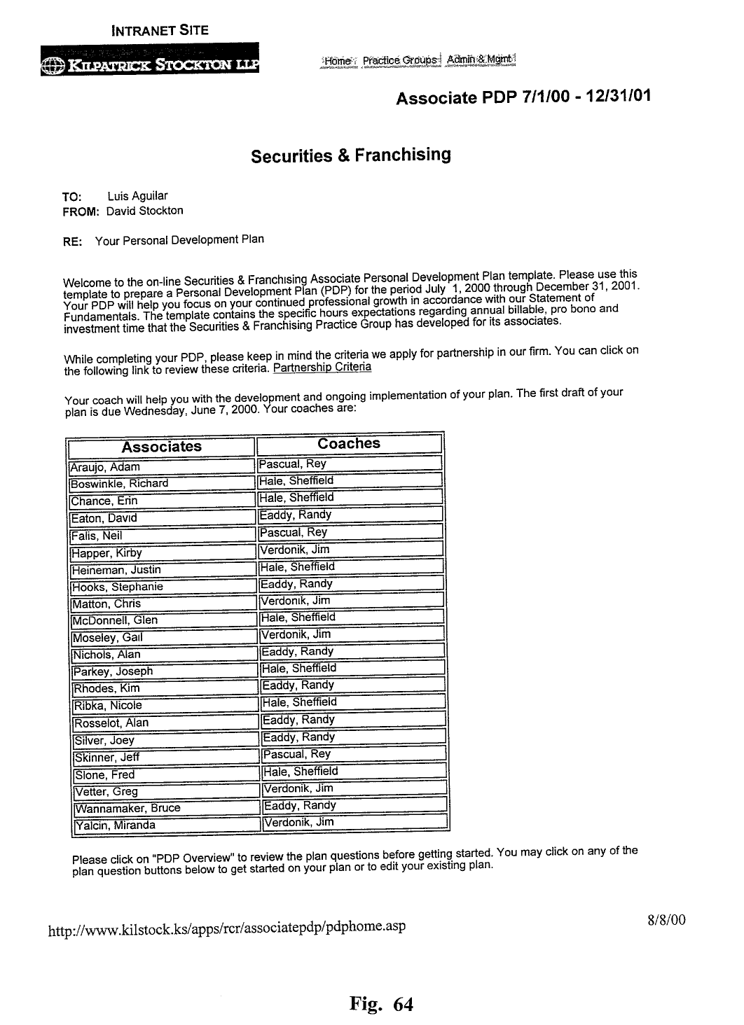

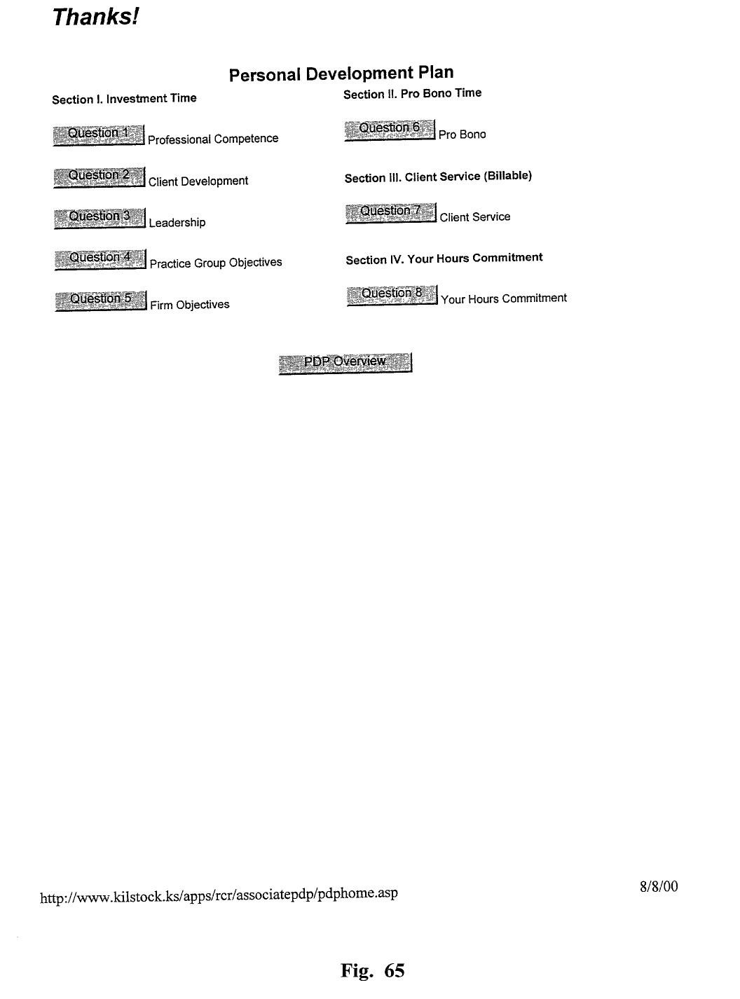

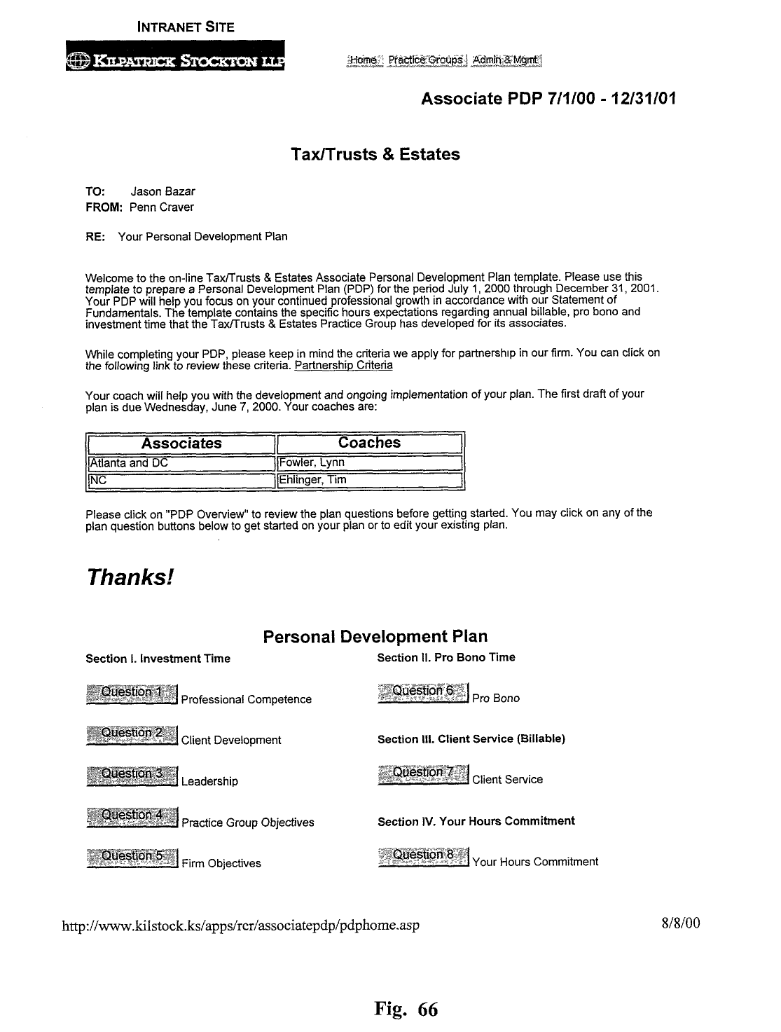

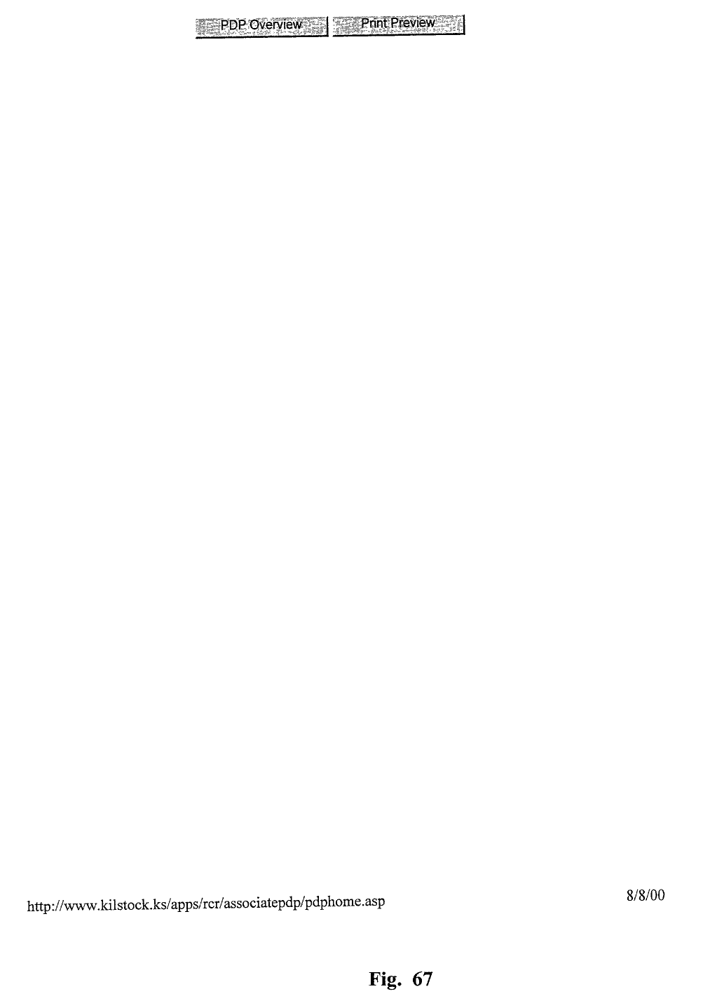

FIGS. 45-67 are the introductory interfaces for particular groups. For instance, FIGS. 45 and 46 are an interface for the business transactions group of a law firm in which individuals and their coaches are listed, followed by a set of buttons to access the interactive personal development plan form which interactively solicits and records information in the four areas; investment time, pro bono time, client service, and hours commitment. Any other categories or areas may also be included and, not all of these need be included. For each area, additional subareas and those listed can be included, and not all listed need be included.

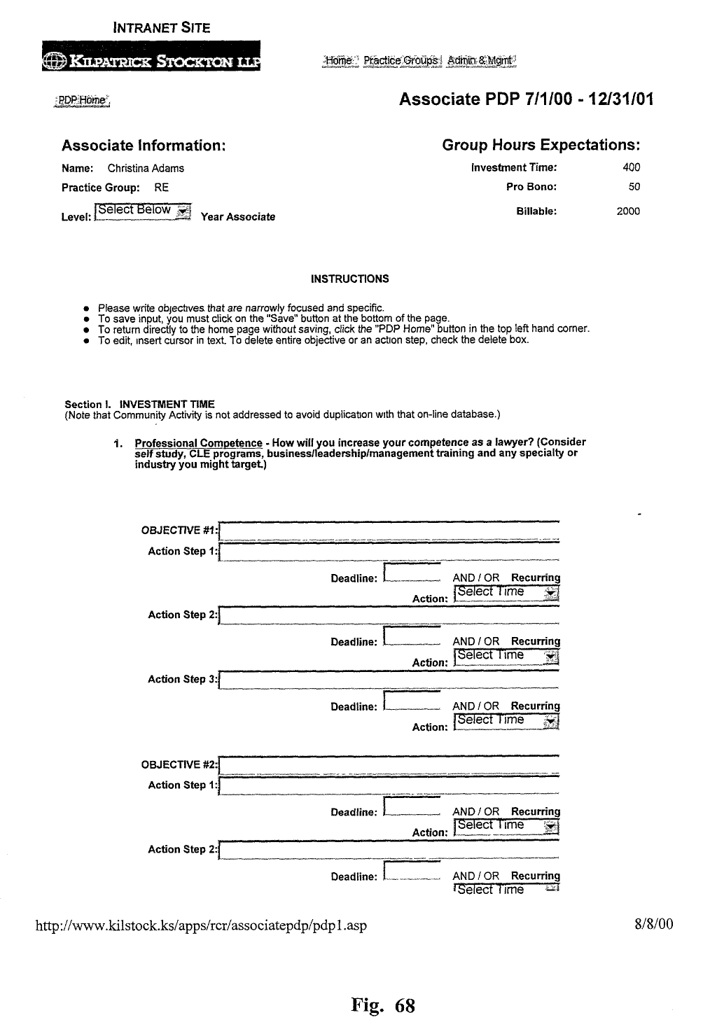

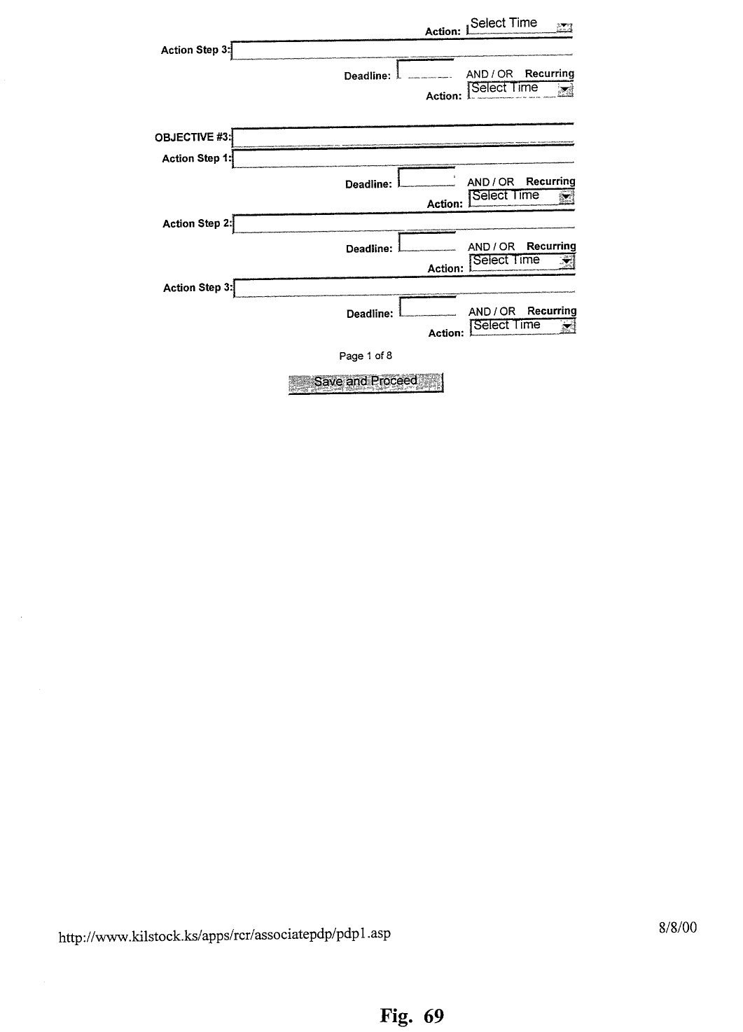

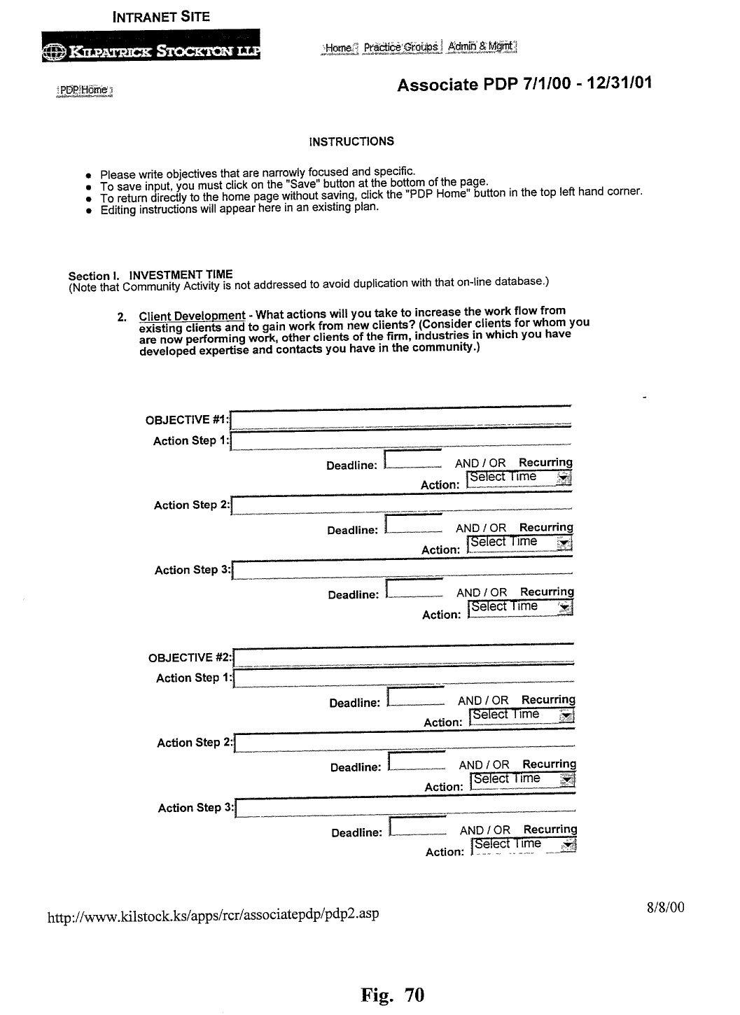

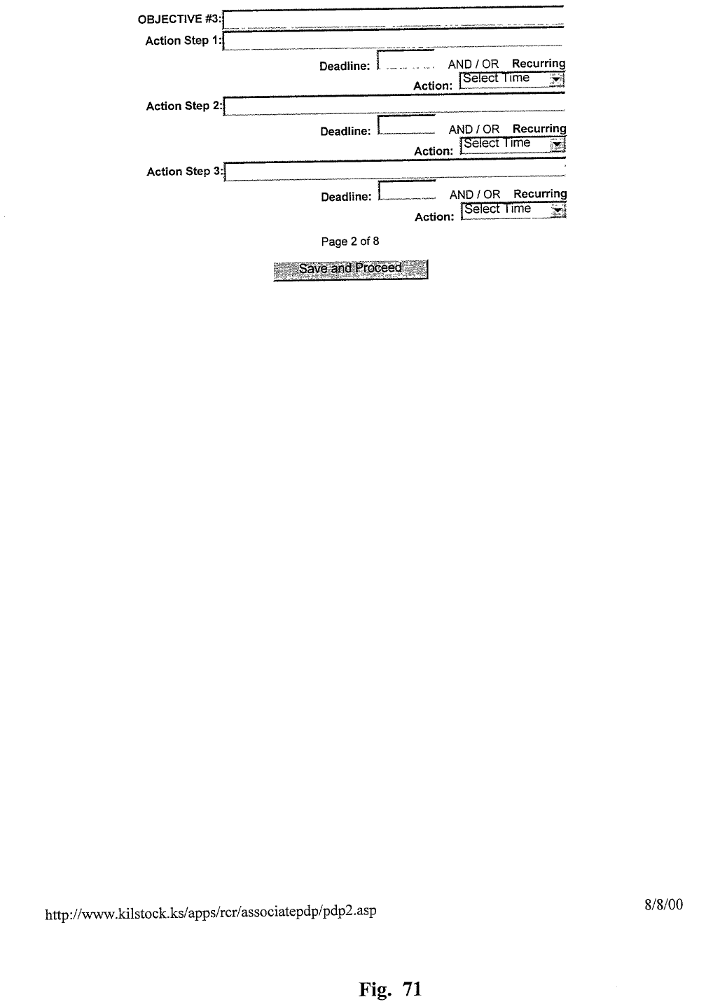

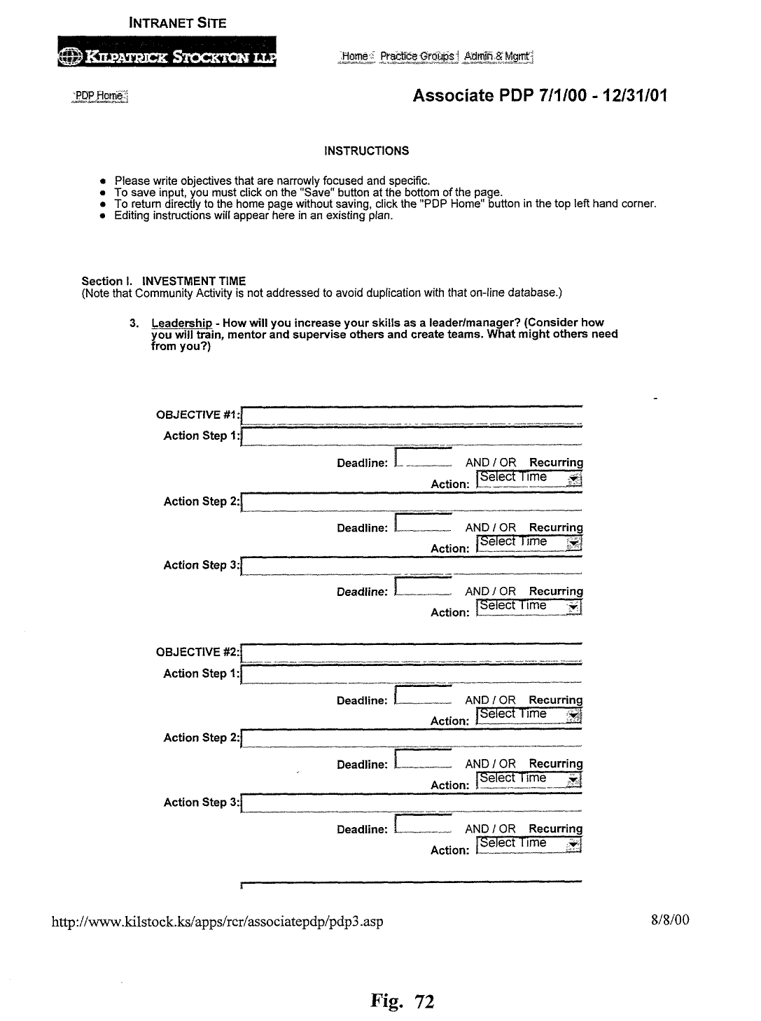

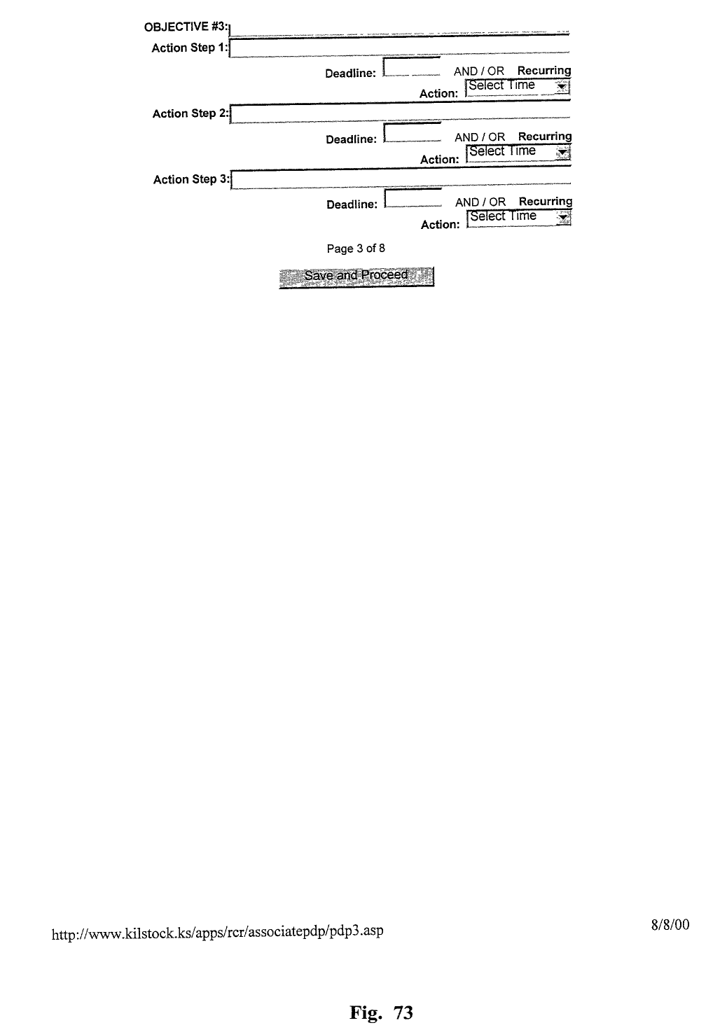

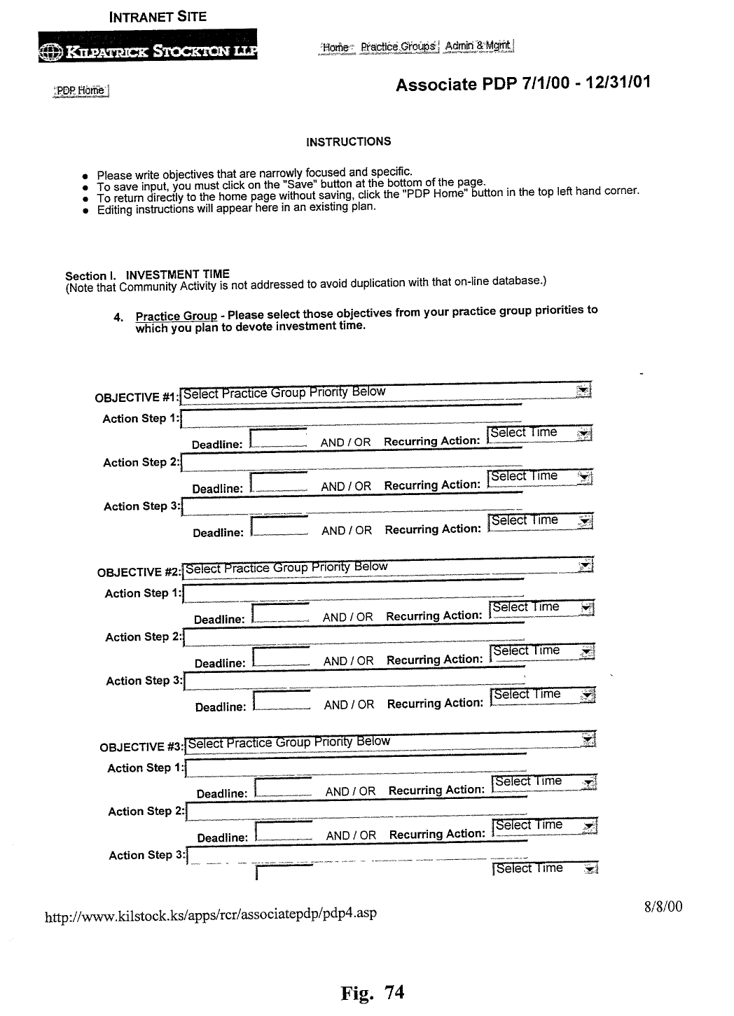

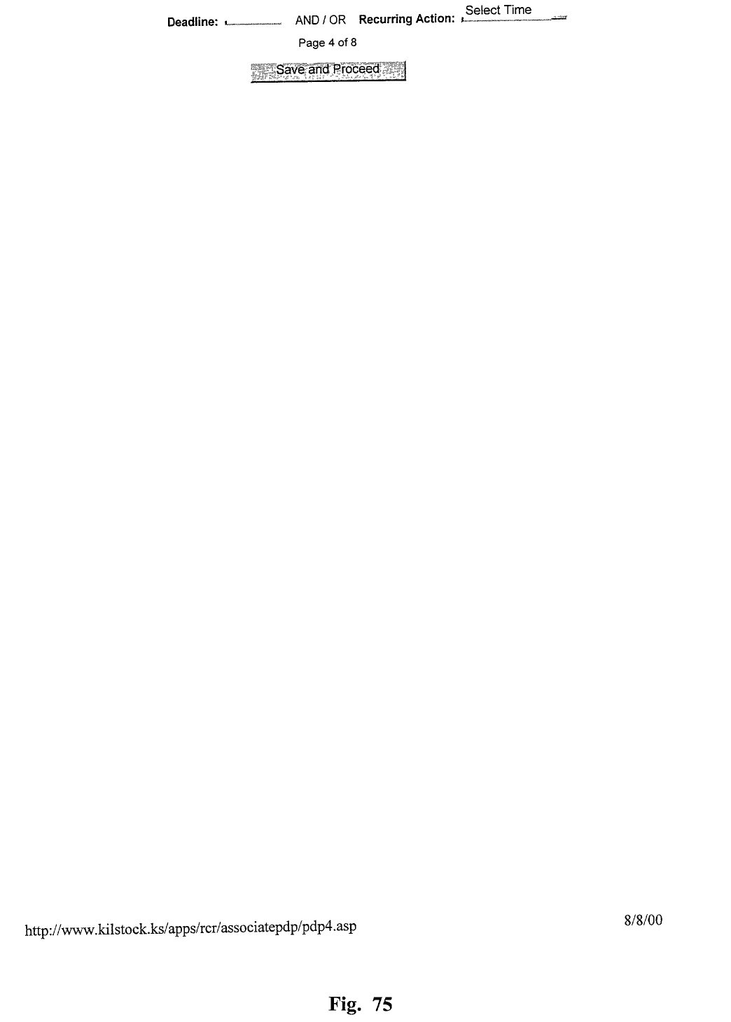

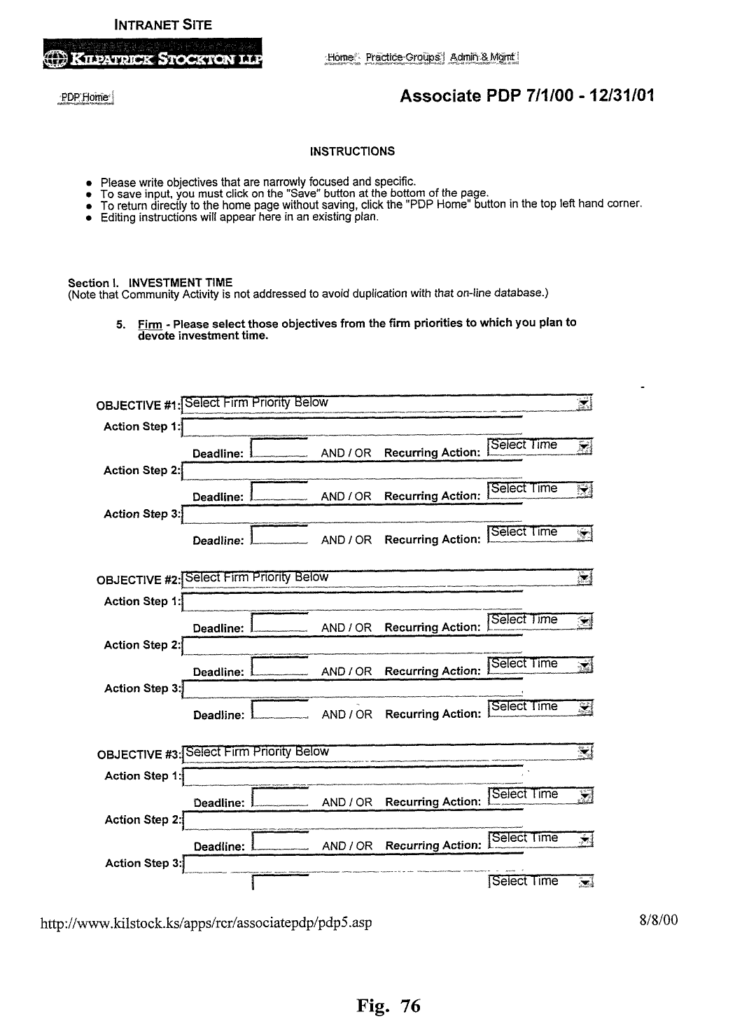

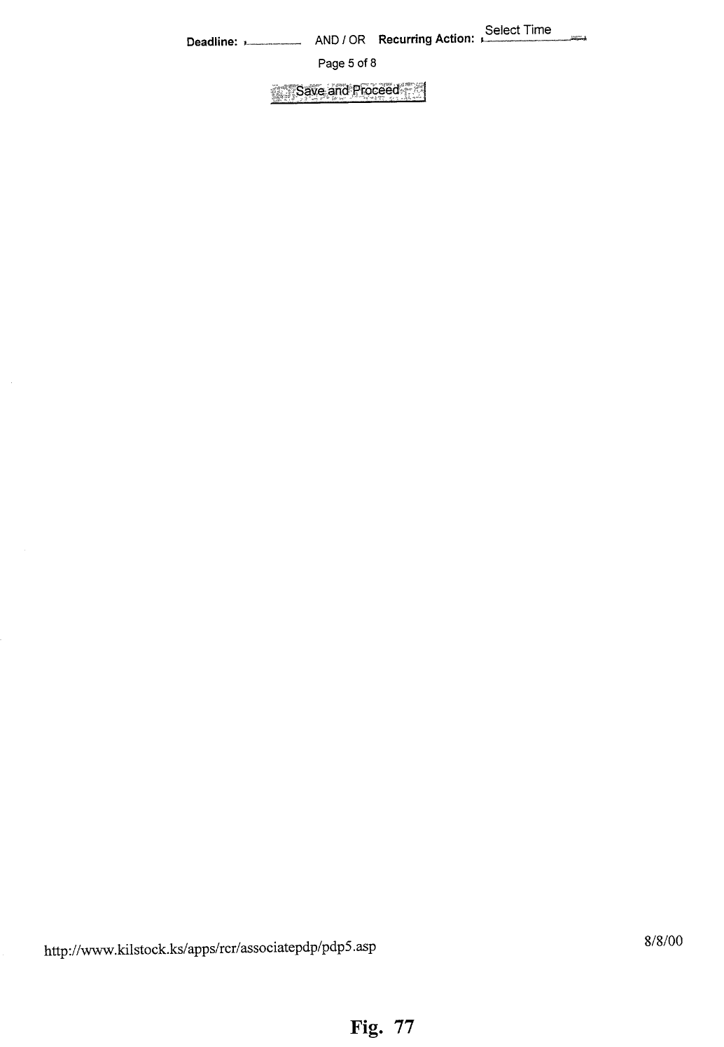

FIGS. 68-82 are screen shots that show the interactive form. FIGS. 68 and 69 ask for objectives, action steps and deadlines for the professional competence subarea of the investment time area. FIGS. 71 and 71 ask for objectives, action steps and deadlines in the client development subarea of the investment time area. FIGS. 72 and 73 ask for objectives, action steps and deadlines in the leadership subarea of the investment time area. FIGS. 74 and 75 ask for objectives, action steps, and deadlines in the practice group subarea of the investment time area. FIGS. 76 and 77 ask for objectives, action steps, and deadlines in the firm priorities subarea of the investment time area.

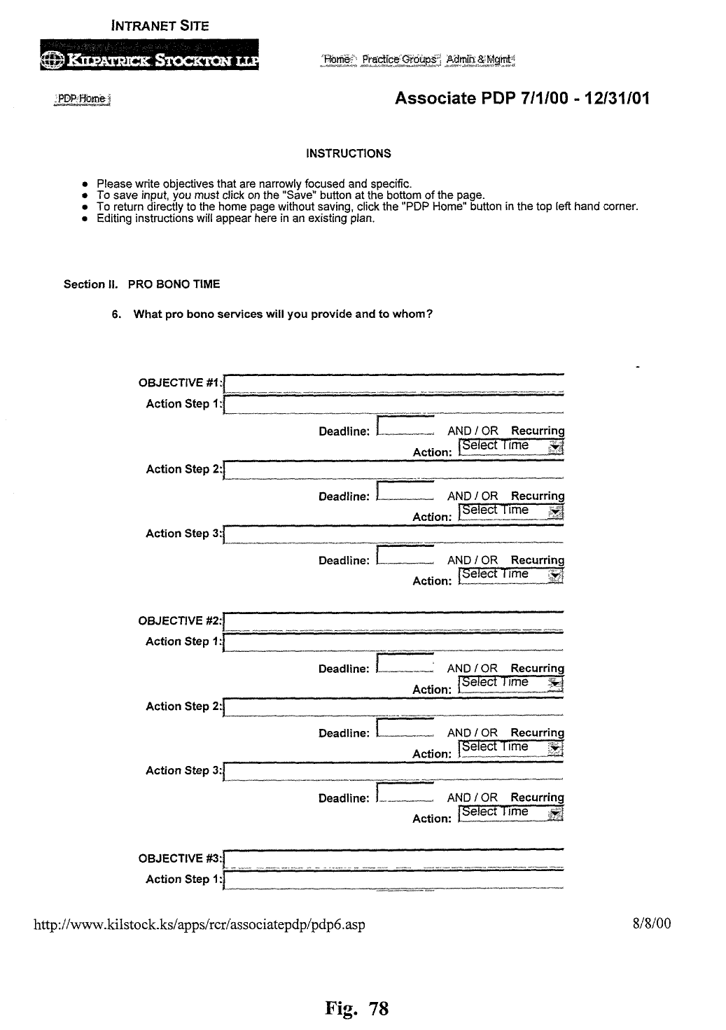

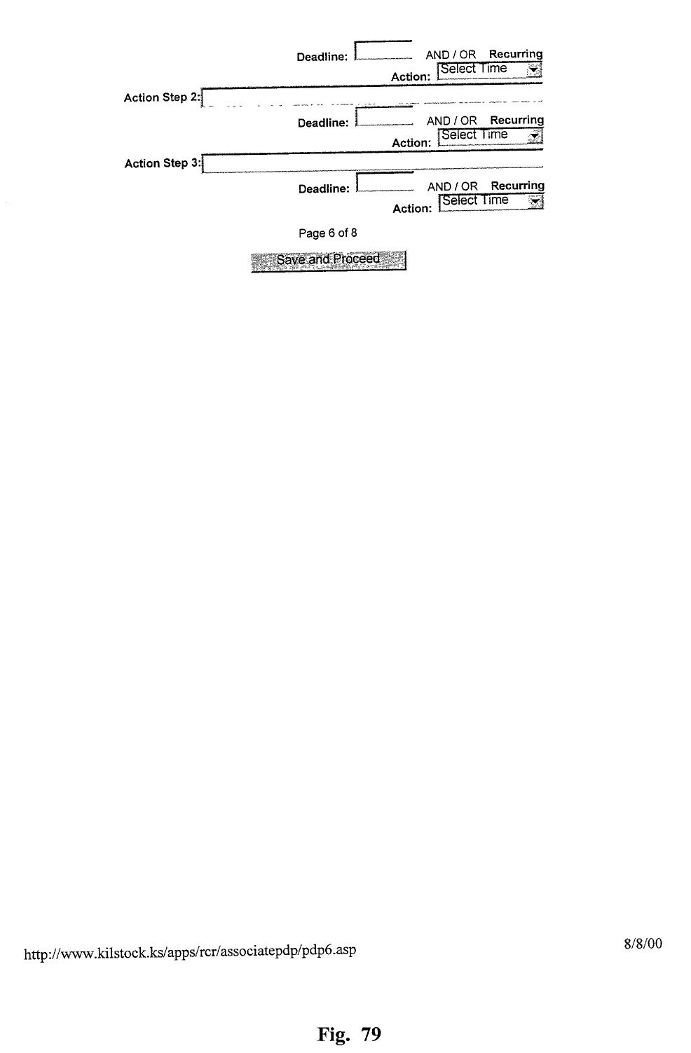

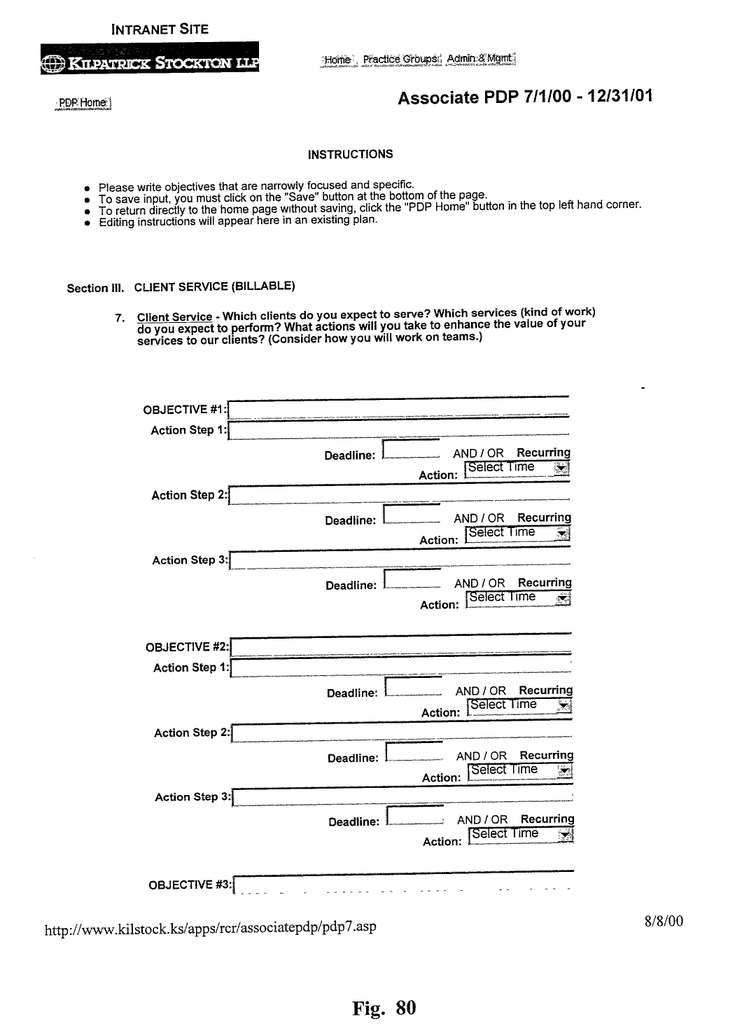

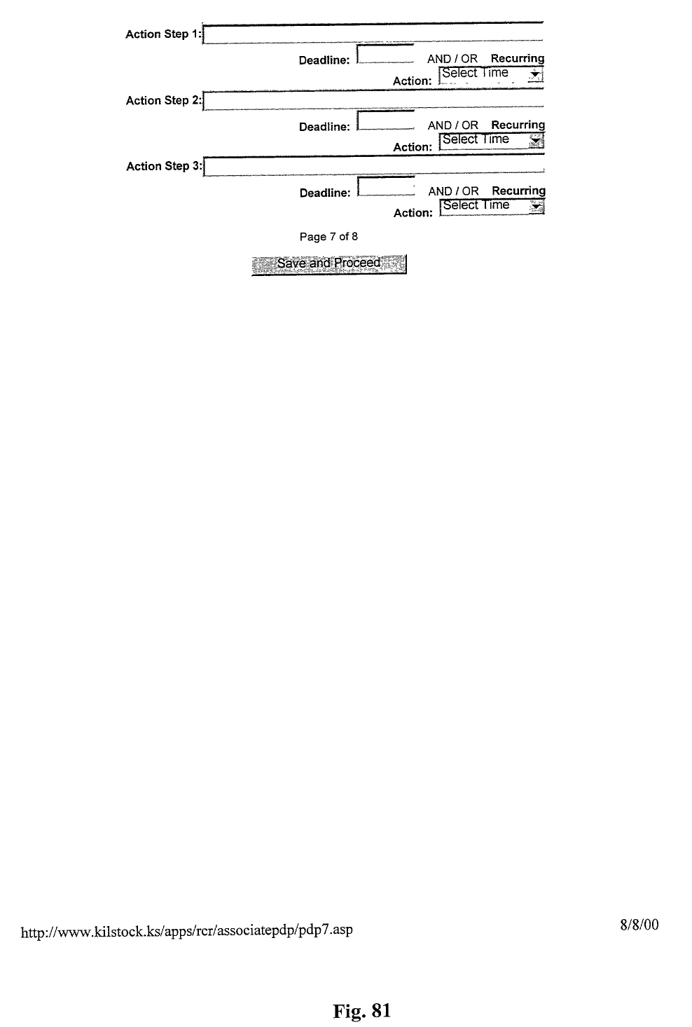

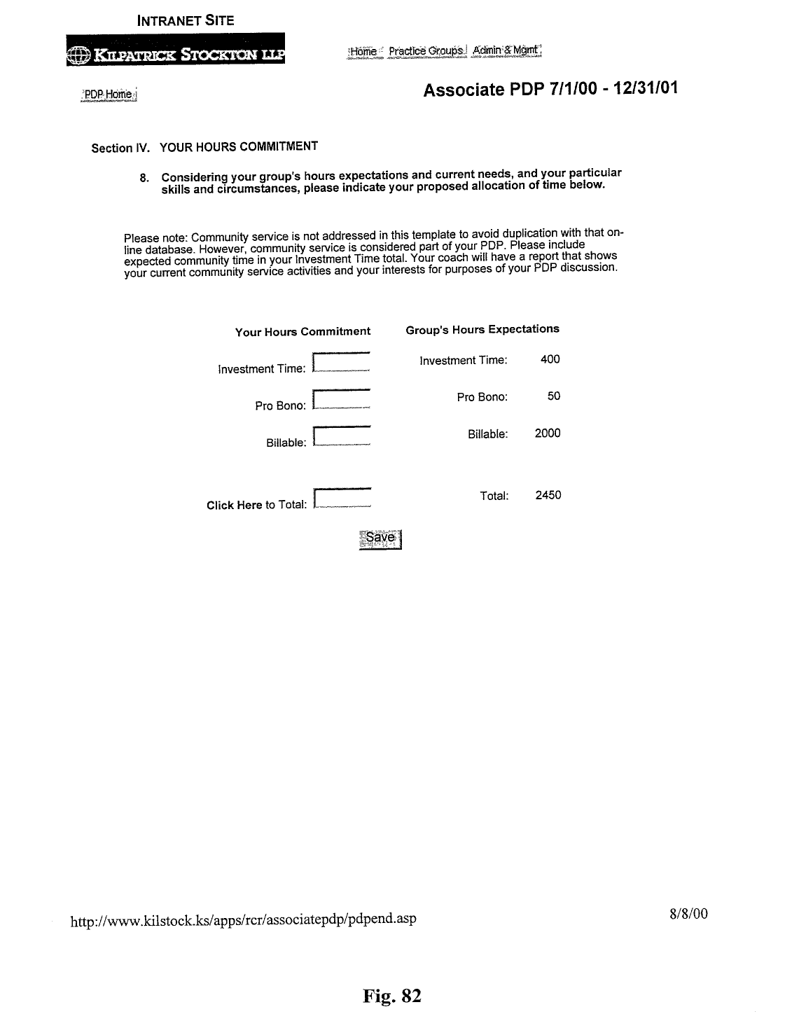

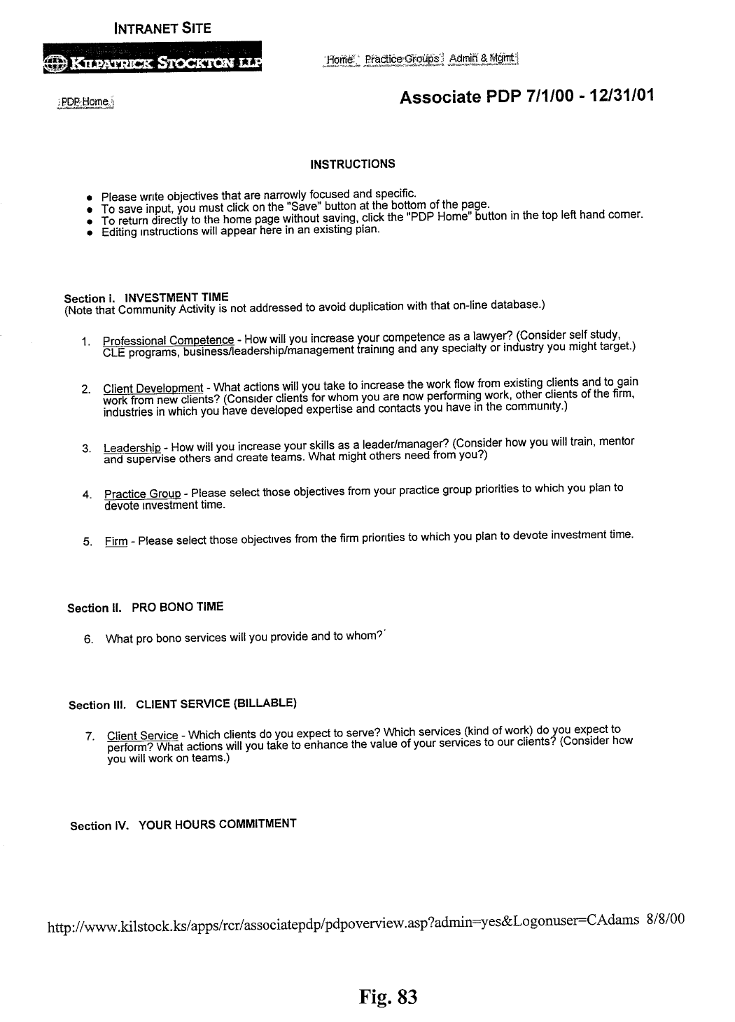

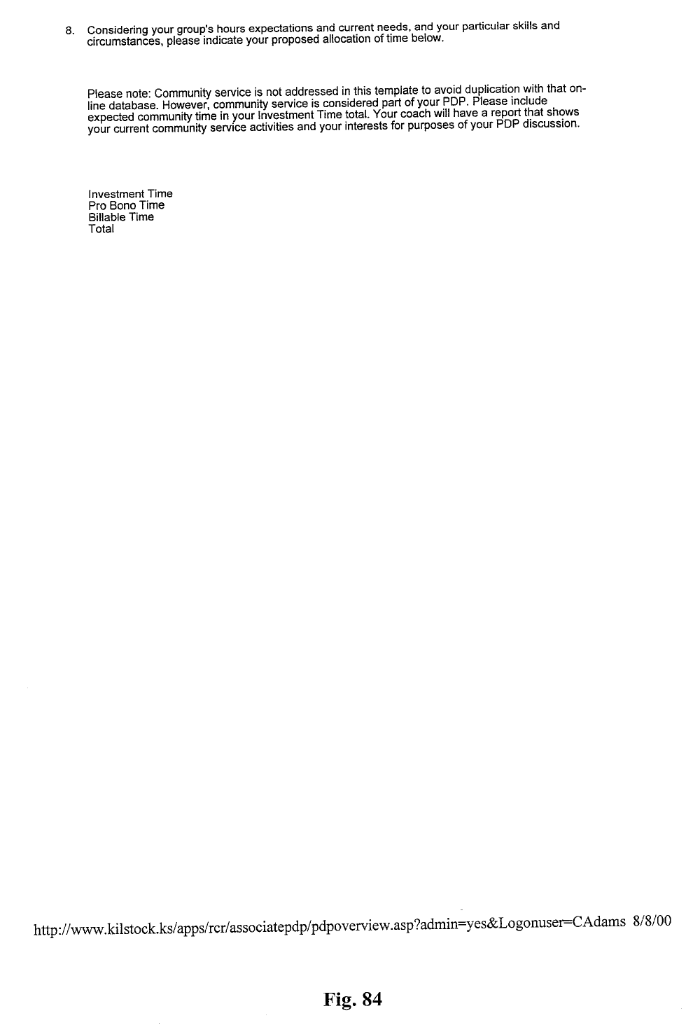

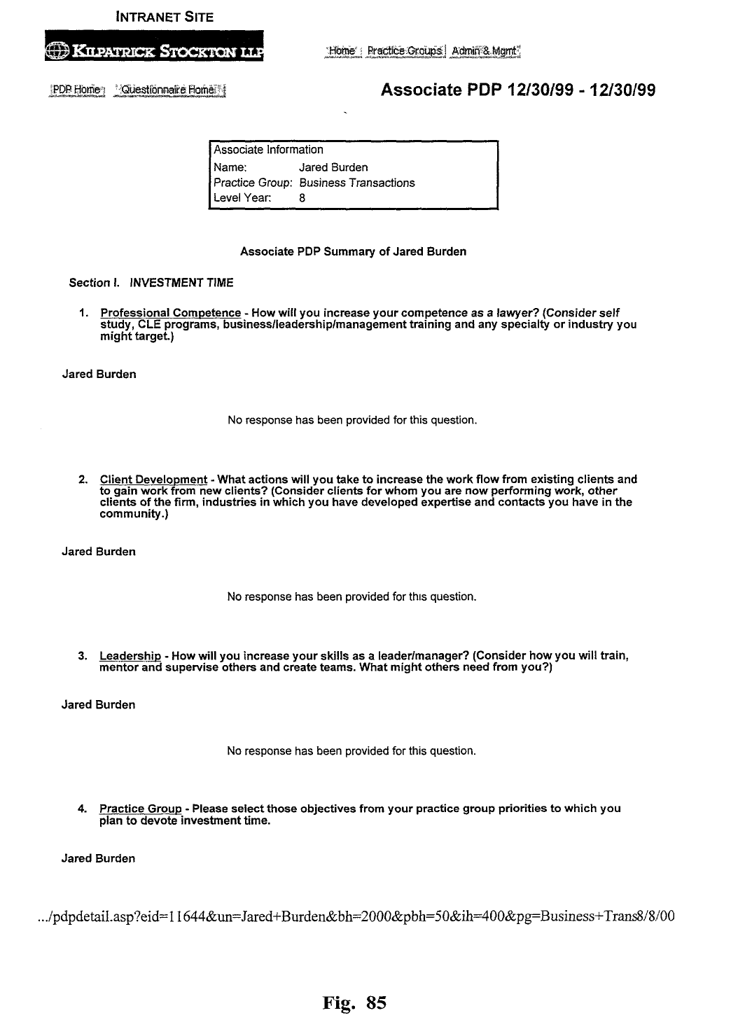

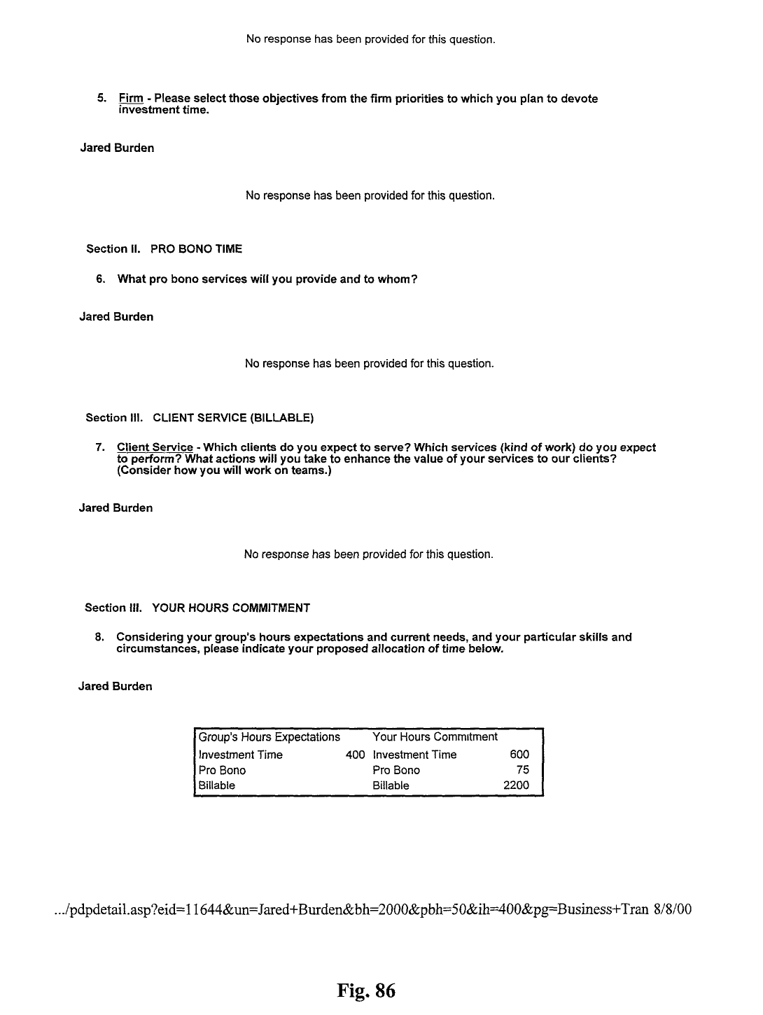

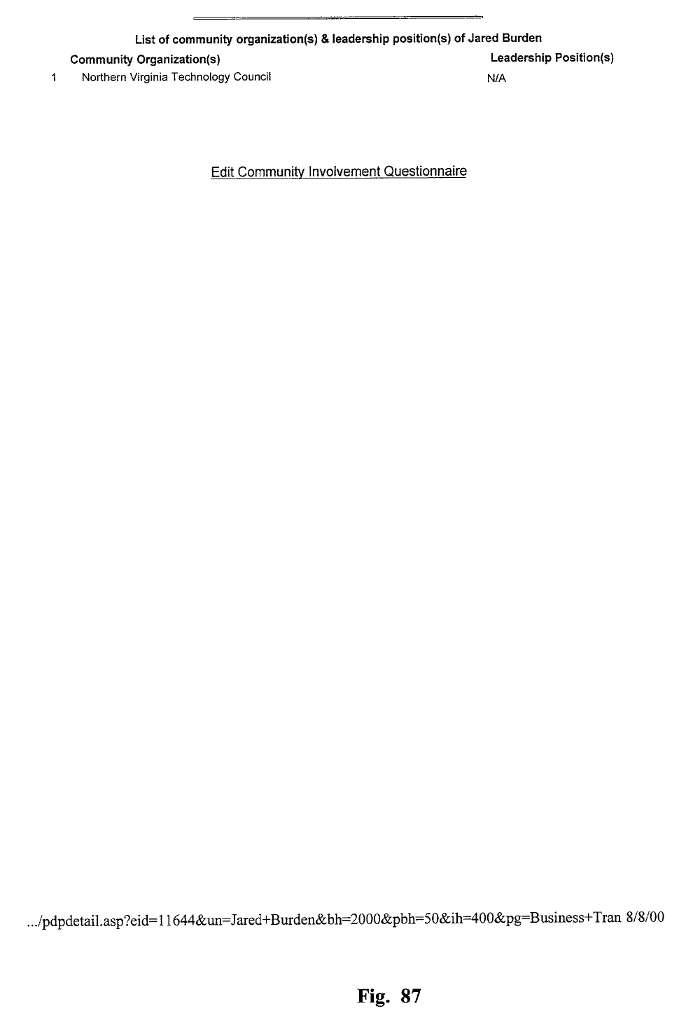

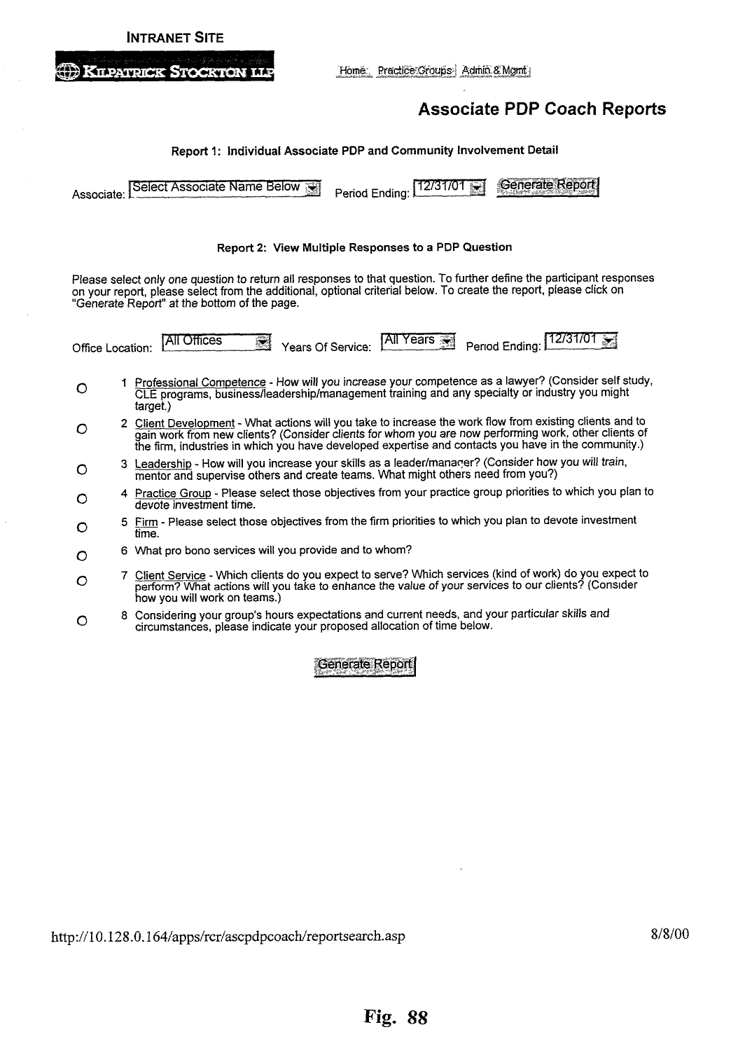

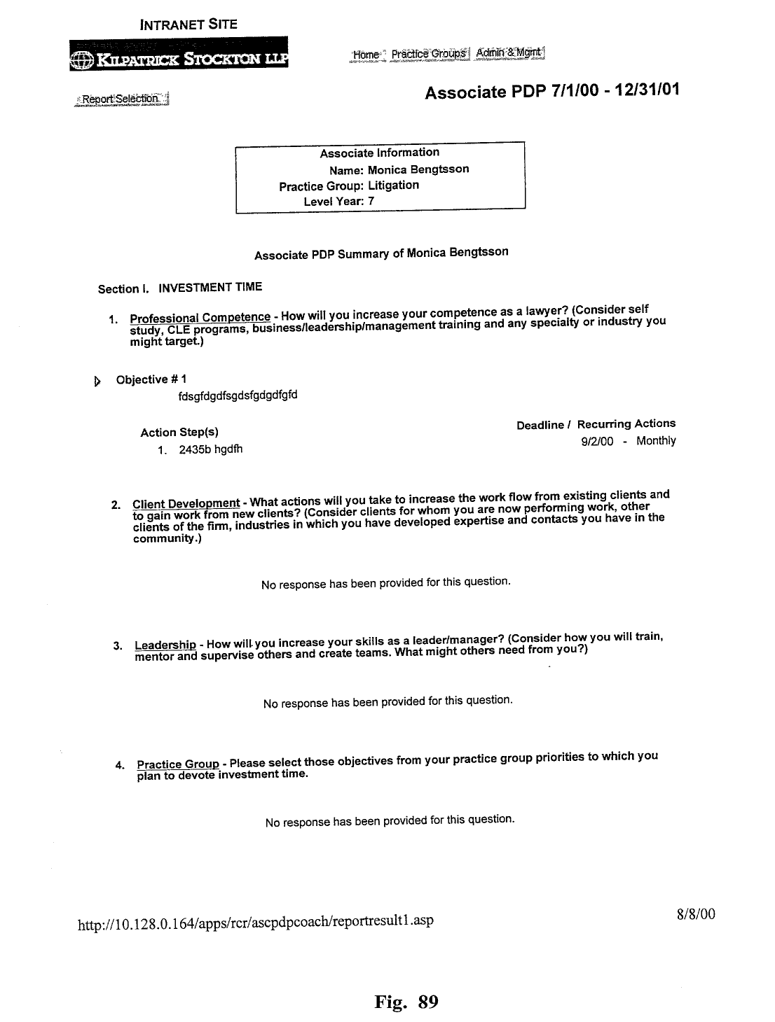

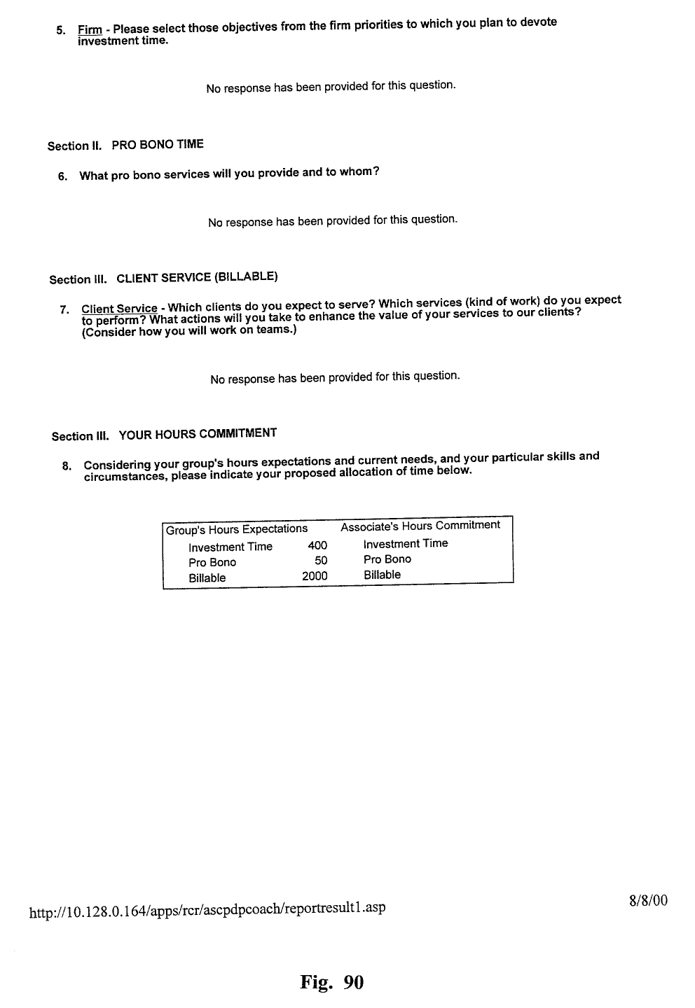

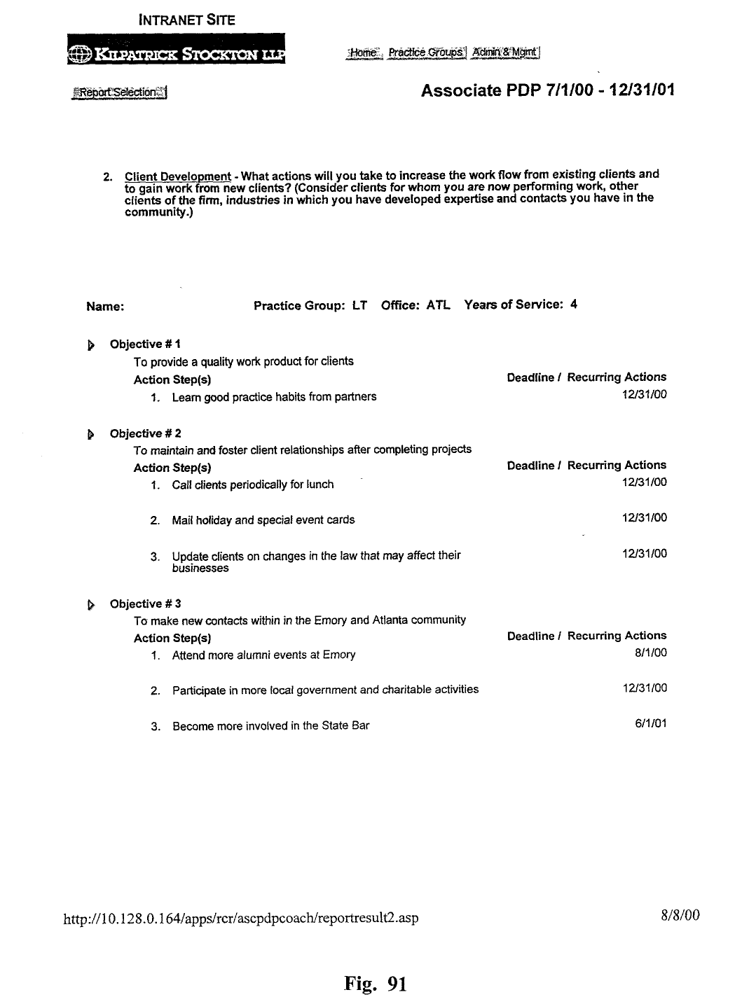

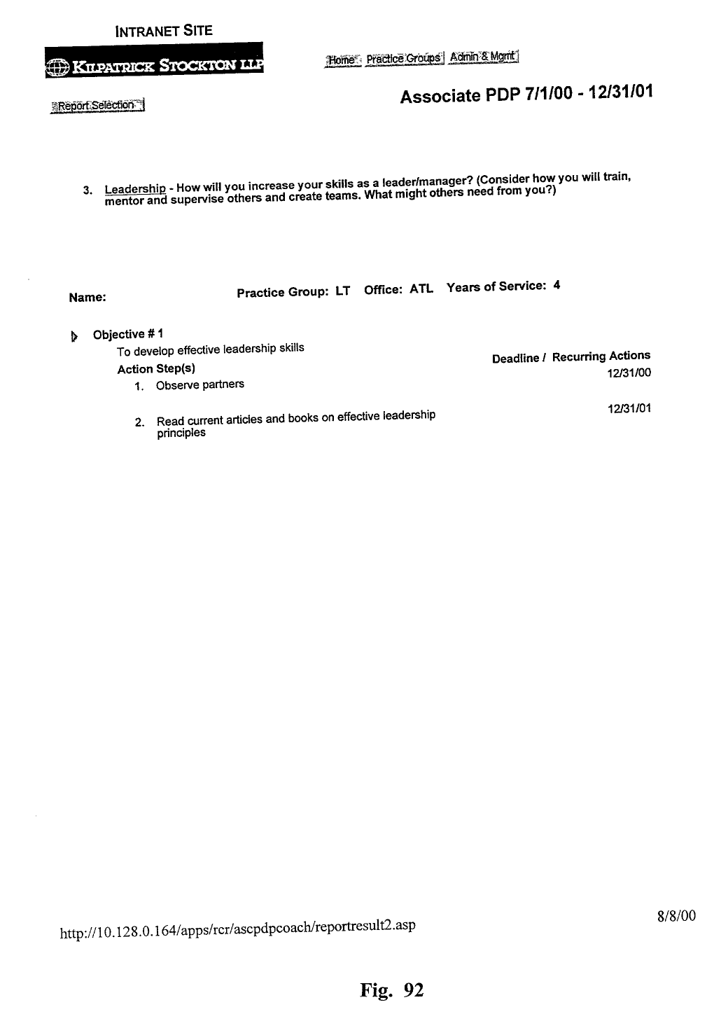

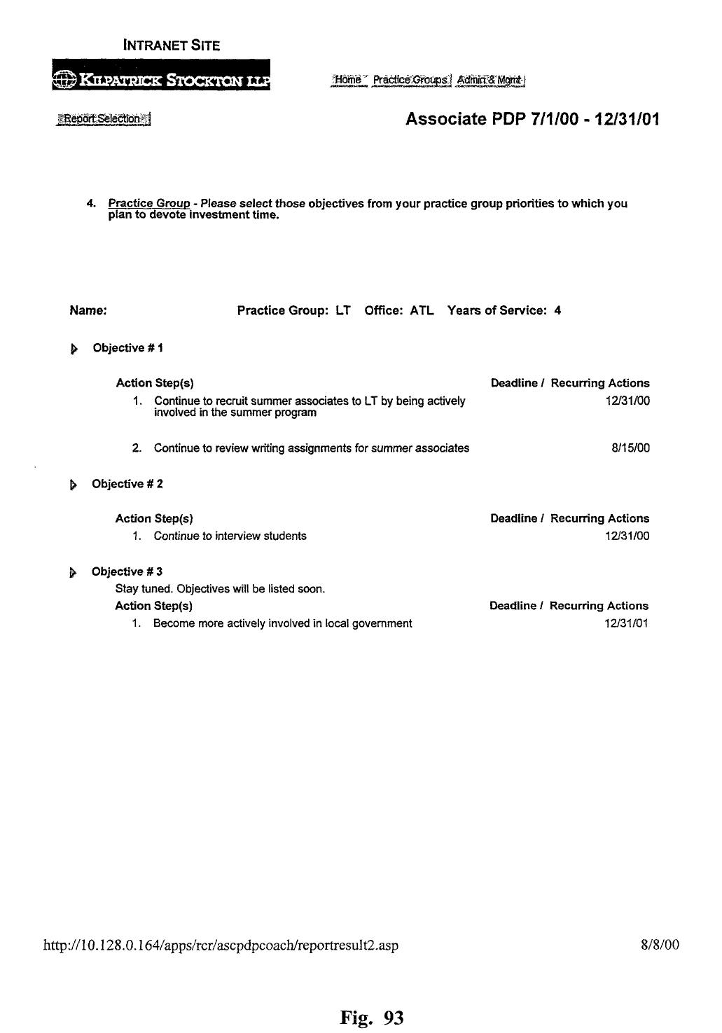

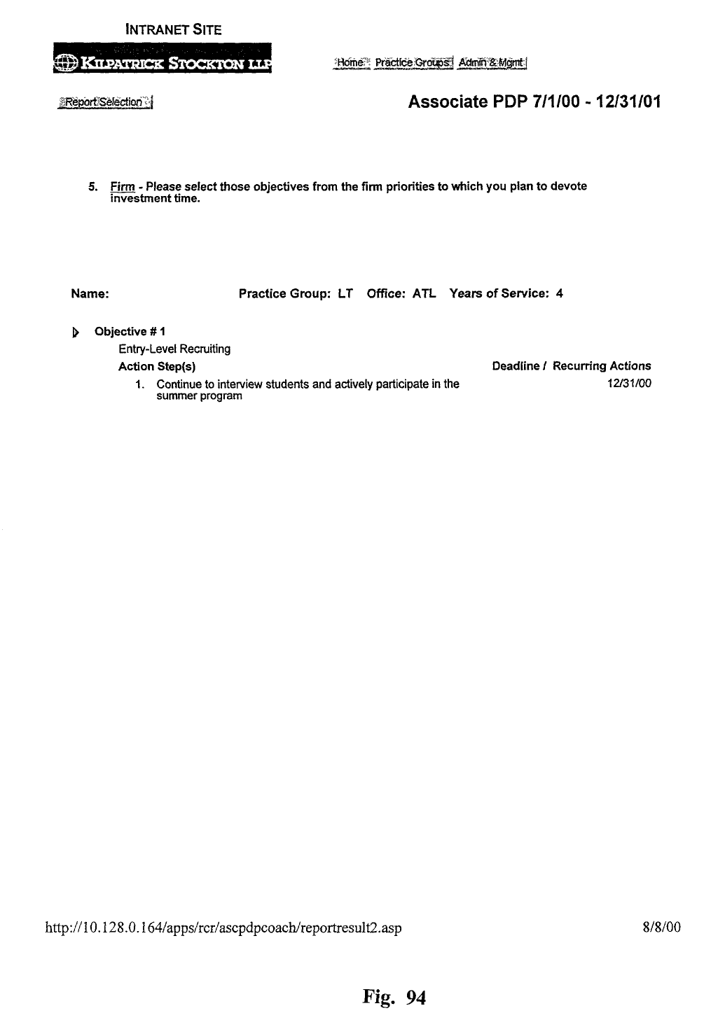

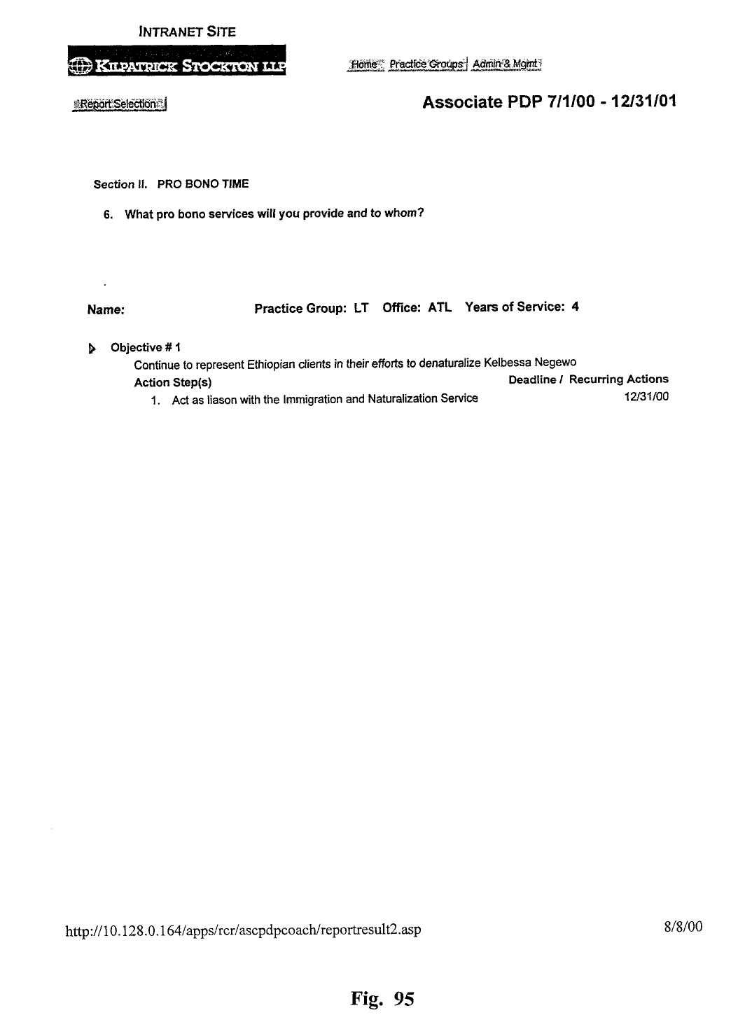

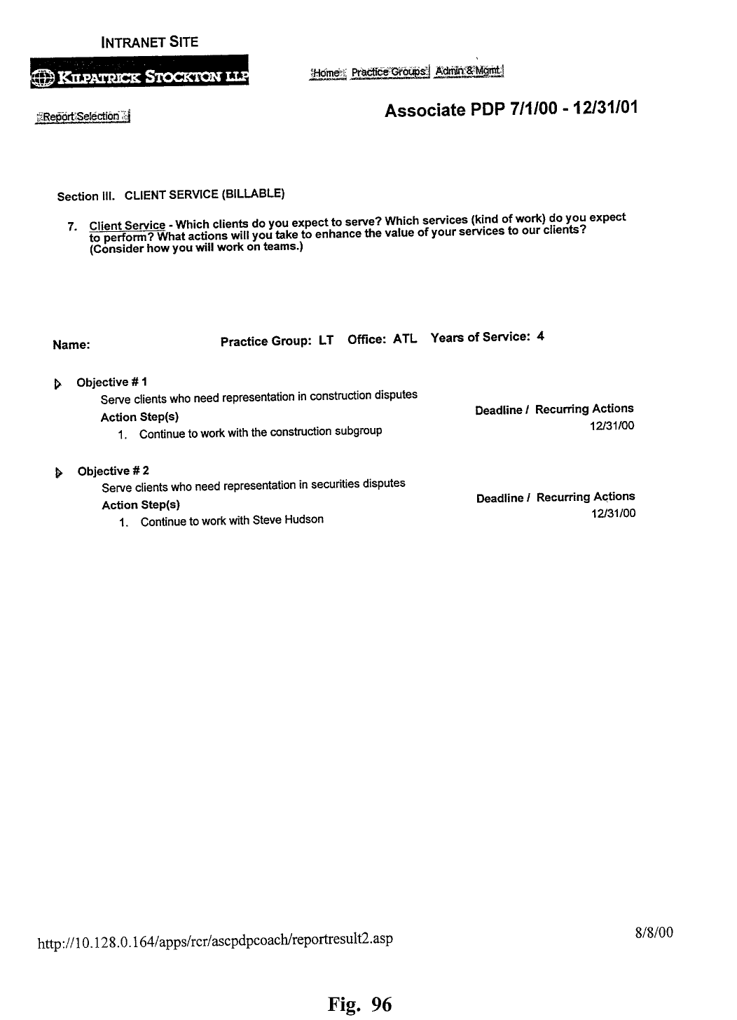

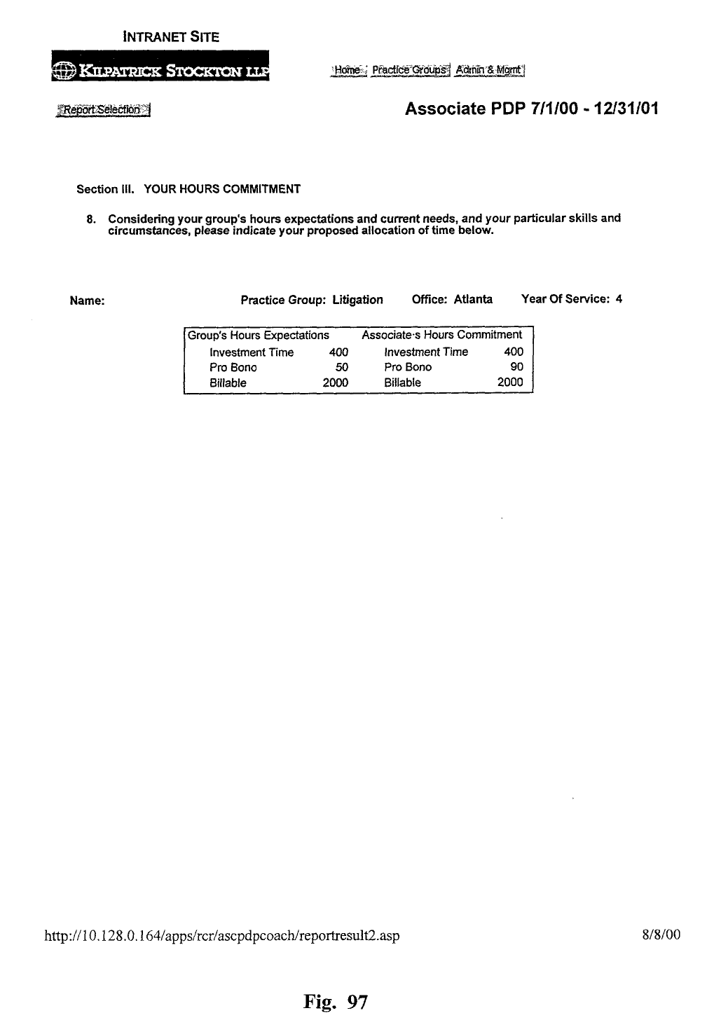

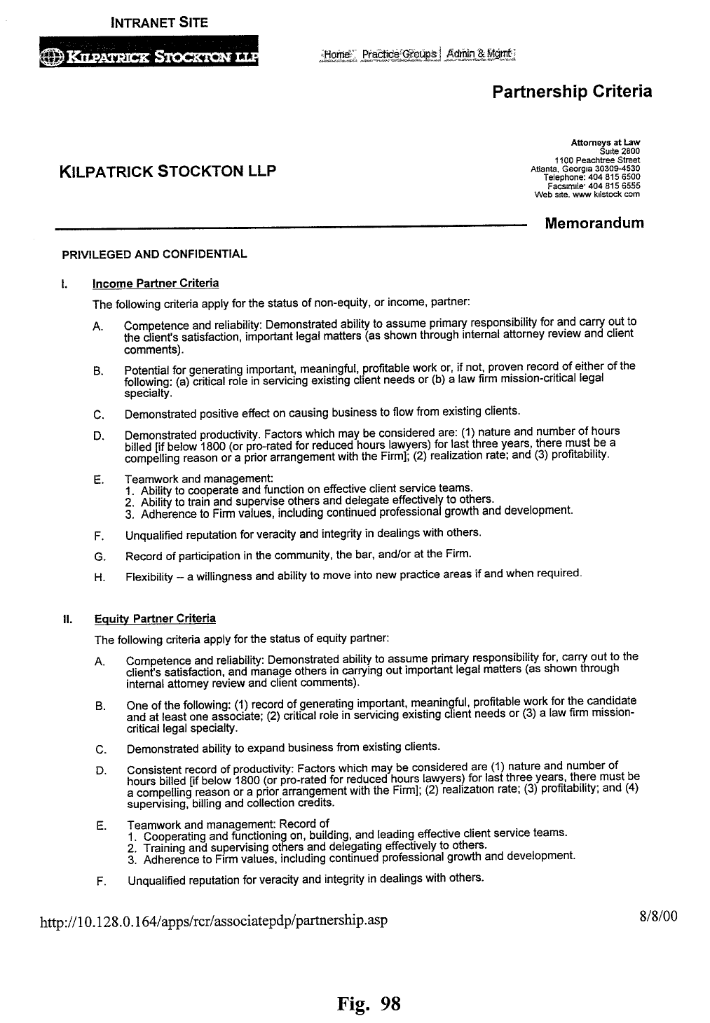

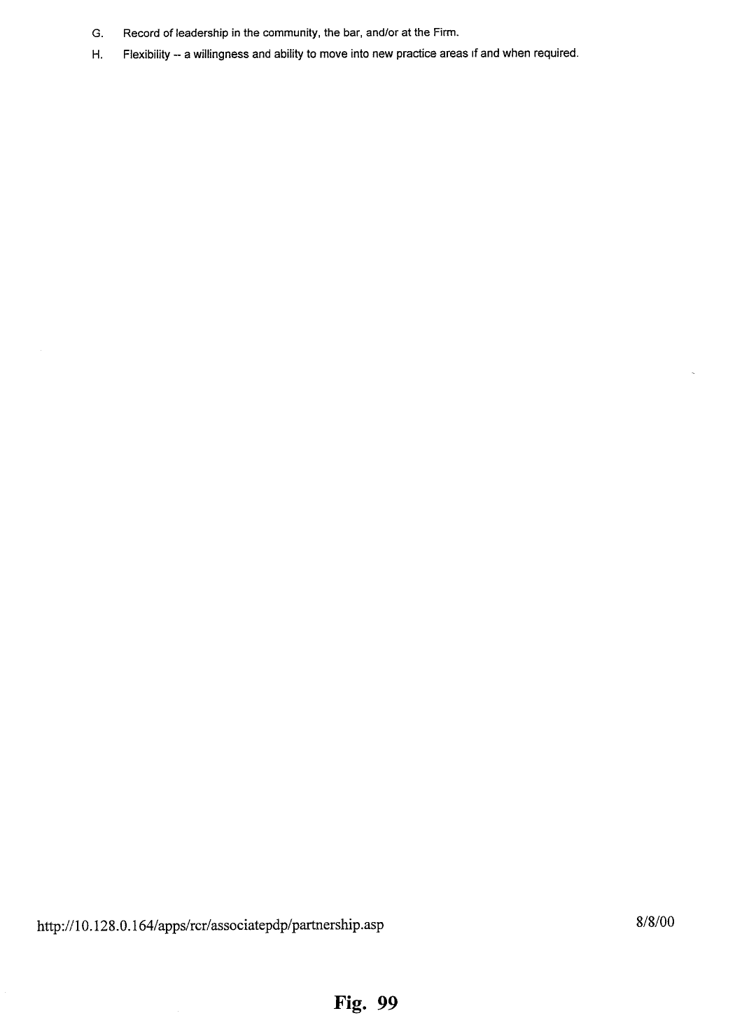

FIGS. 78 and 79 solicit objectives, action steps, and deadlines in the pro bono area. FIGS. 80 and 81 solicit objectives, action steps, and deadlines in the client service area. FIG. 82 solicits time commitment input. FIGS. 83 and 84 summarize the information input into the practice development plan interactive form. FIGS. 85-87 summarize, such as for use by a coach or practice group leader, the planner's practice development plan. FIGS. 88-97 show additional practice development plan information for a particular employee that is available to a coach or practice group leader for assistance in the planning process. FIGS. 98 and 99 show sample criteria for firm advancement criteria for use in the planning process shown in FIG. 2.

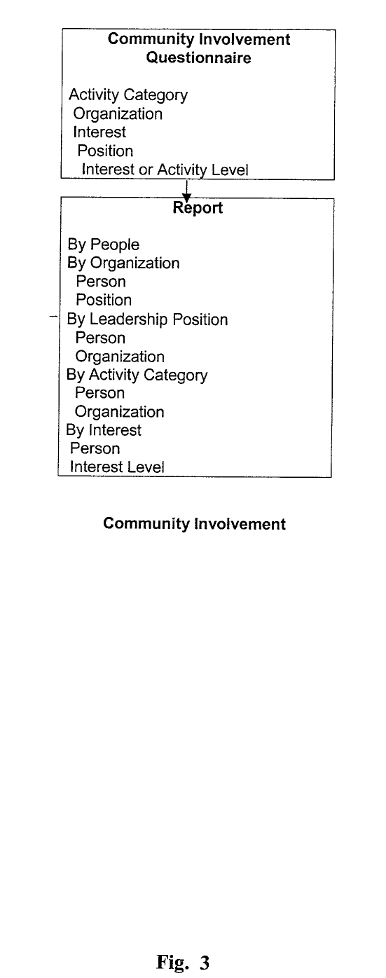

FIG. 3 shows process flow for the preferred embodiment of community involvement management processes according to the present invention. As shown in that diagram, an employee can input information into an interactive form about community activity categories, organizations, or community activity interests they have, what sorts of positions in which they are interested and levels of activity in which they are interested. This information may be collected in a community involvement database for generating and displaying reports that help employees focus their community involvement efforts. For instance, a first report lists people, their organizations, leadership positions, and activity levels as well as other interests. A second report lists by organization, people involved and their positions. A third report, by leadership position, shows people and the organization in which they are involved. A fourth report, by activity category, lists organizations and people in those organizations. A fifth report shows, by interest area, and their interest levels.

(C) Community Involvement

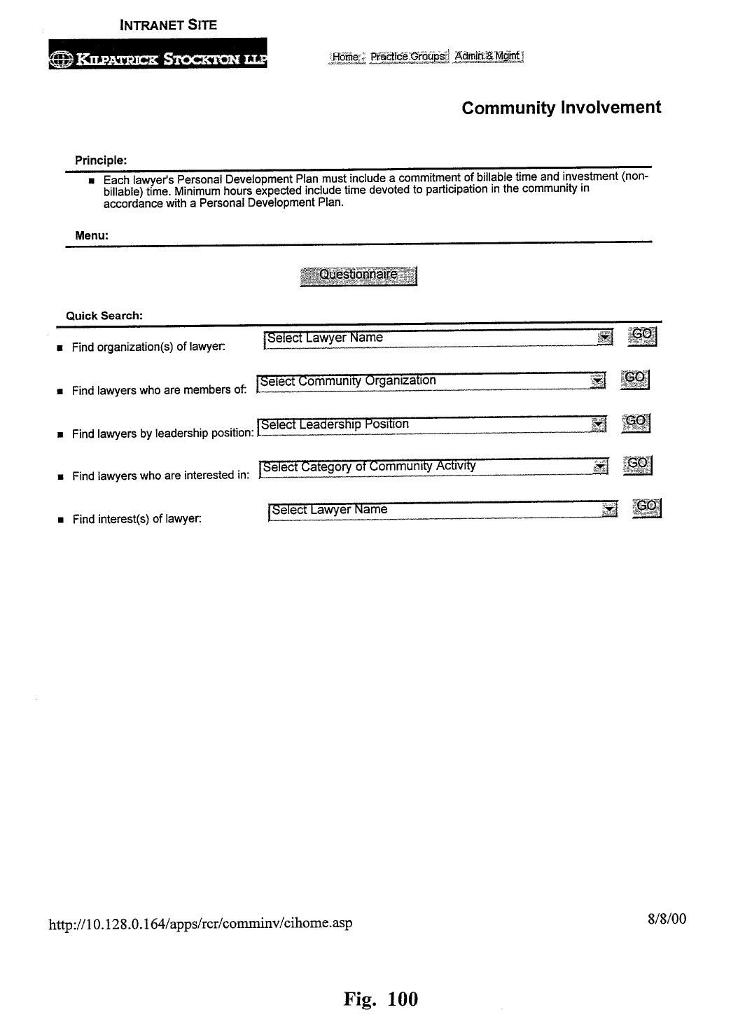

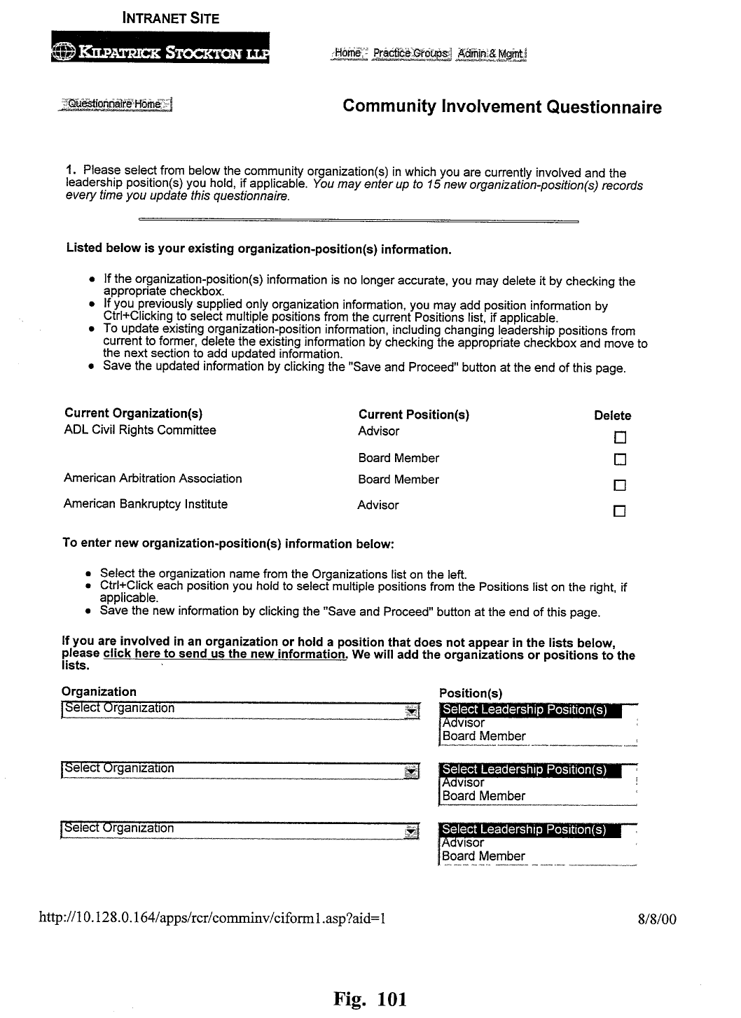

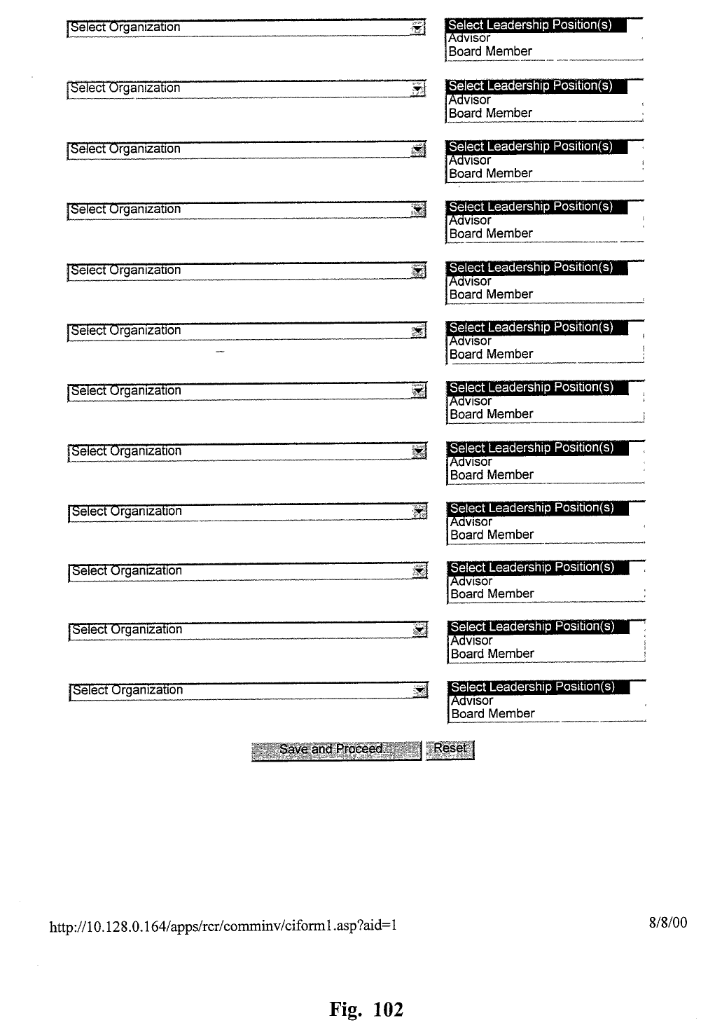

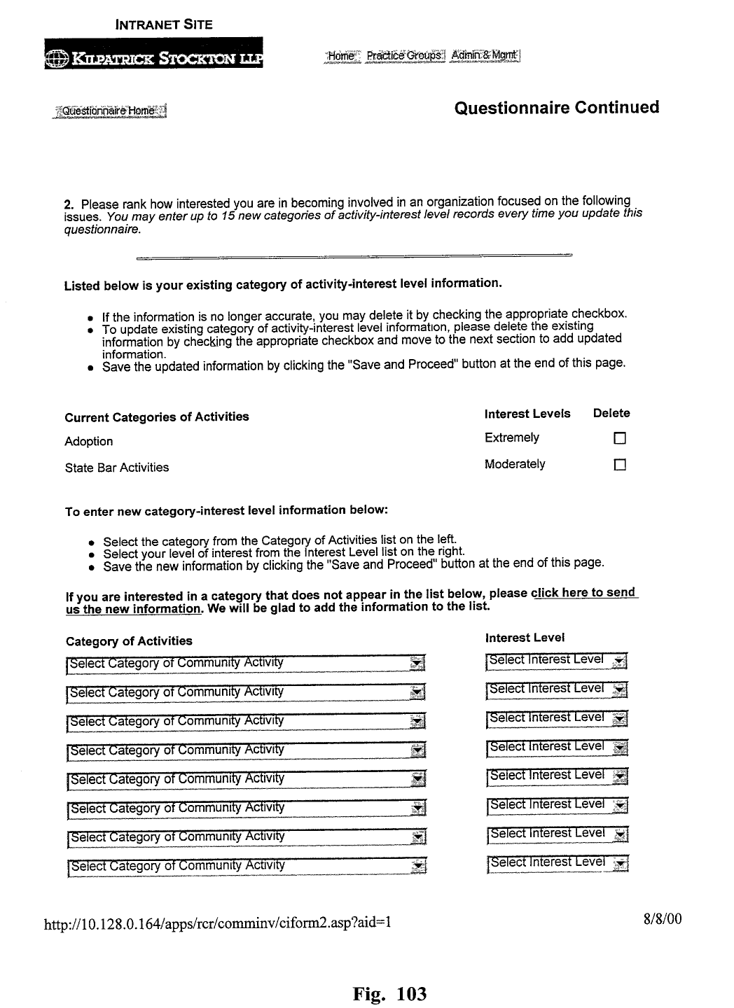

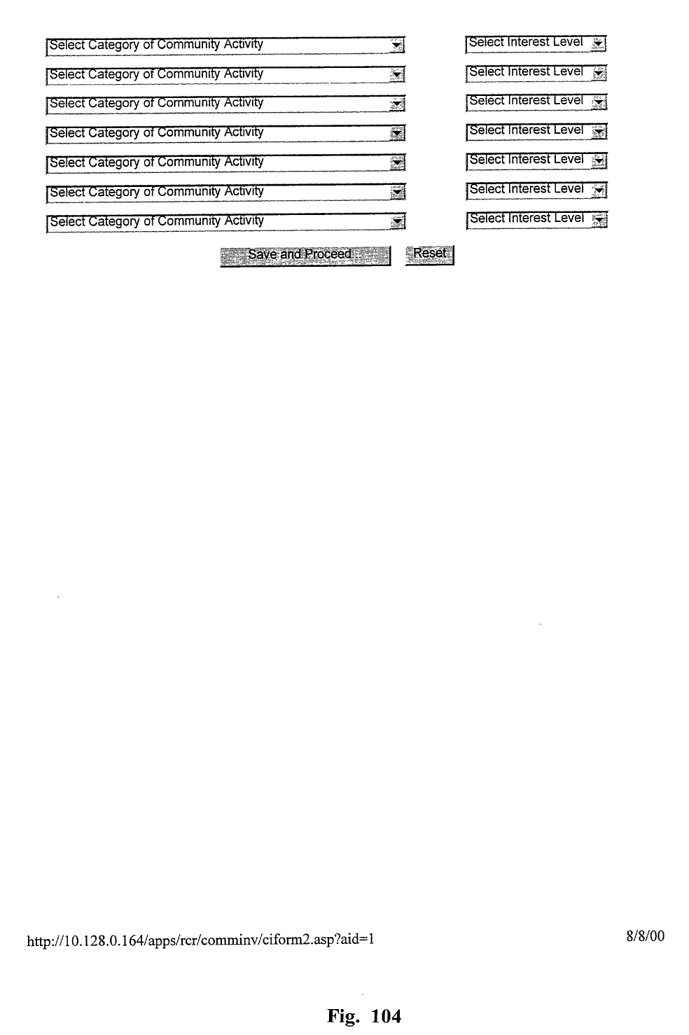

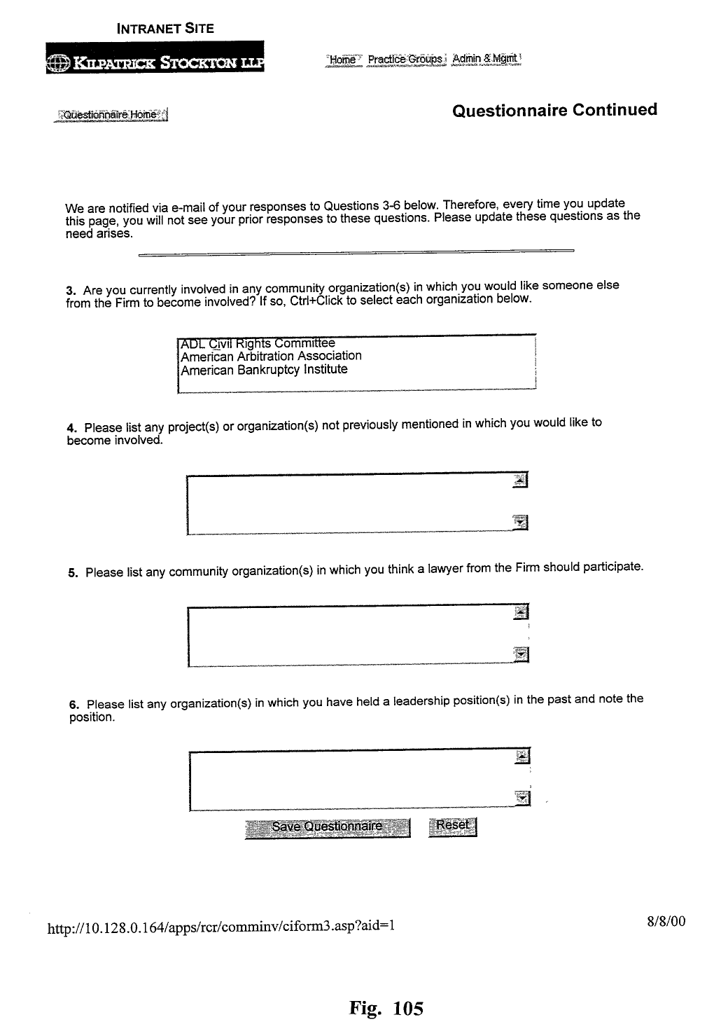

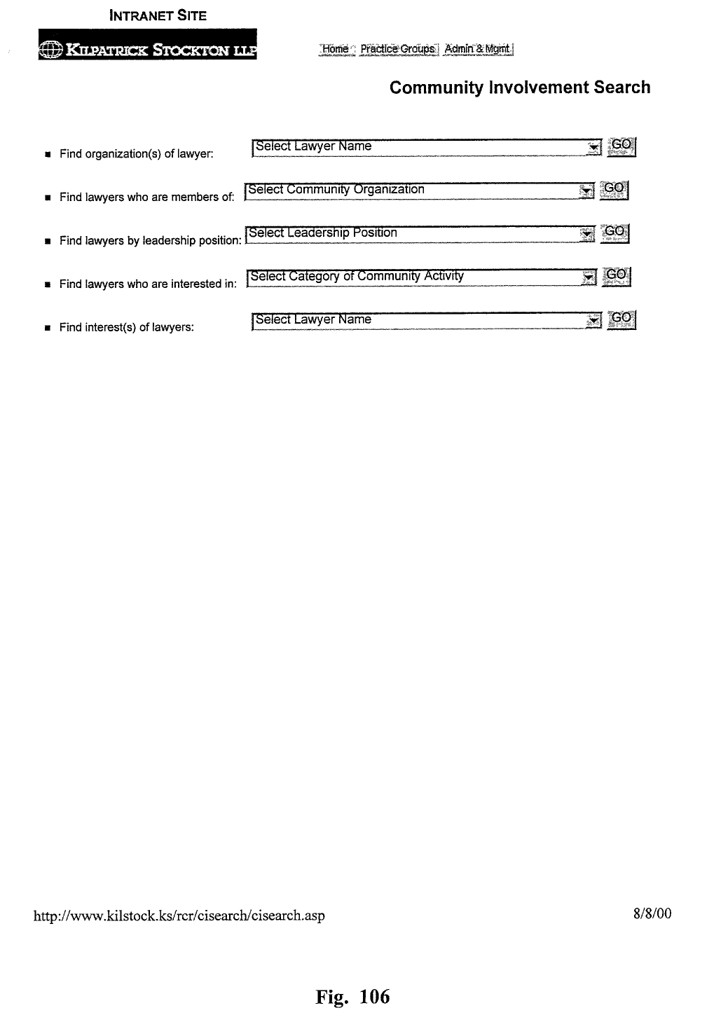

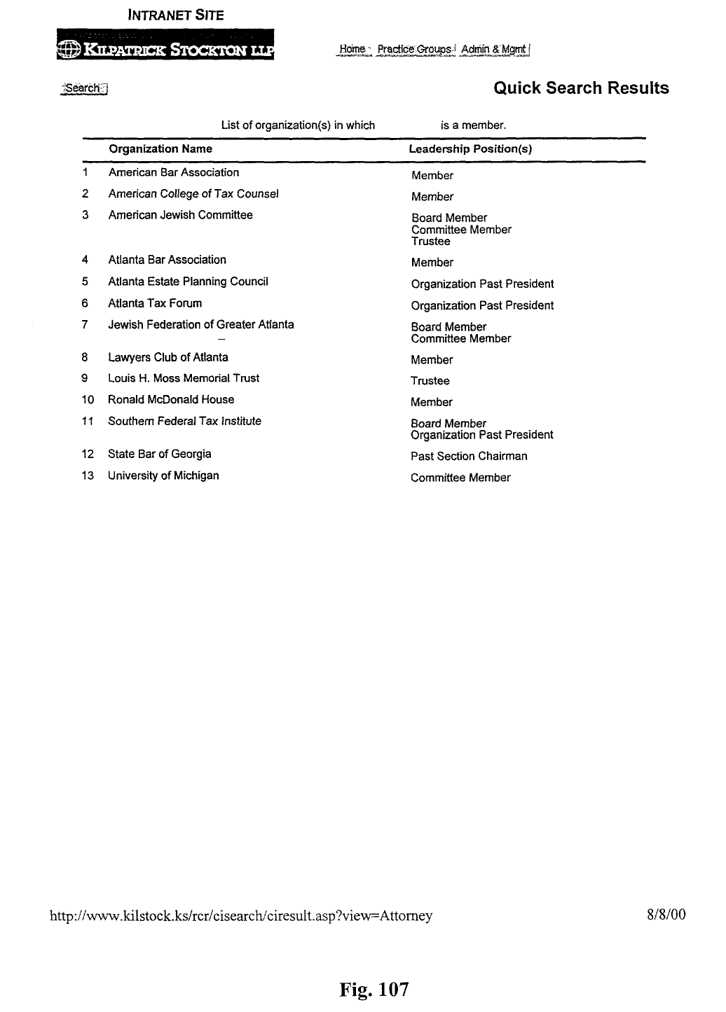

FIGS. 100-110 are screen shots generated by the process of FIG. 3. FIG. 100 is an entry screen face which allows a search by person, organization, leadership position, or interests. FIGS. 101-105 show a community involvement questionnaire according to the preferred embodiment. This interactive form solicits, from a particular person, organizations and positions in which they are actually involved; categories of activities in which they are interested and their interest level; whether they would like someone else from the firm to become involved in a particular organization; other organizations or projects in which they would like to become involved; any other community organizations which a person from the firm should participate in; and past organizations and leadership positions. FIG. 106 is a community involvement search screen shot that can produce search results such as those shown in FIGS. 107-110. FIG. 107 shows a search by person which lists the organizations and leadership positions in which that person is involved.

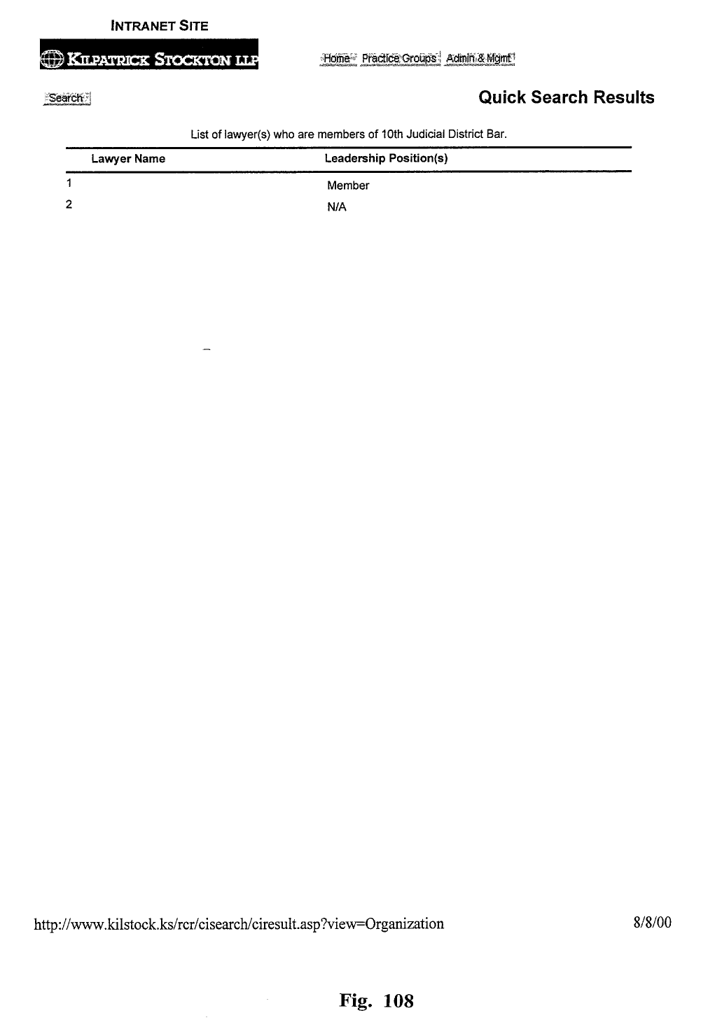

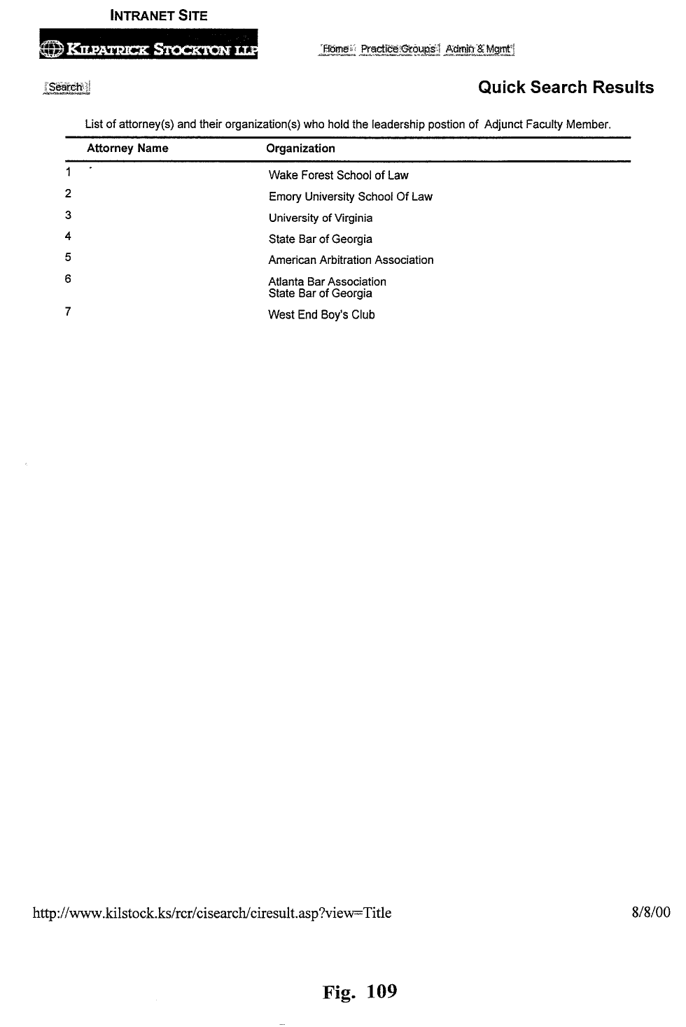

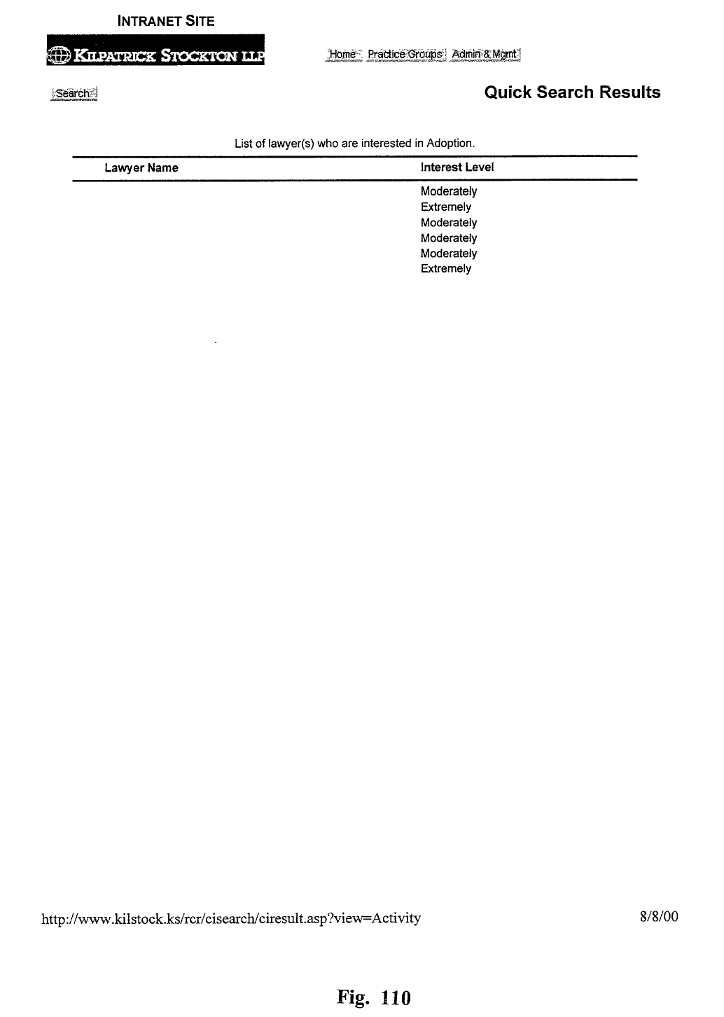

FIG. 108 shows a report of search results by organization, listing people and their leadership positions. FIG. 109 shows a report from a search according to leadership positions, by person and organization. FIG. 110 shows search results for a particular interest category, listing people and their interest levels. Other information may be solicited, collected and reported as desired.

Other databases and management tools may be included in the system, including databases for interactively reviewing performance of employees by those supervising them, databases and reporting/interaction functionality for coaches and those assisting in the practice development planning process as well as other processes and any other desired human resources and/or economic management tools.

What is claimed is:

1. A process for automating the review of supervisors in a professional services firm having a time, billing and accounting database adapted to collect recorded time and automatically generate bills for services rendered, comprising:
a. collecting in the time, billing and accounting database information relating to services rendered, according to a client, matters on which services were rendered for a particular client, timekeepers recording time to each matter, and quantity of time recorded by timekeepers for each matter;
b. generating a list of matters on which reviewees are to be reviewed by a particular reviewer, according to matters on which the reviewer recorded time in a predetermined time period;
c. disseminating, via computer network, an automated review form to the reviewer corresponding to said list of matters;
d. collecting the reviewer's responses as prompted by the review form;
e. processing the responses to provide review data; and
f. producing reports according to the review data.

2. A process according to claim 1 further comprising processing the responses to provide review data that can be sorted according to the reviewer and at least one reviewee.

3. A process according to claim 1 in which collecting the reviewer's responses to questions propounded by the review form comprises presenting to the reviewer an interactive interface in which the reviewer is able to select an option on a scale ranging from favorable to unfavorable, thereby allowing said processing to occur mathematically.

4. A process according to claim 3 in which said processing is adapted to produce a report that shows, for a particular reviewee, and for a particular scale, the number of times reviewers selected each option on the scale.

5. A process according to claim 4 in which said processing is adapted to provide, for a particular reviewee, and for a particular scale, the average score corresponding to reviewers' selection of options on the scale.

6. A process according to claim 5 in which the review form presents scales for reviewing a reviewee according to whether the reviewer's expectations as to the matter were met and whether feedback was appropriate.

7. A process according to claim 5 in which the review form presents a scale for reviewing a reviewee according to whether the matter as supervised provided an opportunity for professional growth.

8. A process according to claim 5 in which the review form presents a scale for reviewing a reviewee according to the reviewee's managerial effectiveness as perceived by the reviewer.

9. A process according to claim 1 in which producing reports comprises producing at least one report corresponding to a reviewee, showing responses for a plurality of matters on which a plurality of reviewers were supervised by the reviewee.

10. A process according to claim 1 in which producing reports comprises producing at least one report corresponding to a practice group, showing responses for a plurality of matters on which a plurality of reviewers were supervised by reviewees in the practice group.

11. A process for automating the review of supervisors in a professional services firm having a time, billing and accounting database adapted to collect recorded time and automatically generate bills for services rendered, comprising:
a. collecting in the time, billing and accounting database information relating to services rendered, according to a client, matters on which services were rendered for a particular client, timekeepers recording time to each matter, and quantity of time recorded by timekeepers for each matter;
b. generating a list of matters on which reviewees are to be reviewed by a particular reviewer, according to matters on which the reviewer recorded time in a predetermined time period;
c. disseminating, via computer network, an interactive automated review form to the reviewer corresponding to said list of matters, the review form including an interactive interface in which the reviewer is able to select an option on a plurality of scales ranging from favorable to unfavorable, said scales including a scale corresponding to whether the matter as supervised by the reviewee met the reviewer's expectations, a scale corresponding to whether the matter provided opportunity for professional growth, and a scale corresponding to the level of the reviewee's managerial effectiveness;
d. collecting the reviewer's responses as prompted by the review form;
e. processing mathematically the responses to provide review data, the review data including for a particular reviewee, and for a particular scale, the number of times reviewers selected each option on the scale and the average score on that scale; and
f. producing reports according to the review data, at least one report showing, for a particular reviewee, results from responses by a plurality of reviewers on a plurality of matters.

12. A process according to claim 11 in which producing reports comprises producing at least one report corresponding to a practice group, showing responses for a plurality of matters on which a plurality of reviewers were supervised by reviewees in the practice group.

13. A process according to claim 11 in which producing reports comprises producing at least one report that reflects a predetermined time period.

14. A process according to claim 11 further comprising:
g. disseminating to at least one planner a practice development planning interactive form, the form adapted to prompt the planner for responses as to particular subject areas, and within those areas, at least one objective, and for said at least one objective, at least one action step and deadline for each objective, said areas including at least the planner's future investment time, client service, and time commitment;
h. collecting responses by said planner to prompts presented by the form; and
i. producing a practice development plan according to said responses.

15. A process according to claim 11 further comprising:
g. disseminating to at least one planner a community involvement interactive form, the form adapted to prompt the planner for responses as to at least community organizations in which the planner is involved and leadership position within each of said community organizations;
h. collecting said responses; and
i. producing at least one report which includes a list of organizations, and for each organization, planners involved in said organizations.

16. A system for automating the review of supervisors in a professional services firm having a time, billing and accounting database adapted to collect recorded time and automatically generate bills for services rendered, comprising:
a. a plurality of user stations;
b. a time, billing and accounting database connected to at least some of said user stations via a network, said database adapted to store information relating to services rendered, according to a client, matters on which services were rendered for a particular client, timekeepers recording time to each matter, and quantity of time recorded by timekeepers for each matter;
c. processing capacity adapted to generate a list of matters on which reviewees are to be reviewed by a particular reviewer, according to matters on which the reviewer recorded time in a predetermined time period;
d. communications capacity adapted to disseminate, via the network, an automated review form to the reviewer's user station corresponding to said list of matters;
e. an MSR database connected to at least some of said user stations via said network, adapted to store responses from said reviewer as prompted on said reviewer's user station by the review form; and
f. processing capacity adapted to process the responses to provide review data and to produce reports according to the review data.

17. A system for automating the review of supervisors in a professional services firm having a time, billing and accounting database adapted to collect recorded time and automatically generate bills for services rendered, comprising:
a. a plurality of user stations;
b. a time, billing and accounting database connected to at least some of said user stations via a network, the database adapted to store information relating to services rendered, according to a client, matters on which services were rendered for a particular client, timekeepers recording time to each matter, and quantity of time recorded by timekeepers for each matter;
c. processing capacity adapted to generate a list of matters on which reviewees are to be reviewed by a particular reviewer, according to matters on which the reviewer recorded time in a predetermined time period and to disseminate, via said computer network, an interactive automated review form to the reviewer corresponding to said list of matters, the review form including an interactive interface in which the reviewer is able to select an option on a plurality of scales ranging from favorable to unfavorable, said scales including a scale corresponding to whether the matter as supervised by the reviewee met the reviewer's expectations, a scale corresponding to whether the matter provided opportunity for professional growth, and a scale corresponding to the level of the reviewee's managerial effectiveness;
d. an MSR database connected to at least some of said user stations, said database adapted to store the reviewer's responses as prompted by the review form; and
e. processing capacity adapted mathematically to process the responses to provide review data, the review data including for a particular reviewee, and for a particular scale, the number of times reviewers selected each option on the scale and the average score on that scale, said processing capacity further adapted to produce reports according to the review data, at least one report showing, for a particular reviewee, results from responses by a plurality of reviewers on a plurality of matters.

18. A system for managing people in a professional services firm having a time, billing and accounting database adapted to collect recorded time and automatically generate bills for services rendered, comprising:
a. a pluralilty of user stations;
b. a time, billing and accounting database connected to at least some of said user stations via a network, the database adapted to store information relating to services rendered, according to a client, matters on which services were rendered for a particular client, timekeepers recording time to each matter, and quantity of time recorded by timekeepers for each matter;
c. processing capacity adapted to generate a list of matters on which reviewees are to be reviewed by a particular reviewer, according to matters on which the reviewer recorded time in a predetermined time period and to disseminate, via said computer network, an interactive automated review form to the reviewer corresponding to said list of matters, the review form including an interactive interface in which the reviewer is able to select an option on a plurality of scales ranging from favorable to unfavorable, said scales including a scale corresponding to whether the matter as supervised by the reviewee met the reviewer's expectations, a scale corresponding to whether the matter provided opportunity for professional growth, and a scale corresponding to the level of the reviewee's managerial effectiveness;
d. an MSR database connected to at least some of said user stations, said database adapted to store the reviewer's responses as prompted by the review form;
e. processing capacity adapted mathematically to process the responses to provide review data, the review data including for a particular reviewee, and for a particular scale, the number of times reviewers selected each option on the scale and the average score on that scale, said processing capacity further adapted to produce reports according to the review data, at least one report showing, for a particular reviewee, results from responses by a plurality of reviewers on a plurality of matters;
f. processing capacity adapted to disseminate to at least one planner a practice development planning interactive form, the form adapted to prompt the planner for responses as to particular subject areas, and within those areas, at least one objective, and for said at least one objective, at least one action step and deadline for each objective, said areas including at least the planner's future investment time, client service, and time commitment;
g. a practice development planning database adapted to store responses by said planner to prompts presented by the form; and
h. processing capacity adapted to produce a practice development plan according to said responses.

19. A system according to claim 18 in which the processing capacity in (f) is the same as the processing capacity in (h).

20. A system for managing people in a professional services firm having a time, billing and accounting database adapted to collect recorded time and automatically generate bills for services rendered, comprising:
a. a pluralilty of user stations;
b. a time, billing and accounting database connected to at least some of said user stations via a network, the database adapted to store information relating to services rendered, according to a client, matters on which services were rendered for a particular client, timekeepers recording time to each matter, and quantity of time recorded by timekeepers for each matter;
c. processing capacity adapted to generate a list of matters on which reviewees are to be reviewed by a particular reviewer, according to matters on which the reviewer recorded time in a predetermined time period and to disseminate, via said computer network, an interactive automated review form to the reviewer corresponding to said list of matters, the review form including an interactive interface in which the reviewer is able to select an option on a plurality of scales ranging from favorable to unfavorable, said scales including a scale corresponding to whether the matter as supervised by the reviewee met the reviewer's expectations, a scale corresponding to whether the matter provided opportunity for professional growth, and a scale corresponding to the level of the reviewee's managerial effectiveness;
d. an MSR database connected to at least some of said user stations, said database adapted to store the reviewer's responses as prompted by the review form;
e. processing capacity adapted mathematically to process the responses to provide review data, the review data including for a particular reviewee, and for a particular scale, the number of times reviewers selected each option on the scale and the average score on that scale, said processing capacity further adapted to produce reports according to the review data, at least one report showing, for a particular reviewee, results from responses by a plurality of reviewers on a plurality of matters;
f. processing capacity adapted to disseminate to at least one planner a community involvement interactive form, the form adapted to prompt the planner for responses as to at least community organizations in which the planner is involved and leadership position within each of said community organizations;
g. a community involvement database adapted to store said responses; and
h. processing capacity adapted to produce at least one report which includes a list of organizations, and for each organization, planners involved in said organizations.

21. A system according to claim 20 in which the processing capacity in (f) is the same as the processing capacity is (h).
